(19) United States
(12) Patent Application Publication
(10) Pub. No.: US 2023/0023503 A1
(43) Pub. Date: Jan. 26, 2023

(54) Security Devices of Various Form factors with Chaosmetric Artifacts

(71) Applicant: Blocktag, Inc., New York, NY (US)

(72) Inventors: Nova Spivack, Sherman Oaks, CA (US); Allie Zhang, Irvine, CA (US); Chun Ming Chin, Cambridge, MA (US)

(21) Appl. No.: 17/694,735

(22) Filed: Mar. 15, 2022

Related U.S. Application Data
(60) Provisional application No. 63/161,473, filed on Mar. 16, 2021.

(51) Int. Cl. G06Q 30/00; G06K 19/06

(52) U.S. Cl. CPC G06Q 30/0185; G06K 19/06037; G06K 19/06131

(57) ABSTRACT

Security devices of various form factors with chaosmetric artifacts are disclosed. In one aspect, embodiments of the present disclosure include a security device, having a physical surface having formed thereon a composite pattern. The composite pattern can created from joining or overlap of imprinting of a first base pattern and a second base pattern. The first base pattern is created from a first basic building block and the basic building block can forms chaosmetric artifacts in the physical surface upon printing.

### CLAIM OF PRIORITY

This application claims the benefit of:

* U.S. Provisional Application No. 63/161,473, filed Mar. 16, 2021 and entitled “Systems, Methods, and Apparatuses For Tag Request, Inspection, Generation, Printing, Fingerprinting with Chaosimetric Patterns,” (8003.US00), the contents of which are incorporated by reference in their entirety.

### RELATED APPLICATIONS

This application is related to U.S. Application No. 17/______, filed Mar. 15, 2022 and entitled “______” (Attorney Docket No. 99013-8003.US01), the contents of which are incorporated by reference in their entirety.

This application is related to U.S. Application No. 17/______, filed Mar. 15, 2022 and entitled “______” (Attorney Docket No. 99013-8003.US03), the contents of which are incorporated by reference in their entirety.

This application is related to U.S. Application No. 17/______, filed Mar. 15, 2022 and entitled “______” (Attorney Docket No. 99013-8003.US04), the contents of which are incorporated by reference in their entirety.

This application is related to PCT Application No. PCT/US2022/20111, filed Mar. 14, 2022 and entitled “Systems, methods and devices to Administer a Security Device with Chaosmetric Patterns” (Attorney Docket No. 99013-8003.WO00), the contents of which are incorporated by reference in their entirety.

This application is related to PCT Application No. PCT/US2021/31017, filed May 6, 2021 and entitled “Security Device with Chaosmetric Patterns” (Attorney Docket No. 99013-8002.WO00), the contents of which are incorporated by reference in their entirety.

This application is related to U.S. Application No. 17/308,178, filed May 5, 2021 and entitled “Security Device with Chaosmetric Patterns” (Attorney Docket No. 99013-8002.US01), the contents of which are incorporated by reference in their entirety.

### TECHNICAL FIELD

The disclosed technology relates generally to systems, methods and devices to administer a security device with chaosmetric patterns/artifacts.

### BACKGROUND

Counterfeiting is a form of theft that has become increasingly problematic. Counterfeit goods span across multiple industries including everything from clothing, accessories, music, software, computer games, medications and cigarettes, to automobile and airplane parts, consumer goods, toys and electronics. The effect is detrimental to the consumers and businesses. Counterfeit products result in loss of revenue for businesses. Consumers purchase counterfeit products that are of low quality and may be exposed to health and safety issues.

### BRIEF DESCRIPTION OF THE DRAWINGS

FIG. 1 illustrates an example block diagram of a host server in an environment able to administer, generate, track, fingerprint, authenticate security devices in a network, in accordance with embodiments of the present disclosure.

FIG. 2A depicts examples of multiple base patterns and their basic building blocks (lines of specified width, orientation angle, periodicity), in accordance with embodiments of the present disclosure.

FIG. 2B depicts further examples of multiple base patterns and their basic building blocks (white circles at specified positions), in accordance with embodiments of the present disclosure.

FIG. 2C depicts an example of character ‘B’ as a basic building block embedded with a sinusoidal halftone base pattern whose image contrast is maximized by computer vision, in accordance with embodiments of the present disclosure.

FIG. 2D depicts an example character ‘B’ as a basic building block attached to a square wave and truncated Koch curve hybrid identifier, in accordance with embodiments of the present disclosure.

FIG. 2E depicts an example of emergent monochrome shapes assembled from overlapping base pattern’s basic building block, in accordance with embodiments of the present disclosure.

FIG. 2F depicts an example of cyan and yellow base patterns printed over each other and a new colored green pattern emerges, in accordance with embodiments of the present disclosure.

FIG. 2G depicts an example of colored base patterns in magenta, cyan, yellow and an emergent composite pattern when printed together, in accordance with embodiments of the present disclosure.

FIG. 2H depicts an example of colored base patterns in cyan, magenta, yellow and an emergent composite pattern when printed together, in accordance with embodiments of the present disclosure.

FIG. 2H-1 depicts an example of creation of a chaosmetric identifier of a fractal base pattern, in accordance with embodiments of the present disclosure.

FIG. 2I depicts examples of base or composite pattern integration in a larger design, in accordance with embodiments of the present disclosure.

FIG. 2I-1 depicts an example of a resolution test target to measure resolution of a scan device, in accordance with embodiments of the present disclosure.

FIG. 2I-2 depicts examples of base or composite pattern utilizing watercolor illusion halftones, in accordance with embodiments of the present disclosure.

FIG. 2I-3 depicts examples of induction images and and a test image illustrating the inductive illusion halftone technique, in accordance with embodiments of the present disclosure.

FIG. 2I-4 depicts an example of a semicircular grating joined with a vertical line grating to form a fingerprint shape, in accordance with embodiments of the present disclosure.

FIG. 2I-5 depicts an example of a semicircular grating joined with a vertical or horizontal line grating to form an S-shaped pattern, in accordance with embodiments of the present disclosure.

FIG. 2I-6 depicts an example of a circular tangential halftone quadrant redrawn as Hilbert space filling curves in accordance with embodiments of the present disclosure.

FIG. 2J depicts examples of additional pattern variants, in accordance with embodiments of the present disclosure.

FIG. 2K depicts examples of secondary emergent patterns, in accordance with embodiments of the present disclosure.

FIG. 2L depicts an example of a pattern placed adjacent to another design element, in accordance with embodiments of the present disclosure.

FIG. 2M depicts an example of a base pattern embedded in an adjacent legacy design element such as a 2D barcode, in accordance with embodiments of the present disclosure.

FIG. 2N depicts an example of a Koch curve pattern in accordance with embodiments of the present disclosure.

FIG. 2O depicts an example of basic building blocks of line segments connect to one another to form a fractal pattern, in accordance with embodiments of the present disclosure.

FIG. 2P depicts examples of fractal patterns with rounded corners, in accordance with embodiments of the present disclosure.

FIG. 3A depicts an example functional block diagram of a host server to administer, generate, track, print, duplicate, fingerprint and/or authenticate security devices in a network, in accordance with embodiments of the present disclosure

FIG. 3B depicts an example block diagram illustrating the components of the host server to administer, generate, track, print, duplicate, fingerprint and/or authenticate security devices in a network, in accordance with embodiments of the present disclosure.

FIG. 4A depicts an example functional block diagram of a client device such as a mobile device that can obtain data from security devices, in accordance with embodiments of the present disclosure.

FIG. 4B depicts an example block diagram of the client device, which can be a mobile device that an obtain data from security devices, in accordance with embodiments of the present disclosure.

FIG. 5A depicts a flow chart illustrating an example process for generating blueprint and assessing blueprint candidates of a security device with chaosmetric patterns (e.g., chaosmetric features), in accordance with embodiments of the present disclosure.

FIG. 5B depicts a flow chart illustrating an example process for generating chaosmetric features for a blueprint of a security tag, in accordance with embodiments of the present disclosure.

FIG. 5C depicts a flow chart illustrating an example process to use a distributed ledger to perform validation of authentication of a security device in a decentralized network, in accordance with embodiments of the present disclosure.

FIG. 5D depicts a flow chart illustrating an example process to use a distributed ledger verify a time window in which authentication of a security device occurred, in accordance with embodiments of the present disclosure.

FIG. 5E depicts a flow chart illustrating an example process for requesting, generating inspecting, printing fingerprinting, and authentication of a security device, in accordance with embodiments of the present disclosure.

FIG. 6A depicts an example of integration of monochrome base or composite patterns with content element, in accordance with embodiments of the present disclosure.

FIG. 6A-1 depicts examples of integration of monochrome fractal patterns with content element, in accordance with embodiments of the present disclosure.

FIG. 6A-2 depicts an example of a QR code converted into a fractal pattern (Hilbert curve fractal pattern), in accordance with embodiments of the present disclosure.

FIG. 6A-3 depicts an example of a bar code converted into a fractal pattern (Hilbert curve fractal pattern), in accordance with embodiments of the present disclosure.

FIG. 6A-4 depicts an example of an artificial fingerprint from a superposition of an elongated circular grating and Hilbert curve fractal in accordance with embodiments of the present disclosure.

FIG. 6A-5 depicts an example of the artificial fingerprint superposed within a content element such as the black/white squares of a QR to generate image, in accordance with embodiments of the present disclosure.

FIG. 6A-6 depicts an example of security device integrated with a fractal grid. in accordance with embodiments of the present disclosure.

FIG. 6B depicts an example of a checkerboard marker element used for camera and lens distortion calibration, in accordance with embodiments of the present disclosure.

FIG. 6C depicts examples of patterns having polychrome form factor, in accordance with embodiments of the present disclosure.

FIG. 6D depicts an example of a monochrome security device having a square form factor, in accordance with embodiments of the present disclosure.

FIG. 6E depicts an example of a monochrome security device of a circular form factor having a center ShotCode circular barcode and surrounding circular fractal, in accordance with embodiments of the present disclosure.

FIG. 6F depicts an example of a monochrome security device having Levy curve fractal with center CanTag marker, in accordance with embodiments of the present disclosure.

FIG. 6G depicts an example of a monochrome security device with a Penrose tiling fractal pattern with a Shotcode barcode in the center, in accordance with embodiments of the present disclosure.

FIG. 6H depicts an example of a monochrome security device having a center ShotCode marker with a circular radial halftone that functions as a continuous-valued resolution test target, in accordance with embodiments of the present disclosure. As radius increases from center of origin, the resolution decreases.

FIG. 6I depicts an example of a monochrome security device with a center marker within an uneven halftone that function as a 1D binary encoded circular barcode, in accordance with embodiments of the present disclosure.

FIG. 6J depicts an example of a monochrome security device with a center marker and with a superimposed radial and tangential circular halftone pattern that functions as a 2D binary encoded circular barcode, in accordance with embodiments of the present disclosure.

FIG. 6K depicts an example of a monochrome security device with a center Shotcode marker having spiral halftone patterns, in accordance with embodiments of the present disclosure.

FIG. 6L depicts an example of a monochrome security device with a content element as a barcode, an authenticity element as truncated Koch curve (on left hand side), and an identity element with a halftone pattern of line segments (on right hand side), in accordance with embodiments of the present disclosure.

FIG. 6M depicts an example of a monochrome security device with an authenticity element as a fractal chain, identity element with a halftone pattern of line segments in the fractal chain, and a content/ marker element as a ShotCode circular barcode, in accordance with embodiments of the present disclosure.

FIG. 6N depicts an example of a digital tag blueprint with zoomed in patterns, in accordance with embodiments of the present disclosure.

FIG. 6O depicts zoomed in line grating patterns from the digital tag blueprint depicted in the example of FIG. 6N, in accordance with embodiments of the present disclosure.

FIG. 6P depicts an image of a printed tag of the digital tag blueprint of the example of FIG. 6N, in accordance with embodiments of the present disclosure.

FIG. 6Q depicts an image of zoomed in chaosmetric patterns from the printed tag shown in FIG. 6P, in accordance with embodiments of the present disclosure.

FIG. 6R depicts example line gratings without transition of simple colors in accordance with embodiments of the present disclosure.

FIG. 6S depicts example line gratings with sinusoidal transition of simple colors, in accordance with embodiments of the present disclosure.

FIG. 6T depicts example line gratings with sinusoidal transition of complex colors (pastels), in accordance with embodiments of the present disclosure.

FIG. 6U depicts an example of an authenticity element having stray faint colored pixels around its white regions, in accordance with embodiments of the present disclosure.

FIG. 7A depicts an example of a printed tag with lines that are too fat which makes it easier to reproduce in accordance with embodiments of the present disclosure.

FIG. 7B depicts zoomed in chaosmetric patterns with fat lines, in accordance with embodiments of the present disclosure.

FIG. 8A depicts an example screenshot of print job settings in MacOS, in accordance with embodiments of the present disclosure.

FIG. 8B depicts an example of a digital tag blue print having multiple layers to be over printed, in accordance with embodiments of the present disclosure.

FIG. 8C depicts an example of an overprinted output by feeding the same paper multiple times through the printer, in accordance with embodiments of the present disclosure.

FIG. 8D depicts an example of a side by side comparison of an original security device and a cloned security device, in accordance with embodiments of the present disclosure.

FIG. 8E depicts an example of an image similarity histogram of fingerprinted original tag against treatment original tag (black histogram) and treatment cloned tag (light grey histogram), in accordance with embodiments of the present disclosure.

FIG. 8F depicts an example of Side-by-side comparison of tag printed from the same blueprint on the same printer with different paper feed settings (851: Photo Paper, 853: Plain Paper), in accordance with embodiments of the present disclosure.

FIG. 8G depicts zoomed images of chaosmetrics artifacts in the tags printed as shown in the example of FIG. 8F, in accordance with embodiments of the present disclosure.

FIG. 8H depicts a comparison of the image structure similarity histogram of the tags printed as shown in the example of FIG. 8F, in accordance with embodiments of the present disclosure.

FIGS. 9A-9D depict examples of text elements or images elements integrated with a security device, in accordance with embodiments of the present disclosure.

FIG. 10 is a block diagram illustrating an example of a software architecture that may be installed on a machine, in accordance with embodiments of the present disclosure.

FIG. 11 is a block diagram illustrating components of a machine, according to some example embodiments, able to read a set of instructions from a machine-readable medium (e.g., a machine-readable storage medium) and perform any one or more of the methodologies discussed herein.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

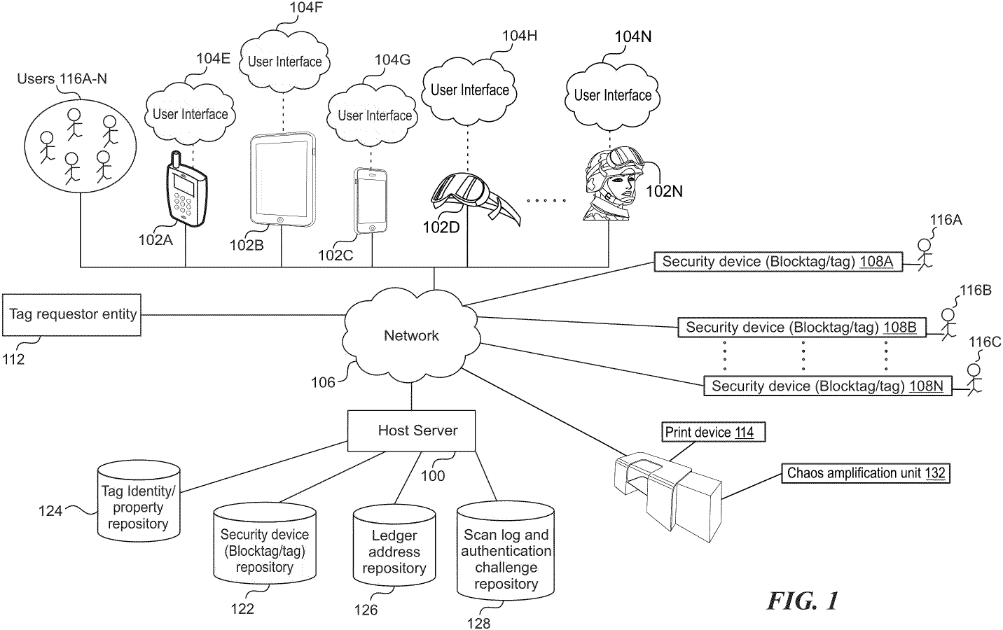

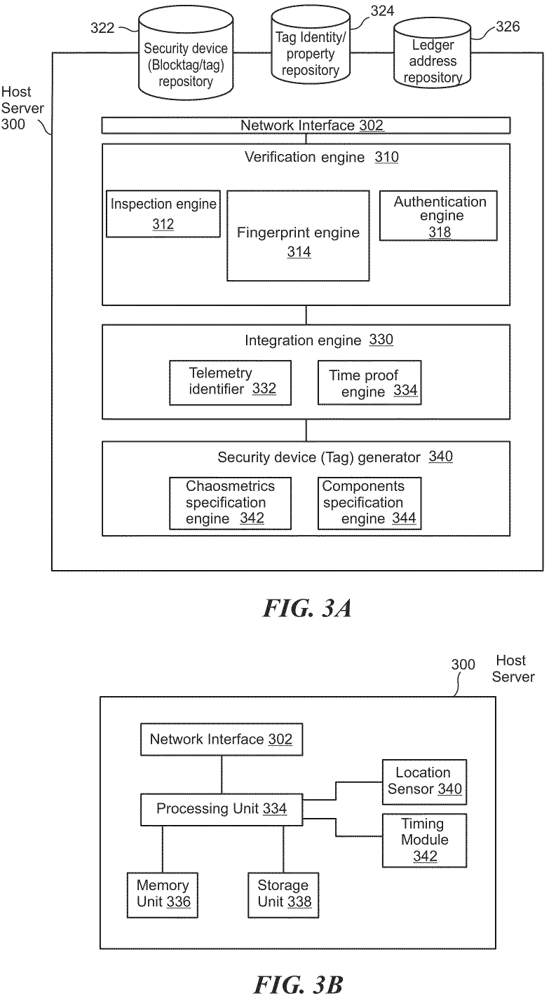

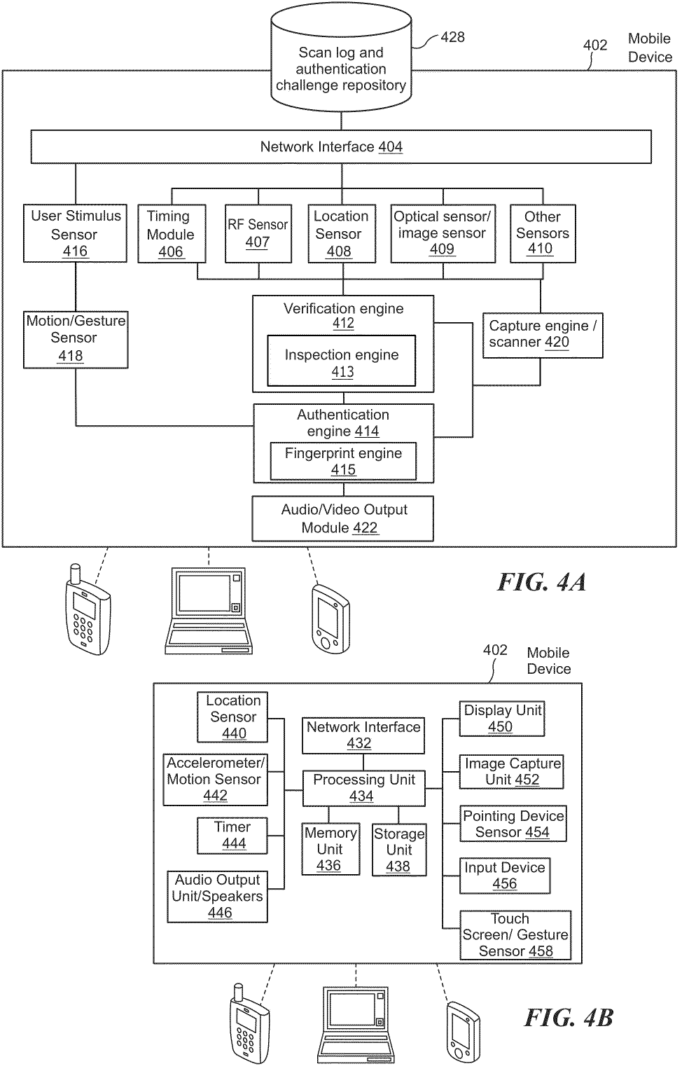

One embodiment of the present disclosure includes systems and methods to administer, read, generate, implement/specify, inspect, fingerprint, authenticate, verify, provision, scan, detect, decoding, identify, track and/or deploy, security devices. The disclosed technology includes a self service, decentralized security device (e.g., physical security device, tag, Blocktag, physical tag, security device 108A-N of FIG. 1) printing system (e.g., a host server 100 of FIG. 1 and/or a host server 300 of FIGS. 3A-3B and/or a device 102A-N as shown in the example of FIG. 1 and/or a device 402 of the example of FIG. 4A) where any user with any printer can print a security device (e.g., a tag, a “Blocktag”, a security device 108A-N as shown in the example of FIG. 1) from anywhere. The disclosed innovation includes systems (e.g., the host server 100 of FIG. 1 and/or the host server 300 of FIGS. 3A-3B and/or the device 102A-N as shown in the example of FIG. 1 and/or the device 402 of the example of FIG. 4A) and processes to print micro chaosmetric artifacts that have an inherent macro structure (e.g. Fractals, Halftones). Such quantifiable inherent micro structure is advantageoulsy used to quantify print quality to ensure chaosmetric artifacts are reasonably chaotic to distinguish an original from a cloned Blocktag. The chaosmetric artifacts in the disclosed innovation can be inspected by the system (e.g., by the inspection engine 312 of the example of FIG. 3A and/or the inspection engine 413 of FIG. 4A) to quantify print quality. This solves the problem of anti-counterfeit security breaches due to internal bad actors (e.g., a domestic thief). For example, employees copying anti-counterfeit data (e.g. passwords, security tag blueprints) from their company’s database and selling the data to counterfeiters, who can then make counterfeit products that pass verification.

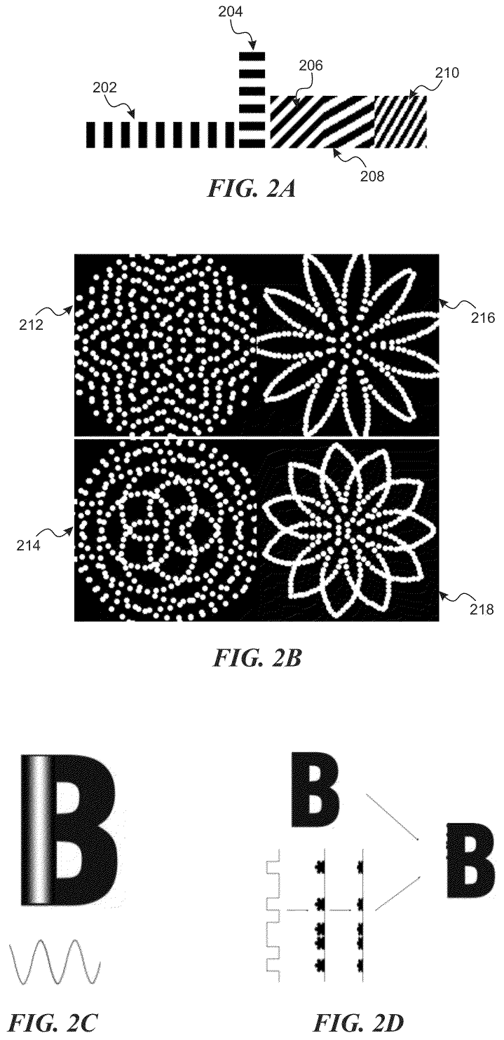

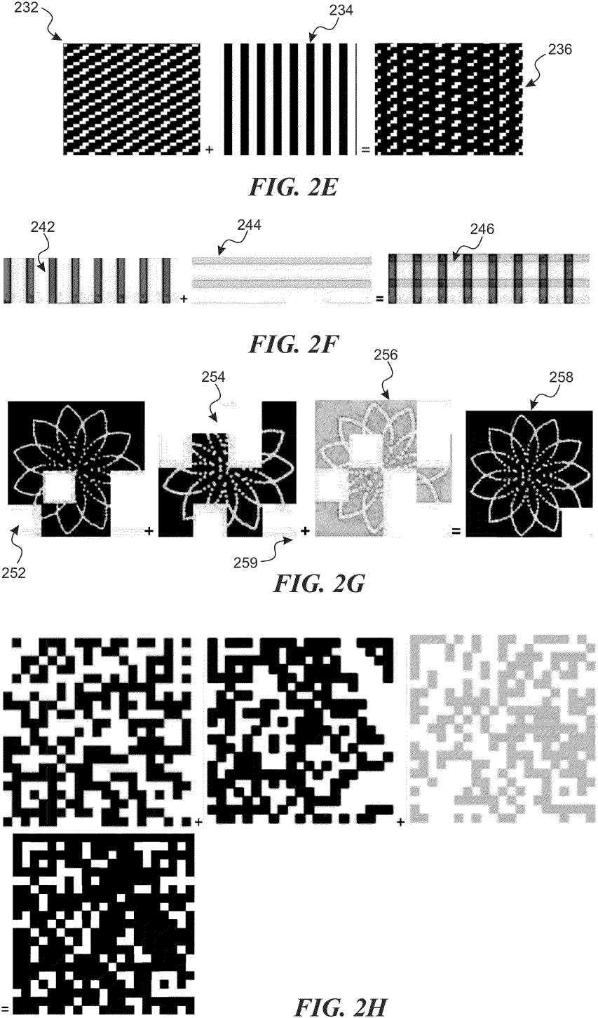

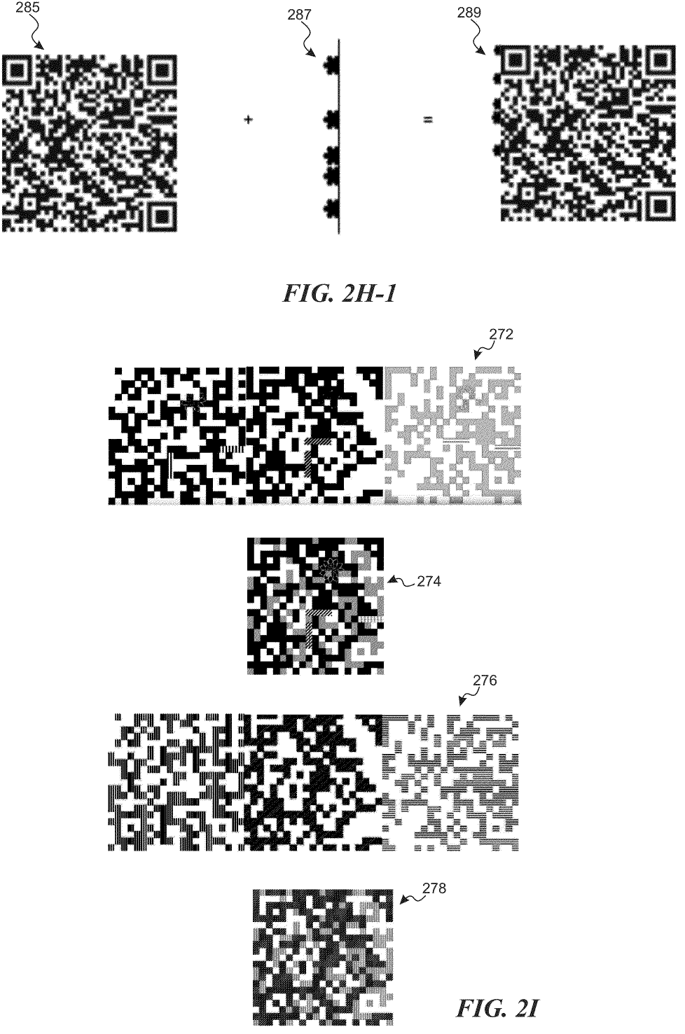

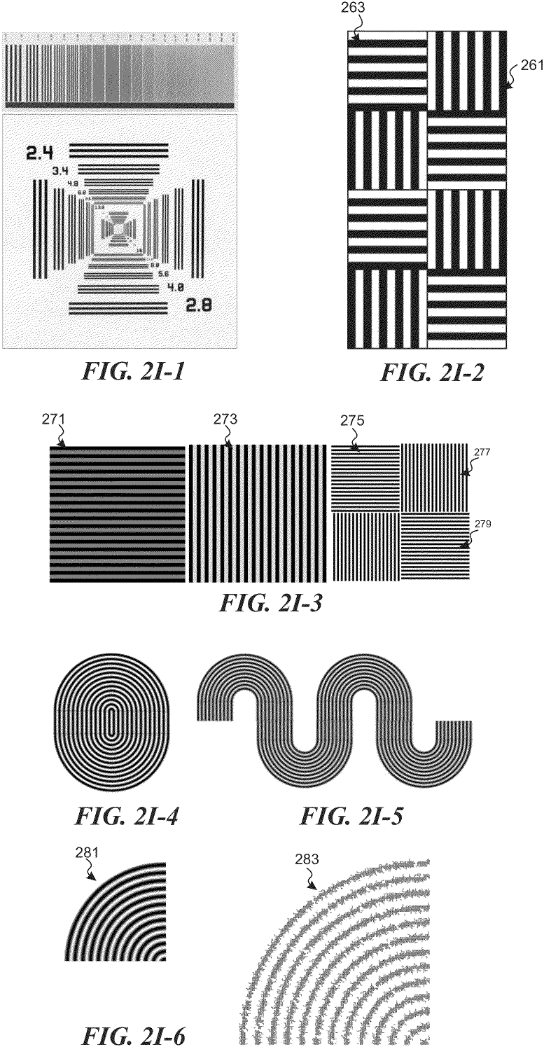

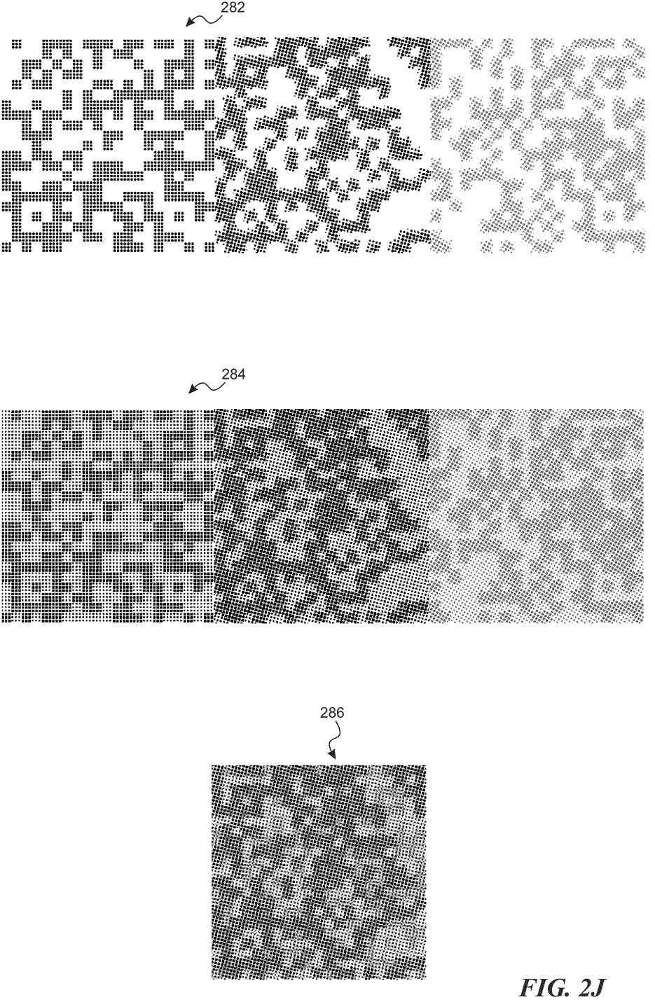

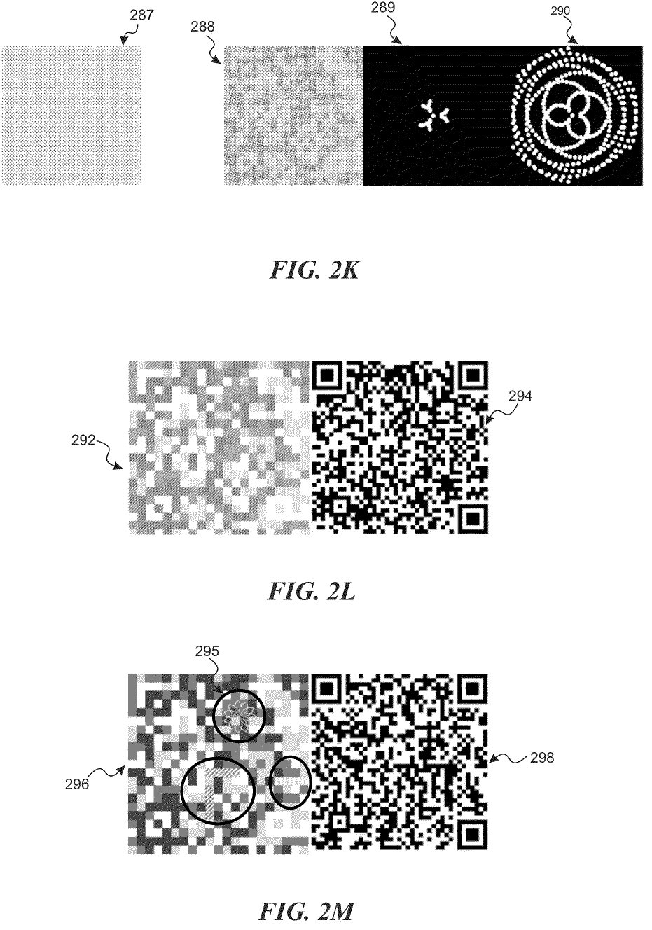

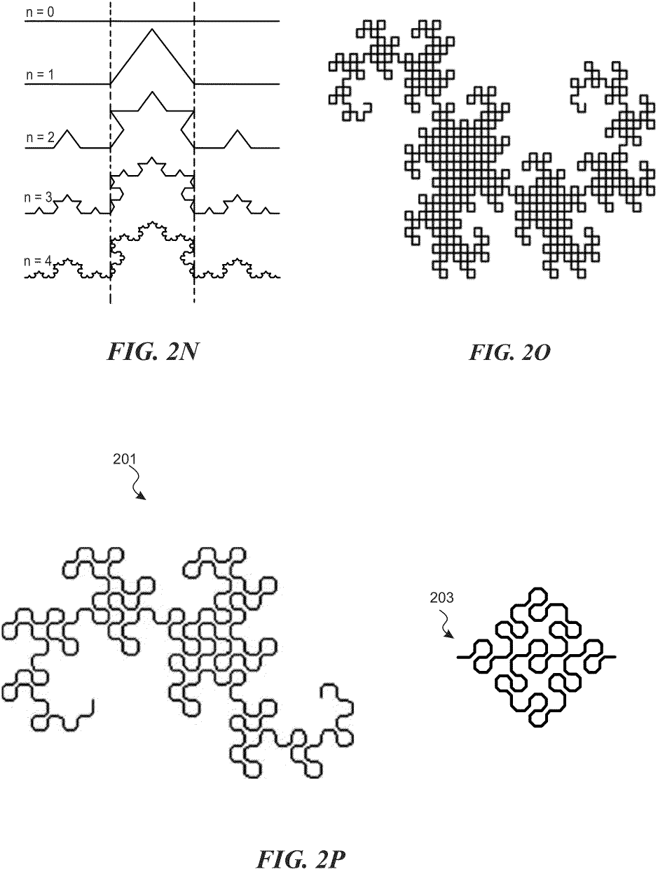

Embodiments of the present disclosure include systems, methods and apparatuses of a security device. One embodiment includes a security device (e.g., physical security device, tag, Blocktag, physical tag, security device 108A-N of FIG. 1) which can include, a physical surface having formed thereon a composite pattern (e.g., composite patterns as shown in the examples of FIG. 2E -FIG. 2H, FIG. 2I-2, FIG. 2I-4― FIG. 2I-5, FIG. 2J). The composite pattern can be created from overlap of imprinting of a first halftone pattern and a second halftone pattern. The first halftone pattern can be created from a first basic building block (e.g., base patterns and basic building blocks as shown in the examples of FIG. 2A ― FIG. 2D, FIG. 2I-2, FIG. 2O, FIG. 2P) and the basic building block forms chaosmetric artifacts in the physical surface upon printing. The first halftone pattern can created by repeating the basic building block with a rotation, spatial periodicity, and/or a given phase shift. The first halftone pattern can also created by repeating the basic building block with locations of each instance of the basic building block specified in a coordinate system. In general, the basic building block includes one or more of the characteristics, individual shape, orientation angle, a dimension, a position, a color.

In one embodiment, the characteristics of the composite pattern can be quantifiable (e.g., by the fingerprint engine 314 of the example of FIG. 3A and/or the fingerprint engine 415 of FIG. 4A) and used to authenticate (e.g., by the authentication engine 318 of the example of FIG. 3A and/or the authentication engine 414 of the example of FIG. 4A) the security device. The characteristics of the composite pattern can include for example, one or more emergent colors which arise from overlap of the first halftone pattern with different colors. The characteristics of the composite pattern can also include and be determined by (e.g., by the inspection engine 312, fingerprint engine 314 and/or the authentication engine of the verification engine 310 of the host server 300 shown in the example of FIG. 3A) for example, an order of printing of the first halftone pattern and the second halftone pattern. The characteristics of the composite pattern can also include a degree of ink bleeding into the physical surface. In a further embodiment, the characteristics of the composite pattern include a spatial periodicity of the composite pattern. The spatial periodicity can be determined from the first halftone pattern. The characteristics of the composite pattern can also include an orientation angle of the composite pattern and the orientation angle can be determined from the first halftone pattern. The second halftone pattern can be created (e.g., by the chaosmetrics specification engine 342 and/or the component specification engine 344 of the security device generator 340 of the host server 300 shown in the example of FIG. 3A) from the same building block or a different building block in a similar fashion. In one embodiment, the second halftone pattern is created from a second basic building block and the characteristics of the composite pattern include an emergent shape of the composite pattern where the emergent shape of the composite pattern can be assembled from shapes and positions of the first basic building block and the second basic building block. In a further embodiment, the chaosmetric artifacts created in the physical surface can be quantified to generate a chaosmetric identifier for the first halftone pattern (e.g., by the chaosmetrics specification engine 342 and/or the component specification engine 344 of the security device generator 340 of the host server 300 shown in the example of FIG. 3A). For example, the chaosmetric identifier of the first halftone pattern can be determined from its spatial frequency.

In one embodiment, the encoded metadata or serial ID can be decoded by a device (e.g. a scan device, a client device 102A-N as shown in the example of FIG. 1 and/or a client device 402 of the example of FIG. 4A). The device (e.g. a scan device, a client device 102A-N as shown in the example of FIG. 1 and/or a client device 402 of the example of FIG. 4A) can be used do execute the Blocktag app or a web browser with access to Blocktag’s scan API to check whether the security device (e.g., Blocktag) attached to an item is authentic (e.g., by the authentication engine 414 of the example of FIG. 4A) without connecting to a remote sever when there is no wired or wireless network connection, IT infrastructure is poor, or when network download/upload speeds are slow. This can be a useful feature in particular when for example, using Blocktags to track cargo on ships out at sea, mark stakes to claims of land or natural resources, including land ownership claims and mining claims underground/underwater or off-Earth locations (e.g. asteroids, moons, other planets).

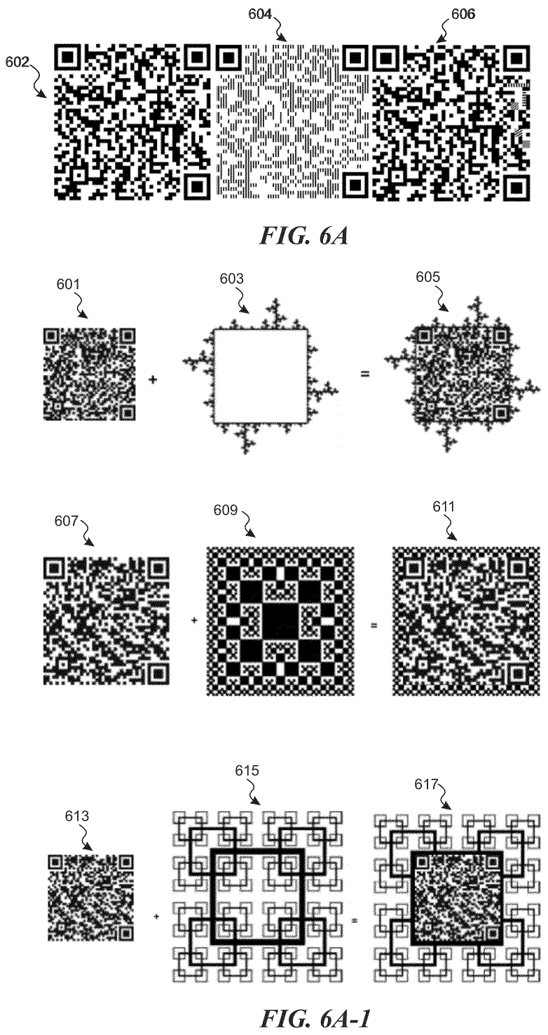

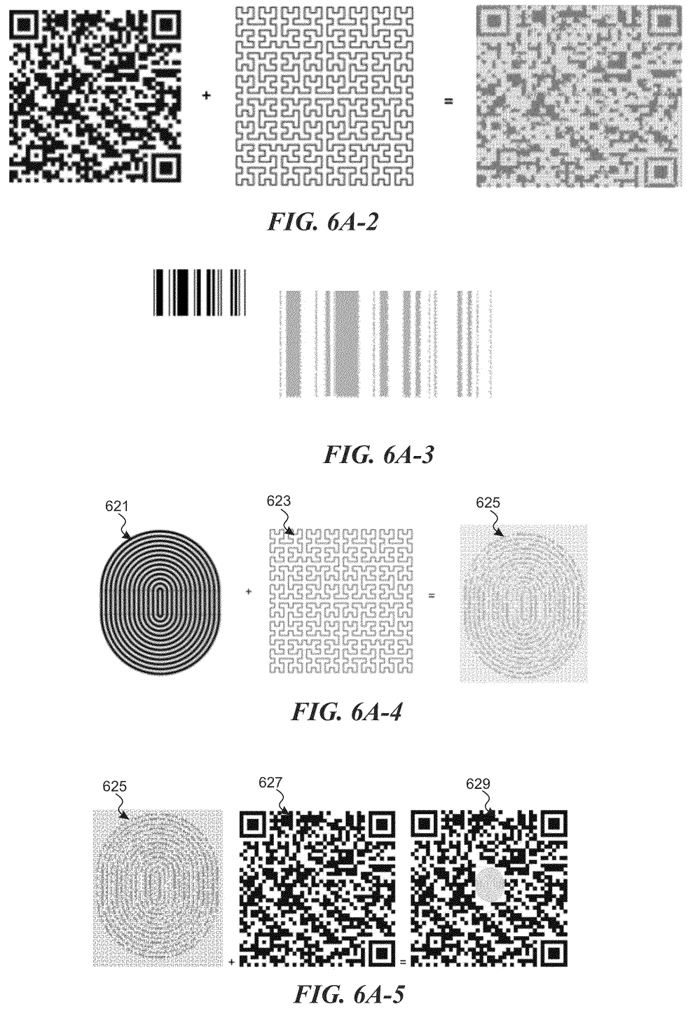

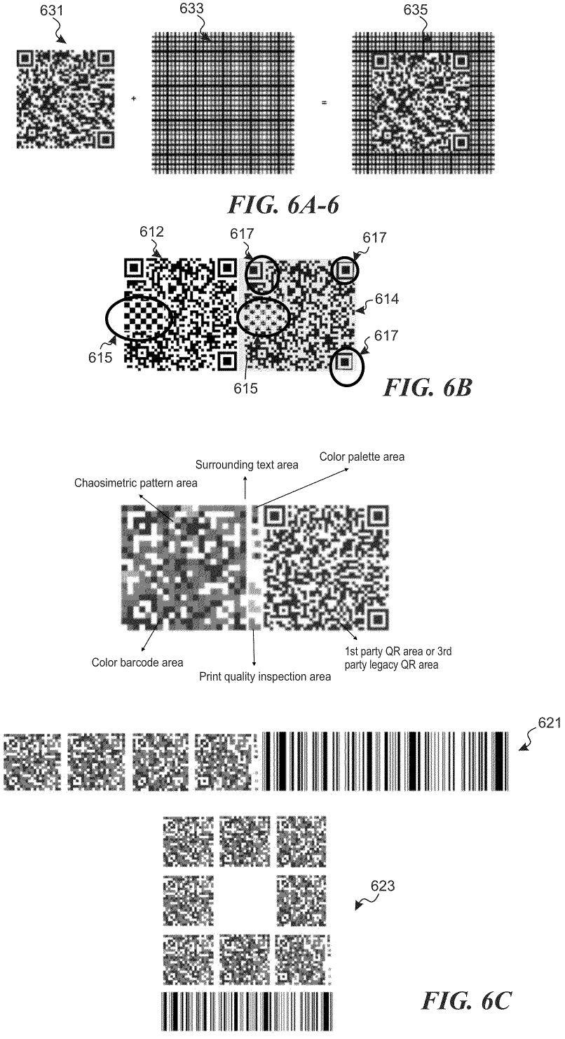

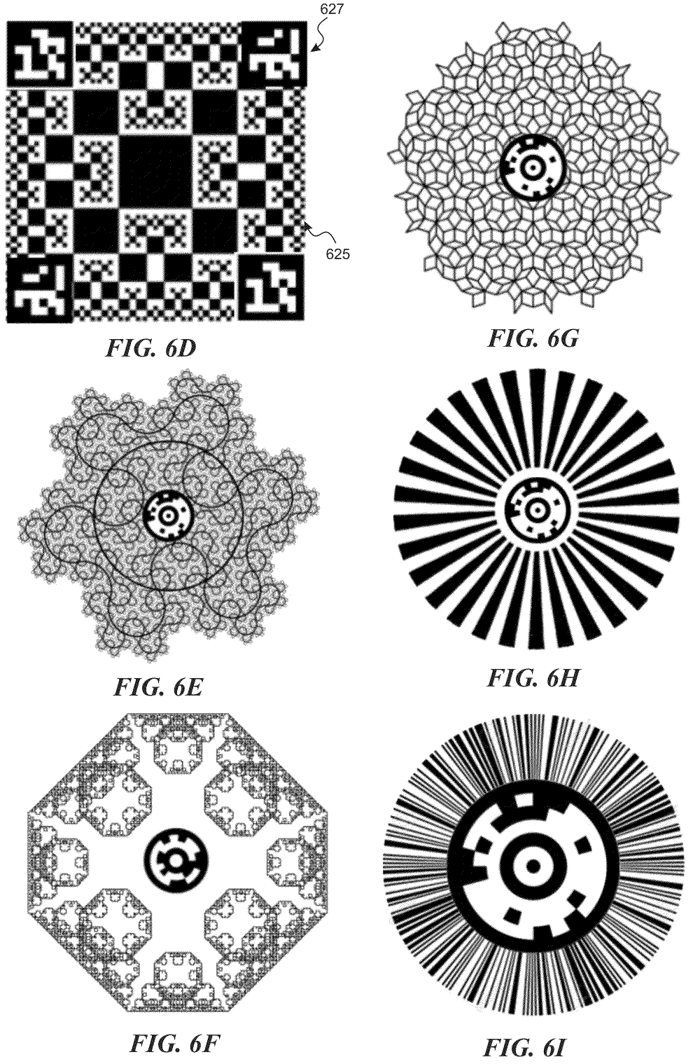

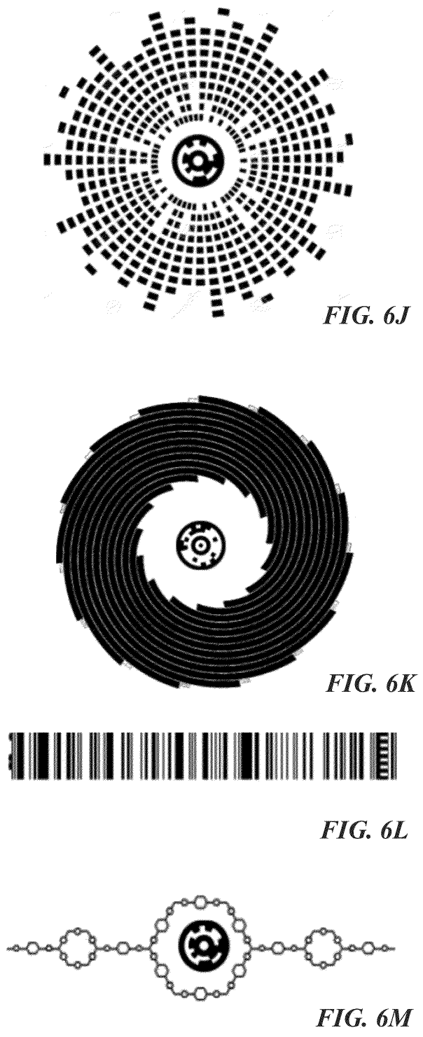

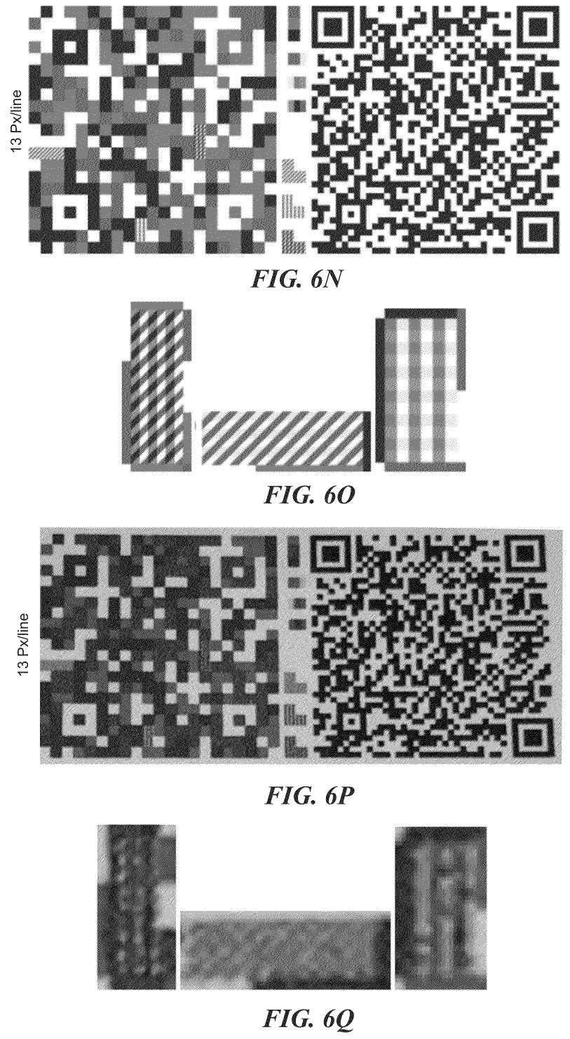

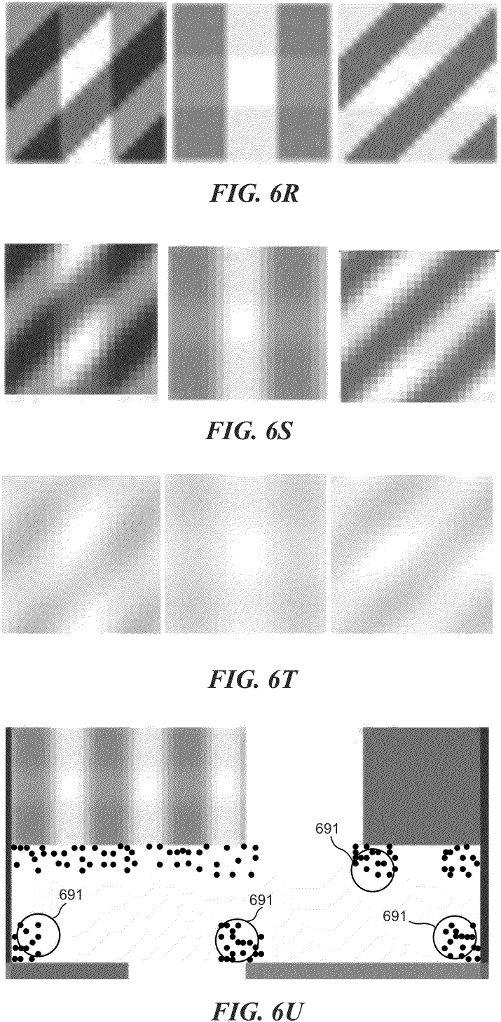

The security device (physical security device) can include a content component/content element (e.g., as shown in the examples of FIG. 6A ― FIG. 6B). The content component can include an encoded element such as a QR code. The QR code can for example, be placed adjacent to the color barcode. In one embodiment, the QR code encodes a URL that points to content related to the tag or content related a physical item/physical good associated with the tag. The URL can include a domain belonging to a 1st party (e.g. www.blocktag.com/tag0) as administered by a host (e.g., a host server 100 of FIG. 1 and/or host server 300 of FIGS. 3A-3B) or it can belong to a 3rd party (e.g., www.contoso.com/tag0). The QR may also be encoded with other metadata related to the authenticity component in case the color barcode runs out of offline storage space. The QR may also encode a hash of the color barcode’s serial number so there is a one-to-one correspondence between a QR and a color barcode. One embodiment of the present disclosure includes, a security device having a content element having, for example, at least one of: a URI, a URL or bar code and a 2D colored barcode disposed adjacent to the content element in the physical surface. The composite pattern can be embedded in the 2D colored barcode to form a polychrome pattern identifier. A further embodiment of the present disclosure includes, a security device (e.g., a tag, a “Blocktag”, a security device 108A-N as shown in the example of FIG. 1, security devices as shown in the example of FIGS. 6D-6M) having a content element having metadata and where the composite pattern is monochromatic and integrated in the content element. In one embodiment the metadata includes metadata defining characteristics of the composite pattern. In a further embodiment, the composite pattern forms a part of a marker element for lens distortion calibration of a scan device used to authenticate the security device. For example, the composite pattern which forms a part of the marker element can include a checkerboard pattern.

One embodiment of the present disclosure, includes a security device (e.g., a tag, a “Blocktag”, a security device 108A-N as shown in the example of FIG. 1, security devices as shown in the example of FIGS. 6D-6M) having a physical surface having formed thereon a composite pattern (e.g., composite patterns as shown in the examples of FIG. 2E - FIG. 2H, FIG. 2I-2, FIG. 2I-4― FIG. 2I-5, FIG. 2J). The physical surface can include paper or fabrics. The physical surface can also form a portion of document paper or product packaging. The physical surface can also include one or more of, glass, plastic and or metallic surface. The composite pattern can created from joining or overlap of imprinting of a first base pattern and a second base pattern, where the first base pattern is created from a first basic building block (e.g., base patterns and basic building blocks as shown in the examples of FIG. 2A - FIG. 2D, FIG. 2I-2, FIG. 2O, FIG. 2P). The second base pattern can be created from a second basic building block. A base pattern can, for instance, be created by repeating a basic building block with a rotation, and spatial periodicity. A base pattern can also be created by repeating a basic building block with a given phase shift.

Note that the characteristics of the composite pattern include an emergent shape of the composite pattern. The characteristics of the composite pattern can include, one or more of, a spatial periodicity of the composite pattern and an orientation angle of the composite pattern with the spatial periodicity being determined from the first base pattern or the second base pattern (e.g., by the chaosmetrics specification engine 342 and/or the component specification engine 344 of the security device generator 340 of the host server 300 shown in the example of FIG. 3A). The orientation angle can also be determined from the first base pattern or the second base pattern. The characteristics of the composite pattern can also include, one or more emergent colors which arise from overlap of the first base pattern with different colors. The characteristics of the composite pattern can also include a degree of ink bleeding into the physical surface. Such characteristics of the composite pattern can be quantifiable (e.g., by the fingerprint engine 314 of the example of FIG. 3A and/or the fingerprint engine 415 of FIG. 4A) and used to in authentication (e.g., by the authentication engine 318 of the example of FIG. 3A and/or the authentication engine 414 of the example of FIG. 4A) of the security device. The basic building blocks selected can form chaosmetric artifacts in the physical surface upon printing. Therefore, the composite pattern also forms chaosmetric artifacts in the physical surface upon printing. In one example, the composite pattern can be formed as a part of a marker element for lens distortion calibration of a scan device used to authenticate the security device.

In one embodiment, the security device includes a content element having metadata (e.g., as shown in the examples of FIG. 6A - FIG. 6M). The composite pattern can be formed within a polychrome pattern (as shown in the examples of FIG. 21, FIG. 2J, FIG. 2K, FIG. 2L) and disposed adjacent to the content element. The polychrome pattern can include, for example, a 2D colored barcode. In one embodiment, the security device includes a content element having metadata (e.g., as shown in the examples of FIG. 6A - FIG. 6M). The content element and the composite pattern can be formed within a square or rectangular form factor. Alternatively, the content element is formed as a central circle and the composite pattern is formed as a ring surrounding the central circle. For example, the content element can include a circular QR code, a Cantag marker, or a ShotCode circular barcode. In one embodiment, the ring surrounding the central circle can have or be embedded or generated with one or more of, a fractal pattern or a halftone pattern. In addition, a ring surrounding the central circle can have formed within, a composite pattern and an identity element. The identity element can include, for example, line gratings or a circular barcode.

In one embodiment, the security device includes a monochrome fractal pattern (as shown in the examples of FIG. 6A-1) formed along one or more edges of the content element or along one or more edges of the composite pattern. Alternatively, the monochrome fractal pattern can be formed to overlap the content element for chaosmetric enhancement. The monochrome fractal pattern (as shown in the examples of FIG. 6A-1) can also be formed within features of the content element for chaosmetric enhancement. The content element of the security device can include one or more of, a URI, a URL or bar code. For example, the content element of the security device can include metadata formed as a QR code. The QR code can, for example, be converted into a hilbert curve fractal pattern for chaosmetric enhancement.

One embodiment of the security device includes a 2D colored barcode (as shown in the examples of FIG. 2I, FIG. 2J, FIG. 2K, FIG. 2L) disposed adjacent to the content element in the physical surface. The composite pattern can be embedded in the 2D colored barcode to form a polychrome pattern identifier. The composite pattern can alternatively be monochromatic (as shown in the examples of FIGS. 2B-2E) and integrated in the content element having metadata. The metadata of the content element therefore also includes additional metadata defining characteristics of the composite pattern.

A further embodiment of the security device includes a resolution test component (e.g., as shown in the examples of FIG. 2I-1 ). The resolution test component can have formed thereon, line gratings with predetermined thicknesses and distances between each of the line gratings. The calibration component can also be disposed in the same plane as the security device to be authenticated. The calibration component can be used in assessing a resolution power of a scan device used to authenticate the security device. In one example, the resolution profile of the scan device is characterized as a function of a distance between the resolution test component and the scan device. In addition, the security device can include a fractal grid integrated with the content element as reference lines, as shown in the example of FIG. 6A-6.

One embodiment of the present disclosure, includes a security device (e.g., a tag, a “Blocktag”, a security device 108A-N as shown in the example of FIG. 1, security devices as shown in the example of FIGS. 6D-6M) having a physical surface having formed thereon a composite pattern. The composite pattern can created (e.g., by the chaosmetrics specification engine 342 and/or the component specification engine 344 of the security device generator 340 of the host server 300 shown in the example of FIG. 3A) from joining or overlap of an imprint of a first base pattern and an imprint of a second base pattern, where the first base pattern is created from a first basic building block. The second base pattern can be created from a second basic building block. The second base pattern can be created by repeating the second basic building block with a given rotation and/or a given spatial periodicity. The second base pattern can in one embodiment, be created by repeating the second basic building block with a given phase shift. In one embodiment, the first base pattern is a fractal pattern (e.g., as shown in the examples of FIG. 2H-1, FIG. 2O, FIG. 2P) based on the first basic building block and the first basic building block forms chaosmetric artifacts in the physical surface upon printing.

The fractal pattern can be generated (e.g., by the chaosmetrics specification engine 342 and/or the component specification engine 344 of the security device generator 340 of the host server 300 shown in the example of FIG. 3A) using the Lindenmayer system or the Iterative Function system (IFS). One embodiment of the fractal pattern includes fractal segments having halftones at different periodicities. The chaosmetric artifacts that created in the physical surface can be quantified to generate a chaosmetric identifier for the first base pattern (e.g., by the fingerprint engine 314 of the example of FIG. 3A and/or the fingerprint engine 415 of FIG. 4A). The chaosmetric identifier of the first base pattern can, for example, be determined from the periodicities of the halftones in the fractal segments. The chaosmetric artifacts can include fractal chaosmetric artifacts that arise from a dimension of the fractal pattern and/or a lacunarity of the fractal pattern. In general, the chaosmetric artifacts can include the set of fractal chaosmetric artifacts arising from a dimension and a lacunarity of the fractal pattern, and a second set of chaosmetric artifacts arising from the first basic building block. In one embodiment, the first basic building block includes straight line segments and the first base pattern includes a rounded-corner fractal pattern formed from the straight line segments with sharp corners replaced by a round corner (e.g., as shown in the example of FIG. 2P). A characteristic of the composite pattern can include an emergent shape of the composite pattern and the emergent shape of the composite pattern is assembled from shapes and positions of the first basic building block and the second basic building block.

In a further embodiment, the composite pattern formed on a physical surface of a security device is created from (e.g., by the chaosmetrics specification engine 342 and/or the component specification engine 344 of the security device generator 340 of the host server 300 shown in the example of FIG. 3A) joining or overlap of imprints of a first halftone pattern and a second halftone pattern. The composite pattern forms chaosmetric artifacts in the physical surface upon printing. The first halftone pattern can be created from a first basic building block. For example, the first halftone pattern can include an embedded fractal pattern formed from the first building block. The chaosmetric artifacts can include fractal chaosmetric artifacts generated in the physical surface from a dimension and/or a lacunarity of the embedded fractal pattern. In general, thee chaosmetric artifacts can include fractal chaosmetric artifacts and specific chaosmetric artifacts of the first basic building block

The second halftone pattern can be created from a second basic building block, for example, by repeating the second basic building block with a given phase shift, a rotation and/or a given spatial periodicity. The chaosmetric artifacts created in the physical surface can be quantified to generate a chaosmetric identifier for the second halftone pattern. For example, the chaosmetric identifier of the second halftone pattern can be determined from its spatial frequency. The second basic building block can possess characteristics of one or more of, individual shape, orientation angle, a dimension, a position, a color. In one embodiment, the second halftone pattern is created by repeating the second basic building block with locations of each instance of the second basic building block specified in a coordinate system (e.g., by the chaosmetrics specification engine 342 and/or the component specification engine 344 of the security device generator 340 of the host server 300 shown in the example of FIG. 3A).

A characteristic of the composite pattern can be quantifiable and used to authenticate the security device. The characteristic of the composite pattern can include, for example, one or more emergent colors which arise from overlap of the second halftone pattern with different colors. The characteristic of the composite pattern can also include an order of printing of the first halftone pattern and the second halftone pattern or a degree of ink bleeding into the physical surface of the security device. The characteristic of the composite pattern can also a spatial periodicity and/or an orientation angle determined from the second halftone pattern. In one embodiment, a characteristic of the composite pattern includes an emergent shape of the composite pattern. For example, the emergent shape of the composite pattern can be assembled from shapes and positions of the first basic building block and the second basic building block (e.g., by the chaosmetrics specification engine 342 and/or the component specification engine 344 of the security device generator 340 of the host server 300 shown in the example of FIG. 3A). The security device can further include a content element having metadata (e.g., as shown in the examples of FIG. 6A - FIG. 6B). For example, the content element can have at least one of: a URI, a URL or bar code. In one embodiment, the composite pattern is monochromatic and integrated in the content element and the metadata includes metadata defining characteristics of the composite pattern. The security device can further include a 2D colored barcode (as shown in the examples of FIG. 2I, FIG. 2J, FIG. 2K, FIG. 2L) disposed adjacent to the content element in the physical surface. For example, the composite pattern can be embedded in the 2D colored barcode to form a polychrome pattern identifier. In a further embodiment, the composite pattern forms a part of a marker element (e.g., as shown in the example of FIG. 6B) for lens distortion calibration of a scan device used to authenticate the security device. For example, the composite pattern which forms a part of the marker element includes a checkerboard pattern.

FIG. 1 illustrates an example block diagram of a host server 100 in an environment able to administer, generate, track, fingerprint, authenticate security devices in a network 106, in accordance with embodiments of the present disclosure. The client devices 102A-N (e.g. a scan device and/or a client/mobile device 402 of the example of FIG. 4A). can be any system and/or device, and/or any combination of devices/systems that is able to establish a connection with another device, a server and/or other systems. Client devices 102A-N each typically include a display and/or other output functionalities to present information and data exchanged between among the client devices 102A-N and the host server 100. For example, the client devices 102A-N can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, a wearable device, a head mounted device, a smart watch, a goggle, a smart glasses, a smart contact lens, and/or any other portable, mobile, hand held devices, etc.

The client devices 102A-N can also include an image or video input integrated display device, with or without a touch enabled display component, with or without optical and/or digital zoom capabilities such as a desktop/laptop computer with web camera or scanner, a Virtual Reality (VR), Augmented Reality (AR) or Mixed Reality (MR) headset/glasses with camera, a drone camera, a telescope camera, a microscope camera, a Closed Circuit Television (CCTV) security camera, a production line inspection camera, a wearable device with camera, a vehicle mount computer with camera, an embedded computer with imaging system, among other similar computing devices, to inspect, fingerprint and authenticate tags. The input mechanism on client devices 102A-N can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), eye tracking, eye detection, pupil tracking/detection, or a combination of the above.

The client devices 102A-N, security devices (Blocktag/tag) 108A-N, its respective networks of users 116A-N, a third party tag generator entity 112, and/or a print device 114, can be coupled to the network 106 and/or multiple networks. In some embodiments, the devices 102A-N and host server 100 may be directly connected to one another. In one embodiment, the host server 100 is operable to administer, read, generate, implement/specify, inspect, fingerprint, authenticate, verify, provision, scan, detect, decoding, identify, track, monitor, and/or deploy security devices in a network. The host server 100 can transmit, receive data or information regarding security devices 108A-N via client devices 102A-N. Functions and techniques performed by the host server 100 and the components therein are also described in detail with further references to the examples of FIGS. 3A-3B.

In general, network 106, over which the client devices 102A-N, the host server 100, the security devices 108A-N, the tag requestor entity 112, and/or the print device 114 communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102A-N and the host server 100 and may appear as one or more networks to the serviced systems and devices. In one embodiment, communications to and from the client devices 102A-N can be achieved by an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, 5G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The host server 100 may include internally or be externally coupled to the security device repository 122, the tag identity/property repository 124, the ledger address repository 126 and/or the scan log and authentication challenge repository 128. The host server 100 is able to generate, create and/or provide data to be stored in the security device repository 122, the tag identity/property repository 124, the ledger address repository 126 and/or the scan log and authentication challenge repository 128. The repositories can store software, descriptive data, images, system information, drivers, and/or any other data item utilized by other components of the host server 100 and/or any other servers for operation. The repositories may be managed by a database management system (DBMS), for example but not limited to, Oracle, DB2, Microsoft Access, Microsoft SQL Server, PostgreSQL, MySQL, FileMaker, etc. The repositories can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

Users who want to generate, create, modify, adjust, or design blueprints of the security device 108 can in one embodiment, self-serve the process via the disclosed system (e.g., the host server 100 of FIG. 1 and/or the host server 300 of FIGS. 3A-3B and/or the device 102A-N as shown in the example of FIG. 1 and/or the device 402 of the example of FIG. 4A) which can for example be accessed via the host server’s website (e.g., Blocktag’s website). The blueprint can be used to print the security device 108 using a print device (e.g., print device 114). Given a blueprint of the security device 108 with a digital pattern, the printer (e.g., print device 114) can be configured to generate random (chaotic) print anomalies, chaosmetric patterns/artifacts, so that each printed pattern instance is unique. The chaotic print anomalies are generally quantifiable and measurable.

For example, a tag requestor entity 112 can issue a request to generate a digital tag blueprint to the system (e.g., the host server 100 of FIG. 1 and/or the host server 300 of FIGS. 3A-3B and/or the device 102A-N as shown in the example of FIG. 1 and/or the device 402 of the example of FIG. 4A). In general, the requestor entity 112 can include individuals, groups of people, 3rd party companies, or other organizations. The blue print can be used by the print device 114 to generate the security device (e.g., a tag, a “Blocktag”, a security device 108A-N as shown in the example of FIG. 1). In one embodiment, the print device 114 is coupled to a chaos amplification unit 132. In one example, the chaos amplification unit 132 can be physically attached to the print device 114 to amplify the degree of chaos in printed patterns on the security device (e.g., a tag, a “Blocktag”, a security device 108A-N as shown in the example of FIG. 1).

The chaosmetric properties and chaosmetric print quality inspection of the security device 108 can be initiated by the tag generator entity 112 or other users 116A-N using the user device 102. The request for quality check can be sent to the host server 100 (e.g., the host server 100 of FIG. 1 and/or the host server 300 of FIGS. 3A-3B). If a security device 108 passes inspection (e.g., performed by the verification engine 310 and/or the inspection engine 312 of the host server 300 of FIGS. 3A-3B), the tag’s chaosmetric print property can be fingerprinted (e.g., via the verification engine 310 an/or the fingerprint engine 314 of the host server 300 of FIGS. 3A-3B) by the entity 112 using the user device (e.g., the device 102A-N as shown in the example of FIG. 1 and/or the device 402 of the example of FIG. 4A) able to communicate with the host server 100 (e.g., the host server 100 of FIG. 1 and/or the host server 300 of FIGS. 3A-3B).

The inspected and/or fingerprinted security device 108 can then be authenticated (e.g., by the authentication engine 318 of the example of FIG. 3A and/or the authentication engine 414 of the example of FIG. 4A) by other users 116A-N using the user device (e.g., the device 102A-N as shown in the example of FIG. 1 and/or the device 402 of the example of FIG. 4A) able to communicate with the host server 100 (e.g., the host server 100 of FIG. 1 and/or the verification engine 310 of the host server 300 of FIGS. 3A-3B). The parameters used to authenticate the physical tag 108 can be stored on a repository (e.g., the security device repository 322 and/or the tag identity/property repository 324 and/or the ledger address repository of FIG. 3A and/or the security device repository 122 and/or the tag identity/property repository 124 and/or the ledger address repository 126 and/or the scan log and authentication challenge repository 128 of FIG. 1, and/or the scan log and authentication challenge repository 428 of FIG. 4A). The parameters used to authenticate the physical tag 108 can also be encoded on the security device 108 itself which can be decoded or read by the user device (e.g. a scan device, a client/mobile device 102A-N as shown in the example of FIG. 1 and/or a client/mobile device 402 of the example of FIG. 4A).

The host server (e.g., the host server 100 of FIG. 1 and/or the security device generator 340 and/or the chaosmetrics specification engine 324 and/or the components specification engine 344 of the host server 300 of FIGS. 3A-3B) the host server 300 of FIGS. 3A-3B) can identify and/or generate tag configuration options (e.g., by the security device generator 340 of the host server 300 of FIGS. 3A-3B) via a user experience to the requestor 112. The user experience can be presented via user interface 104 in which the tag requestor entity 112 can interact with the host server 100. The tag configuration options can include a selection of parameters associated with the print device 114 such as brand, model, resolution, printer type (inkjet, laser), etc. The tag configuration options can also include parameters associated with the security device 108. Such parameters include, for example, width, height, text, logos, embedded metadata, etc. Access to the host server 100 (e.g., the host server 100 of FIG. 1 and/or the host server 300 of FIGS. 3A-3B or the security device generator 340 of the host server 300) can be provided by locally installed clients or generic applications, such as a browser on a computing device of the requestor entity 112.

In response to receiving a selection of configuration specification from the requestor entity 112, the host server 100 (e.g., the host server 100 of FIG. 1 and/or the host server 300 of FIGS. 3A-3B or the security device generator 340 of the host server 300) processes the selection (e.g., via the chaosmetrics specification engine 324 and/or the components specification engine 344 of the host server 300 of FIGS. 3A-3B). The host server (e.g., the host server 100 of FIG. 1 and/or the host server 300 of FIGS. 3A-3B or the security device generator 340 of the host server 300) can therefore generate and deliver tag blueprint candidates that the tag requestor entity 112 can download as files that are readable in whole by 3rd party software such as Portable Document Format (PDF) readers, Raster Image Processing (RIP) software (Onyx, Versaworks etc.), Computer Aided Design (CAD) software, among others. Tag blueprint candidates can be printed by the print device 114 and inspected using the user device (e.g., the client device 102A-N as shown in the example of FIG. 1 and/or the client device 402 of the example of FIG. 4A) to check the printed physical tag’s print quality. Tag blueprint candidates that pass inspection can then be copied and pasted in other image and/or vector graphics file formats such as PNG, JPG, JPEG, TIFF, SVG, among others for printing. The printed physical tags that pass inspection may be fingerprinted and authenticated.

The print device 114 can include for example, desktop home or office printers, industry-grade factory printers, point of sale receipt printers, portable/mobile pocket/backpack-sized photo printers, industrial label printers, 3D printers for example. Print device that deposit ink in additive ways such as inkjets, laserjet, ultraviolet curing, sublimation, heat transfer, water slide transfer, digital offset, 3D printing, microprinting, solid/hot-melt ink printing, or subtractive ways such as laser engraving/etching, laser marking, chemical etching, photolithography, photographic exposure, Computer Numerical Control (CNC) machining (drilling, boring, milling, reaming etc.). Print device of different feeder inputs such as flatbed, roller, paper tray, for example. Print device that prints directly or indirectly on different material substrates such as paper, leather, metals, wood, fabrics, glass, plastic, rubber, animal or human skin, for example. Print device that uses different ink types such as water or oil based ink, powder based toner, solid based ink (e.g. wax, crayons) among other similar printing devices.

The security device 108 can be printed directly on material surfaces such as document paper, product packaging, among others, or printed indirectly on sticker paper which is subsequently pasted on surfaces. Note that the chaos amplification unit 132 is an optional component (hardware and/or software) that can be coupled to the print device 114. The choas amplification unit 132 can be coupled to and controlled by the system (e.g., the host server 100 of FIG. 1 and/or the host server 300 of FIGS. 3A-3B and/or the device 102A-N as shown in the example of FIG. 1 and/or the device 402 of the example of FIG. 4A). In one example, the chaos amplification unit 132 can utilize physical phenomena to increase randomness of ink deposition during printing. For example, the chaos amplification unit 132 can enhance and manipulate chaosmetrics through the addition of mechanical vibrations, electrostatic charging, special ink, microdots, etc.

FIG. 2A depicts examples of multiple base patterns 202, 204, 206, 208 and 210 and their basic building blocks (lines of specified width, orientation angle, periodicity), in accordance with embodiments of the present disclosure. FIG. 2B depicts further examples of multiple base patterns 212, 214, 216 and 218 and their basic building blocks (white circles at specified positions), in accordance with embodiments of the present disclosure.

A blueprint of a security device (e.g., Blocktag, tag, etc.) can be designed using on a bottom-up approach or top-down approach using basic building blocks (e.g., lines, circles, squares, dots, etc.). Various characteristics of the basic building blocks can be specified. In general, a basic building block is a fundamental unit which produces chaosmetric artifacts in the material used to create the security device (e.g., a tag, a “Blocktag”, a security device 108A-N as shown in the example of FIG. 1, security devices as shown in the example of FIGS. 6D-6M) when printed. The characteristics of building blocks include, for example, one or more of, 1. Individual shape (Dot, straight line segment, curved line segment, letter, character etc.) 2. Orientation angle, 3. Dimensions (Radius, width etc), 4. Position (x, y coordinates) on the surface of the security device 5. Color (e.g., Cyan, Magenta, Yellow, Black, etc.). One or more basic building blocks can be used together to produce a base pattern. A basic building block can also be embedded with a base pattern. For example, a basic building block can be repeated to form a recurring halftone pattern with a certain rotation, spatial periodicity and/or phase shift measured as the number of digital pixels or printed dots along x and y-axis. When printed, this halftone property represents general chaosmetric artifacts in addition to a basic building block’s specific chaosmetric artifacts. In some embodiments, basic building blocks can also be defined and specified by placement on a coordinate system. For example, how a vertical/horizontal line grating can be positioned in Cartesian coordinates or how a circular tangential or radial grating can be drawn in polar coordinates.

FIG. 2C depicts an example of character ‘B’ as a basic building block embedded with a sinusoidal halftone base pattern whose image contrast is maximized by computer vision, in accordance with embodiments of the present disclosure. Note that the original printed character’s sinusoidal ink distribution will have less contrast, making it not obvious to human vision. FIG. 2D depicts an example character ‘B’ as a basic building block attached to a square wave and truncated Koch curve hybrid identifier, in accordance with embodiments of the present disclosure. The Koch curves can be flattened to reduce its human vision visibility. This depicts an example of where a basic building block has base patterns placed around its perimeter.

FIG. 2E depicts an example of emergent monochrome shapes 236 assembled from overlapping base patterns 232 and 234 with basic building block, in accordance with embodiments of the present disclosure. When two or more base halftone patterns overlap each other via printing one pattern on top of another, a composite pattern emerges. Such composite patterns have several characteristics that can be quantified and used for authentication. For example:
Emergent colors from overlapping base pattern with different colors (e.g. Cyan+Magenta=Blue, Cyan+Yellow=Green, Magenta+Yellow=Red).
Print order of overlapping base patterns. E.g. Different shades of red are derived from printing cyan pattern first, followed by magenta on top versus printing magenta first, followed by cyan on top.
Degree of colored ink bleeding unique to the printed material surface and ink type used.
Spatial periodicity of composite patterns derived from base pattern.
Orientation angle of composite patterns derived from base pattern.
Emergent shape assembled from the shapes and positions of each base pattern’s basic building block.
Emergent composite pattern assembled from basic buildings blocks

Overlapping halftone patterns solve the following problems:
The base halftone pattern’s spatial periodicity and rotation may be obvious to the naked eye, making it easy to clone. A composite pattern masks it’s underlying base patterns, making them more covert, less easy to clone and still maintain its spatial periodicity and rotation signal.
chaosmetric artifacts arising from a base pattern ink edge bleeding into paper may be insufficient to distinguish a printed original base pattern from a cloned base pattern. Composite pattern increases chaosmetric by causing ink bleeding not only into the paper but also between overlapping base pattern layers.

FIG. 2F depicts an example of cyan base pattern 242 and yellow base pattern 244 printed over each other and a new colored green pattern emerges in the composite pattern 246, in accordance with embodiments of the present disclosure. FIG. 2G depicts an example of colored base patterns in magenta 252, cyan 254, yellow 256 and an emergent composite pattern 258 when printed together, in accordance with embodiments of the present disclosure. FIG. 2H depicts a further example of colored base patterns in cyan, magenta yellow and emergent composite pattern when printed together, in accordance with embodiments of the present disclosure.

The base or composite pattern design can exist not only as a standalone authentication element but also, for example, integrated as part of a larger whole design blueprint or placed adjacent to other design elements. A base or composite pattern can be identified by association with the content or marker element it is physically attached to (e.g. a barcode’s serial number, a QR link), or by a separate serial identifier. Since a base/composite pattern produces chaosmetric artifacts when printed, this separate identifier is also referred to as a chaosmetric identifier. A chaosmetrics identifier improves security of data encoded in legacy track-and-trace systems such as barcodes, QR etc. For example:
A serial identifier / chaosmetric identifier of halftone base pattern can be derived from it’s spatial frequency.
A serial identifier / chaosmetric identifier of a fractal base pattern can be derived from:
   Variations in the fractal line segment’s embedded halftone periodicity as the line segment is traversed
   Replacing each square wave in a sawtooth edge binary pattern with a fractal subset (e.g. A Koch Curve with its sides truncated), as illustrated in the example of FIG. 2H-1.

FIG. 2H-1 depicts an example of creation of a chaosmetric identifier of a fractal base pattern, in accordance with embodiments of the present disclosure. Image 285 depicts an example of an original content element (QR code). Image 287 depicts an example of a Koch curve pattern. Image 289 depicts the additive fractal blue print joined along the QR edges.

FIG. 2I depicts examples of base or composite pattern integration in a larger design, in accordance with embodiments of the present disclosure. A scenario for integration as part of a larger whole further includes a serialization technique where each tag can be uniquely identified by a serial number using a 2D colored barcode. In one embodiment, the address space associated with the authenticity element space is expanded using polychrome patterns to generate a polychrome chaosmetric identifier. An example form factor for the polychrome pattern identifier is a 2D colored barcode based on Just Another Barcode (JAB). The disclosed security device embeds halftone/fractal patterns on top of the 2D colored bar code so that chaosmetric artifacts arise from the patterns when printed, making the security device with chaosmetric 2D colored barcode unclonable. A polychrome psychometric identifier enables the disclosed system to uniquely identify and track a much larger number of anti-counterfeit items and item relationships with people compared to monochrome identifiers to prove presence, possession and ownership. Overlapping the three base layers 272 creates the 2D colored barcode 274 with composite patterns from FIG. 2F and FIG. 2G. Note that the base patterns can be extended to cover more area up to the entire 2D colored barcode design. Overlapping the fully patterned cyan, magenta and pink layers of 276 produces intermittent red, green and blue (rgb) lines in the 2D barcode 278. Although the 2D barcode 278 is not fully colored in solid RGB, a scan device can still read the tag’s serial number from the emergent composite pattern while authenticating the patterns based on the line orientation angle, thickness, phase shift etc.

FIG. 2I-1 depicts an example of a resolution test target to measure resolution of a scan device, in accordance with embodiments of the present disclosure. In one embodiment, halftones with variable line gratings can be used to determine the highest resolution line grating that the scan device (e.g. a user device, a client/mobile device 102A-N as shown in the example of FIG. 1 and/or a client/mobile device 402 of the example of FIG. 4A) is able to resolve as a function of perpendicular distance between the halftone and scan device. Variable halftones solve the problem of how to manage authentication on scan devices with different resolutions on a decentralized Blocktag system. Variable halftones can be used as resolution test targets to measure the resolution of a scan device. A resolution test target can include reference line patterns with well-defined thicknesses and spacings and are designed to be placed in the same plane as the object being imaged. By identifying the largest set of non-distinguishable lines, the resolving power of a given system (e.g., scan device) is determined.

FIG. 2I-2 depicts examples of base or composite pattern utilizing watercolor illusion halftones, in accordance with embodiments of the present disclosure. The watercolor effect is an optical illusion in which a white area takes on a pale tint of a thin, bright, intensely colored polygon surrounding it if the colored polygon is itself surrounded by a thin, darker border. Watercolor illusion halftones address the problem of counterfeiters wanting to eyeball and re-render the blueprint of a printed Blocktag (e.g., security device). In one embodiment, optical illusions can be used to mask the true color of white areas on the Blocktag’s original blueprint. The white areas may or may not have a colored pigment printed on it. The white area’s true pigment value is encoded in the Blocktag’s content element. For example, the vertical gratings 261 are black and white with a thin line of red along each black bar. The horizontal gratings 263 are black and white with a thin line of green along each black bar. The illusion is that the red and green appear to spread over the black and white regions of the vertical and horizontal gratings respectively. FIG. 2I-3 depicts examples of induction images 271 and 273 and a test image 275 illustrating the inductive illusion halftone technique, in accordance with embodiments of the present disclosure. In one embodiment, a halftones pattern in a security device (e.g., a tag, a “Blocktag”, a security device 108A-N as shown in the example of FIG. 1, security devices as shown in the example of FIGS. 6D-6M) is implemented to induce optical illusions called the McCollough effect. McCollough is a phenomenon of human visual perception in which colorless gratings appear colored contingent on the orientation of the gratings. It is an aftereffect requiring a period of induction to produce it. For example, if a user alternately looks at a red horizontal grating 271 and a green vertical grating 272 for a few minutes, a black-and-white horizontal grating 279 will then look greenish and a black-and-white vertical grating 277 will then look pinkish. A Blocktag can be implemented to use the McCollough effect to authenticate proof of presence/possession. Firstly, black and white halftones of different rotations may be printed within a Blocktag’s QR. To induce the optical illusion in a user, color halftones may be printed on other parts of the tag. If small printed color halftones are unable to induce optical illusion, bigger color halftones may be rendered digitally on a user’s scan device. When a user scans a Blocktag for authentication, the scan device can prompt the user to:
1. Look at the printed or rendered color halftones
2. Tap on the warped perspective QR areas where black and white halftones appear colored due to the McCollough effect.

Utilization of the McCollough effect solves the problem of determining whether a user is real or a spam robot. The McCollough effect is leveraged to authenticate a user-item combination in the physical world. The disclosed security device implementation using the McCollough effect manipulates colors using optical illusions and relies on human ability to determine which colors are perceived on a Blocktag. Even if a spam robot fools McCollough authentication, the infinitesimally short time used by the robot to authenticate is distinguishable from the longer, more realistic amount of time used by a human user.

FIG. 2I-4 depicts an example of a semicircular grating joined with a vertical line grating to form a fingerprint shape, in accordance with embodiments of the present disclosure. FIG. 2I-5 depicts an example of a semicircular grating joined with a vertical or horizontal line grating to form an S-shaped pattern, in accordance with embodiments of the present disclosure. In one embodiment, halftones of different base patterns are joined to form a composite halftone. For example, a vertical grating may be joined with a semicircular tangential grating to form a composite fingerprint-shaped elongated circular grating or a continuous S shaped pattern. Joint halftones formed from different base patterns can solve the challenge of limited real estate on a Blocktag to include the components of:
a. Identity element
b. Authenticity element
c. Content element
d. Chaosmetrics features or artifacts (Ink deposited by an inkjet printer along tangential lines of a circular grating can be more deformed.)
e. Macro inherent structures for print quality inspection
f. Resolution test target to quantify resolution of scan device
g. Design aesthetics elements
h. Optical illusions elements

Multiple requirements can be satisfied on the same printed area when halftones are joined. For example, an S shaped pattern can be drawn as a bounding box design around the boundaries of a Blocktag to meet requirements d, e and f. In one embodiment, a fractal’s line segments can be halftoned with different periodicities to generate a halftone fractal pattern. In this way, the halftoned fractal can increase the probability of printing specific chaosmetric distortions as halftoning increases the fractal’s total line edge length to surface area ratio. In a further embodiment, a space filling fractal can be superimposed on a halftone such that fractal’s pattern is small enough and does not interfere with the halftone’s basic building block. For example, in a Hilbert curve fractal with line width smaller than a halftone grating’s line width, the darker the halftone’s gray scale, the smaller Hilbert curve’s fractal scale. Embedding a fractal in a halftone enhances the probability of printing specific chaosmetric distortions by increasing the halftone’s total line edge to surface area ratio and number of fractal scale levels. FIG. 2I-6 depicts an example of a circular tangential halftone quadrant 281 redrawn as Hilbert space filling curves 283 in accordance with embodiments of the present disclosure. Hilbert curves at bigger scale levels are seen along the gray edges of the wavefront pattern. Hilbert curves at smaller scale levels are seen in the internal darker regions of each wavefront.

FIG. 2J depicts examples of additional pattern variants, in accordance with embodiments of the present disclosure. Another variant of the base pattern’s basic building blocks uses squares and/or circles instead of lines as shown in the patterns of 282. Yet another variant of the base pattern’s basic building blocks uses squares of different widths and/or circles or any shape to be used as the basic elements of different radii with no white spaces as shown in 284. The lighter the component primary color (e.g. Cyan) in the 2D colored barcode, the smaller the size of the square and/or circle. Overlapping the three layers of cyan, magenta and yellow produces a secondary emergent composite red, blue, green pattern of 286. Any scanner can read the overall tag’s serial number even though this patterned 2D colored barcode is less obvious than the original solid 2D colored barcode. FIG. 2K depicts examples of secondary emergent patterns 289, in accordance with embodiments of the present disclosure. In addition to the three base colors of cyan, magenta and yellow, An optional fourth base color pattern, black, can be added with specified base pattern parameters (e.g. Orientation angle, square/circle size) as shown in 287 to represent the lightness/darkness of the 2D colormap. Overlapping the four layers of cyan, magenta, yellow and black produces a secondary emergent spatial pattern. This secondary pattern can be modeled as a subset of the base patterns similar to the examples of FIG. 2B. From 4 layered 2D colored barcode 288, a secondary emergent spatial pattern 289 can be identified in black and white from the 2D color barcode 288. This secondary emergent pattern having a black and white pattern 289 is a subset of an extended spatial pattern from the center of the image 290.

FIG. 2L depicts an example of a pattern 292 placed adjacent to another design element 294, in accordance with embodiments of the present disclosure. Patterns can also be placed adjacent to other design elements to, better detect the positions of the base/composite patterns, enhance security of data encoded in legacy systems including but not limited to 1D barcodes, 2D barcodes such as QR codes, and/or check alignment of overlapping colored pattern layers when printing. FIG. 2M depicts an example of a base pattern 296 embedded in an adjacent legacy design element such as a 2D barcode 298, in accordance with embodiments of the present disclosure. Base patterns can also be embedded in adjacent legacy design elements like 2D barcodes such as QR codes to, calibrate the spatial overlapping in black and white (monochrome) before adding color as another layer of complexity or to calibrate the camera parameters and lens distortion unique to each scanner (e.g. Phone cameras). The hybrid QR with embedded base patterns can still be successfully read by any QR scanner.

FIG. 2N depicts an example of a Koch curve pattern in accordance with embodiments of the present disclosure. The illustrated Koch curve pattern exhibits nested and recursive sawtooth structures at 5 scale levels (n=0, 1, 2, 3, 4). FIG. 2O depicts an example of basic building blocks of line segments connect to one another to form a fractal pattern, in accordance with embodiments of the present disclosure. In one embodiment, the formation of a base pattern from basic building blocks is specified by predefined rules. For example, the Lindenmayer system or Iterative Function System (IFS) that define how a line segment is connected to another line segment to form recursive patterns such as fractal patterns. When printed, the fractal’s dimension and/or lacunarity are general chaosmetric artifacts in addition to a basic building block’s specific chaosmetric artifacts. FIG. 2P depicts examples of fractal patterns with rounded corners, in accordance with embodiments of the present disclosure. Fractal pattern 201 is an example of an 8 iteration Dragon curve fractal with rounded corners. Fractal pattern 203 is an example of a 2 iteration Peano curve fractal with rounded corners.In one embodiment, fractal straight line segments that join one point to another point to form sharp corners (e.g. In a Koch Curve) in a fractal pattern can be replaced by a best fit curved line segment (e.g. Bezier Curve) that intersects those same points to form round corners for integration in the disclosed security devices. The fractal pattern with curved corners has the same fractal dimension as the fractal with sharp corners. More specific chaosmetric artifacts can be printed on a round-cornered fractal pattern by inkject printers in comparison with sharp corners.

FIG. 3A depicts an example functional block diagram of a host 300 server to administer, generate, track, print, duplicate, fingerprint and/or authenticate security devices in a network, in accordance with embodiments of the present disclosure

The host server 300 includes a network interface 302, a verification engine 310, an integration engine 330, and/or a security device (tag) generator 340. The host server 300 is also coupled to a security device (Blocktag/tag) repository 322, a tag identity/property repository 324 and/or a ledger address repository 326. Each of the verification engine 310, integration engine 330 and/or the security device (tag) generator 340 can be coupled to each other. One embodiment of the verification engine 310 further includes, an inspection engine 312, a fingerprint engine 314 and/or an authentication engine 318. One embodiment of the integration engine 330 includes a telemetry identifier 332 and/or a time proof engine 334. One embodiment of the security device (tag) generator 340 includes, a chaosmetrics specification engine 342 and/or a components specification engine 344.

Additional or less modules can be included without deviating from the techniques discussed in this disclosure. In addition, each module in the example of FIG. 3A can include any number and combination of sub-modules, and systems, implemented with any combination of hardware and/or software modules. The host server 300, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

One embodiment of the present disclosure, includes a system (e.g., the host server 100 of FIG. 1 and/or the host server 300 of FIGS. 3A-3B and/or the client/mobile device 102A-N as shown in the example of FIG. 1 and/or the client/mobile device 402 of the example of FIG. 4A) to generate a blueprint of a security device. The system can include, a host server (e.g., a host, a host server 100 of FIG. 1 and/or host server 300 of FIGS. 3A-3B) configured to generate the blueprint of the security device, In operation the host server can determine a set of configuration options to generate the blueprint and generates a candidate of the blueprint in response to receipt of a request to generate the blueprint. The set of configuration options can include, for example, a first set of parameters associated with one or more specification of the print device and/or a second set of parameters associated with the security tag. In one embodiment, the host server generates the set of configuration options (e.g., by the chaosmetrics specification engine 342 and/or the component specification engine 344 of the security device generator 340 of the host server 300 shown in the example of FIG. 3A) based on the one or more specifications of the print device (e.g., a print device 114 as shown in the example of FIG. 1). In general, the request transmitted to the host server can include one or more specifications of the print device, The one or more specification can include, for example, printing resolution, printing mechanism, printer model, and printer brand etc. The candidate of the blueprint is generated to be embedded with chaosmetric features. The system can further include a print device (e.g., a print device 114 as shown in the example of FIG. 1) to print the candidate of the blueprint and a scan device coupled to the host server.

In one embodiment, the scan device (e.g. a client/mobile device 102A-N as shown in the example of FIG. 1 and/or a client/mobile device 402 of the example of FIG. 4A).is provisioned by the host server (e.g., a host, a host server 100 of FIG. 1 and/or host server 300 of FIGS. 3A-3B) for inspection and authentication of blueprint candidates. The scan device can also be operable to inspect the blueprint (e.g., by the inspection engine 413 of FIG. 4A) to determine a chaosmetric metric of a print quality of the blueprint of the security device printed by the print device. Note that the chaosmetric metric of the print quality of the blueprint printed by the print device is determined from quantification or scoring of the blurriness or sharpness of a line printed in the blueprint (e.g., by the inspection engine 312 of the example of FIG. 3A and/or the inspection engine 413 of FIG. 4A). If the print quality of the blueprint passes inspection, the security tag can be activated by the system for replication or for use and is able to be authenticated (e.g., by the authentication engine 318 of the example of FIG. 3A and/or the authentication engine 414 of the example of FIG. 4A) using authentication parameters. In addition, in response to detection that the scan device is used to inspect the blueprint, the host server can also register an identifier of the scan device as being associated with a requester user of the request to generate the blue print.

In one embodiment, the print device (e.g., the print device 114 as shown in the example of FIG. 1) is coupled to a chaos amplification device (e.g., the chaos amplification unit 132 as shown in the example of FIG. 1) to control a degree of chaos in printing. The chaos amplification device can for example, include mechanical components configured to perform vibrations, such that the vibrations are mechanically coupled to a print head or nozzle of the print device to displace ink during printing. For example, the chaos amplification device can modify a degree of chaos in printing through generation of mechanical vibrations to adjust randomness of ink deposition in printing. The chaos amplification device can alternatively include an electrostatic charging component where the electrostatic component is adapted to affect distribution of electrostatically charged toner during printing. For example, the electrostatic component distributes negative or positive charges onto a printing target to adjust the distribution of electrostatically charged toner during printing onto the printing target.

In a further embodiment, the system include a database (e.g., the security device repository 322 and/or the tag identity/property repository 324 and/or the ledger address repository of FIG. 3A and/or the security device repository 122 and/or the tag identity/property repository 124 and/or the ledger address repository 126 and/or the scan log and authentication challenge repository 128 of FIG. 1, and/or the scan log and authentication challenge repository 428 of FIG. 4A) to store the authentication parameters for the security device where the security device is able to be authenticated by the scan device using authentication parameters. In one embodiment, the authentication parameters for the security device are encoded in the security device and decoded by the scan device.

The system (e.g., the host server 100 of FIG. 1 and/or the host server 300 of FIGS. 3A-3B and/or the client/mobile device 102A-N as shown in the example of FIG. 1 and/or the client/mobile device 402 of the example of FIG. 4A) provides more robust authentication features using other properties such as color and frequency of the security device for authentication (e.g., by the authentication engine 318 of the example of FIG. 3A and/or the authentication engine 414 of the example of FIG. 4A). A pattern’s frequency and color distribution can be unaffected even if portions of the pattern are obscured, occluded or damaged. A further advantage of the disclosed technology provides greater chaosmetrics across various printer form factors. Printers having different dots per inch (dpi) resolution printing of different types of paper produces random micro deformations at different physical dimensions. The fractal features in the disclosed security devices (e.g., a tag, a “Blocktag”, a security device 108A-N as shown in the example of FIG. 1) maximizes chaosmetrics (e.g., by the chaosmetrics specification engine 342 and/or the component specification engine 344 of the security device generator 340 of the host server 300 shown in the example of FIG. 3A) across different printers as fractals exhibit the same pattern at different levels of scale. For example, the disclosed system can generate a Koch Curve representing sawtooths (e.g., as shown in the example of FIG. 2N) at multiple recursive scale levels within the print resolution of a printer. The system (e.g., the host server 100 of FIG. 1 and/or the host server 300 of FIGS. 3A-3B and/or the device 102A-N as shown in the example of FIG. 1 and/or the device 402 of the example of FIG. 4A) can identify the scale level which can exhibit the most chaosmetrics.

The disclosed technology also enables cost efficient chaosmetrics artifact printing. For example, the system can perform subtractive printing where black ink is discounted from within the anti-counterfeit element to generate chaosmetrics artifacts. Subtractive printing can be performed without affecting scannability as long as black ink is subtracted from portions of the anti-counterfeit element (e.g. QR, barcode) within it’s error correction limits. This feature is more cost and resource efficient in comparison to approaches using additive printing where black ink is added to the edges of an anti-counterfeit element to generate chaosmetrics artifacts. The system also generates an increased number of chaosmetric unique identifiers (e.g., address space) that can be encoded per unit physical area on a security device. The system can use a multi-colored chaosmetrics encoding system that can encode more data in comparison to black and white implementations which encodes a serial ID in a binary format.

Embodiment of the present disclosure includes systems and processes to detect, read, and/or identify fractal images (e.g., fractal images printed on an object). In one embodiment, the system (e.g., the host server 100 of FIG. 1 and/or the host server 300 of FIGS. 3A-3B and/or the client/mobile device 102A-N as shown in the example of FIG. 1 and/or the client/mobile device 402 of the example of FIG. 4A) can detect specific chaosmetric artifacts from distortions caused by random ink edge bleeding. For example, in a security device with fractal features/patterns, the chaosmetric signal-to-noise ratio for authentication can be increased by using a micro-scale index also referred to as “structural similarity” to compare a fractal’s specific chaosmetric artifacts with a fingerprinted baseline (e.g., by the authentication engine 318 of the example of FIG. 3A and/or the authentication engine 414 of the example of FIG. 4A). Such micro-scale index can be used for authentication in addition to measuring macro-scale indices caused by the general distortion patterns in a fractal pattern to compare a fractal pattern’s general chaosmetric artifacts with a fingerprinted baseline. The macro-scale indices can arise from how a printer distributes ink on an item’s surface or how an item’s textured surface absorbs ink. The macro-scale indices can include for example, fractal dimension that quantifies a fractal’s overall complexity and lacunarity that quantifies a fractal’s overall emptiness or heterogeneity.

To authenticate a security device accurately with the micro-scale structural similarity index, the system further amplifies the signal from a printed fractal’s specific chaosmetric artifacts by customizing the fractal pattern (e.g., by the chaosmetrics specification engine 342 and/or the component specification engine 344 of the security device generator 340 of the host server 300 shown in the example of FIG. 3A). For example, in security devices, straight line segments that join one point to another point to form sharp corners (e.g. In a Koch Curve) can be replaced by a best fit curved line segment (e.g. Bezier Curve) that intersects those same points to form round corners. The fractal pattern with curved corners has the same fractal dimension as the fractal with sharp corners. An inkjet printer will print more specific chaosmetric artifacts on the round-cornered fractal as inkjet printers cannot deposit ink well along the round corner’s diagonal tangent lines.

Since fractal dimension/lacunarity is zoom invariant, one process of authenticating fractals uses a printer’s dots per inch resolution and a scan device’s camera resolution. In this method, the perpendicular distance between the printed fractal and scan device (e.g. a user device, a client device 102A-N as shown in the example of FIG. 1 and/or a client device 402 of the example of FIG. 4A) is not utilized. This process of authentication (e.g., by the authentication engine 318 of the example of FIG. 3A and/or the authentication engine 414 of the example of FIG. 4A) can, in some instances be sufficient to measure a printed fractal’s general chaosmetric patterns. But if the scan device is too far away from the fractal, it may interpolate pixels and miss specific print distortions along the fractal’s recursive edges. This reduces chaosmetrics and affects the fractal’s authentication accuracy.

One embodiment of the present disclosure provides an optimization of authentication by printing markers with a fractal so that a scan device (e.g. a user device, a client/mobile device 102A-N as shown in the example of FIG. 1 and/or a client/mobile device 402 of the example of FIG. 4A). can determine the fractal’s width/height and calculate the perpendicular distance between the printed fractal and scan device. This distance can be provided as feedback on a scan device during print quality inspection and authentication so that a user scans the printed fractal close enough to measure micro chaosmetric artifacts precisely. Embodiments of the present disclosure expands the definition of a fundamental unit of authentication from an item to include an item-device pair. The fractal identification through authentication of features (e.g., by the authentication engine 318 of the example of FIG. 3A and/or the authentication engine 414 of the example of FIG. 4A) unique to an item (e.g., Fractal dimension and lacunarity) proves item authenticity. The system (e.g., the host server 100 of FIG. 1 and/or the host server 300 of FIGS. 3A-3B and/or the device 102A-N as shown in the example of FIG. 1 and/or the device 402 of the example of FIG. 4A) can authenticate features unique to the combination of an item and a user’s scan device to prove not only an item’s authenticity but also an authentic item’s relationship with the user. The disclosed item-device feature is based on halftone patterns of different periodicities embedded with the fractal patterns. Unlike fractal dimension which is zoom invariant, a halftone’s sharpness appears more blurred as the scan device zooms out or is moved farther away. For a given distance and zoom magnification (e.g. 2x optical zoom and up to 10x digital zoom on iPhone 11) between a halftoned fractal and a scan device’s camera, the halftones patterns with features above a certain periodicity is visible on the scan device. Otherwise, the scan device over-interpolates pixels and blurs halftones with smaller periodicities, which can cause the halftones to be unreadable. Halftone visibility perceived by a scan device is used as the unique item-device feature to prove different types of relationship between an item and a user. Such relationships include, for example:
A. Proof of Presence: Prove that an item tagged with a security device (e.g., a tag, a “Blocktag”, a security device 108A-N as shown in the example of FIG. 1) is within line of sight and at a quantifiable close proximity distance from a scan device registered by a user. To prove this, the Blocktag must be scanned by the device to authenticate. For example: An item’s Blocktag seen through a store window can be scanned by a user’s device to prove the user’s relative physical proximity with the tag.
B. Proof of Possession: Prove that an item’s Blocktag is not only in close proximity and within line of sight of a user’s device (e.g. a scan device, a client/mobile device 102A-N as shown in the example of FIG. 1 and/or a client/mobile device 402 of the example of FIG. 4A), but also the user has physical control of the Blocktag. To prove this, the user must scan the Blocktag to authenticate. For example, a Blocktag tagged item that is held in a user’s hand can be scanned to prove the user’s physical control over the tag.
C. Proof of ownership. Prove that a user owns an item.

Embodiments of the present disclosure extends authentication from short range to long range. To be authenticated (e.g., by the authentication engine 318 of the example of FIG. 3A and/or the authentication engine 414 of the example of FIG. 4A) reliably at long ranges, the disclosed security device includes embedded halftone patterns of different periodicities in the fractal pattern. For a given distance between a printed halftoned fractal and a scan device’s camera, the halftones above a certain periodicity is visible on the scan device. Otherwise, the scan device (e.g. a user device, a client/mobile device 102A-N as shown in the example of FIG. 1 and/or a client/mobile device 402 of the example of FIG. 4A) interpolates pixels and halftones with smaller periodicities are not visible. Moreover, halftones within a certain periodicity range can also interfere with the grid pattern of a camera’s sensor array to produce emergent Moire patterns. Halftone visibility and Moire patterns represent long range chaosmetric signatures unique to a camera pointed at a halftoned fractal. At long range distances between a printed fractal and a scan device, the system can capture any specific chaosmetric patterns unique to the printed fractal. Such an implementation prevents a bad actor skilled in fractal art from eyeballing, decoding and recreating the overt anti-counterfeit fractal patterns to fool authentication.

The network interface 302 can be a networking module that enables the host server 300 to mediate data in a network with an entity that is external to the host server 300, through any known and/or convenient communications protocol supported by the host and the external entity. The network interface 302 can include one or more of a network adaptor card, a wireless network interface card (e.g., SMS interface, WiFi interface, interfaces for various generations of mobile communication standards including but not limited to 1G, 2G, 3G, 3.5G, 4G, LTE, 5G, etc.,), Bluetooth, a router, an access point, a wireless router, a switch, a multilayer switch, a protocol converter, a gateway, a bridge, bridge router, a hub, a digital media receiver, and/or a repeater.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or have its functionality distributed in part or in full. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, flash, optical storage, to name a few), but may or may not be limited to hardware.

The verification engine 310 and its components can include any combination of software agents and/or hardware modules (e.g., including processors and/or memory units). The integration engine 330 and its components can include any combination of software agents and/or hardware modules (e.g., including processors and/or memory units). The security device (tag) generator 340 and its components can include any combination of software agents and/or hardware modules (e.g., including processors and/or memory units).

FIG. 3B depicts an example block diagram illustrating the components of the host server 300 to administer, generate, track, print, duplicate, fingerprint and/or authenticate security devices in a network, in accordance with embodiments of the present disclosure. In one embodiment, host server 300 includes a network interface 302, a processing unit 334, a memory unit 336, a storage unit 338, a location sensor 340, and/or a timing module 342. Additional or less units or modules may be included. The host server 300 can be any combination of hardware components and/or software agents to administer, generate, track, authenticate security devices in a network. The network interface 302 has been described in the example of FIG. 3A. One embodiment of the host server 300 includes a processing unit 334. The data received from the network interface 302, location sensor 340, and/or the timing module 342 can be input to a processing unit 334. The location sensor 340 can include GPS receivers, RF transceiver, an optical rangefinder, etc. The timing module 342 can include an internal clock, a connection to a time server (via NTP), an atomic clock, a GPS master clock, etc. The processing unit 334 can include one or more processors, CPUs, microcontrollers, FPGAs, ASICs, DSPs, or any combination of the above. Data that is input to the host server 300 can be processed by the processing unit 334 and output to a display and/or output via a wired or wireless connection to an external device, such as a mobile phone, a portable device, a host or server computer by way of a communications component. One embodiment of the host server 300 includes a memory unit 336 and a storage unit 338. The memory unit 335 and a storage unit 338 are, in some embodiments, coupled to the processing unit 334. The memory unit can include volatile and/or non-volatile memory. The processing unit 334 may perform one or more processes related to administering, fingerprinting, generating, tracking, and/or authenticating security devices. In some embodiments, any portion of or all of the functions described of the various example modules in the host server 300 of the example of FIG. 3A can be performed by the processing unit 334.

FIG. 4A depicts an example functional block diagram of a client device 402 such as a mobile device that can obtain data from security devices, in accordance with embodiments of the present disclosure.

The client device 402 includes a network interface 404, a timing module 406, an RF sensor 407, a location sensor 408, an image sensor 409, a verification engine 412 having an inspection engine 413, an authentication engine 414 having a fingerprint engine 415, a user stimulus sensor 416, a motion/gesture sensor 418, a capture engine/scanner 420, an audio/video output module 422, and/or other sensors 410. The client device 402 may be any electronic device such as the devices described in conjunction with the client devices 102A-N in the example of FIG. 1 including but not limited to portable devices, a computer, a server, location-aware devices, mobile phones, PDAs, laptops, palmtops, iPhones, cover headsets, heads-up displays, helmet mounted display, head-mounted display, scanned-beam display, smart lens, monocles, smart glasses/goggles, wearable computer such as mobile enabled watches or eyewear, and/or any other mobile interfaces and viewing devices, etc. In one embodiment, the client device 402 is coupled to a scan log and authentication challenge repository 428. The scan log and authentication challenge repository 428 may be internal to or coupled to the mobile device 402 but the contents stored therein can be further described with reference to the example of the scan log and authentication challenge repository 128 shown in the example of FIG. 1.

Additional or less modules can be included without deviating from the novel art of this disclosure. In addition, each module in the example of FIG. 4A can include any number and combination of sub-modules, and systems, implemented with any combination of hardware and/or software modules. The client device 402, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software. In the example of FIG. 4A, the network interface 404 can be a networking device that enables the client device 402 to mediate data in a network with an entity that is external to the host server, through any known and/or convenient communications protocol supported by the host and the external entity. The network interface 404 can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The client device 402 can perform one or more processes related to reading, generating provisioning, scanning, detecting, decoding, identifying, inspecting, authenticating security devices and/or retrieving relevant data from security devices. The client device 402 can further provide functionalities described herein via a consumer client application (app) (e.g., consumer app, client app, ‘Blocktag’appplication/app, etc.). The consumer / end user application includes a user interface that enables access to one or more processes related to administering, reading, generating, implementing/specifying, inspecting, fingerprinting, authenticating, verifying, provisioning, scanning, detecting, decoding, identifying, tracking, deploying, security devices, in some instance such functionality includes augmented reality features and can be partially or wholly deployed via an augmented reality environment. In some embodiments, any portion of or all of the functions described of the various example modules in the host server 300 of the example of FIG. 3A can be performed by the client device 402.

FIG. 4B depicts an example block diagram of the client device 402, which can be a mobile device that an obtain data from security devices, in accordance with embodiments of the present disclosure. In one embodiment, client device 402 (e.g., a user device) includes a network interface 432, a processing unit 434, a memory unit 436, a storage unit 438, a location sensor 440, an accelerometer/motion sensor 442, an audio output unit/speakers 446, a display unit 450, an image capture unit 452, a pointing device/sensor 454, an input device 456, and/or a touch screen sensor 458. Additional or less units or modules may be included. The client device 402 can be any combination of hardware components and/or software agents for performing one or more of the processes related to administering, reading, generating, implementing/specifying, inspecting, fingerprinting, authenticating, verifying, provisioning, scanning, detecting, decoding, identifying, tracking, deploying security devices and/or retrieving relevant data from security devices. The network interface 432 has been described in the example of FIG. 4A.

One embodiment of the client device 402 further includes a processing unit 434. The location sensor 440, accelerometer/motion sensor 442, and timer 444 have been described with reference to the example of FIG. 4A. The processing unit 434 can include one or more processors, CPUs, microcontrollers, FPGAs, ASICs, DSPs, or any combination of the above. Data that is input to the client device 402 for example, via the image capture unit 452, pointing device/sensor 454, input device 456 (e.g., keyboard), and/or the touch screen sensor 458 can be processed by the processing unit 434 and output to the display unit 450, audio output unit/speakers 446 and/or output via a wired or wireless connection to an external device, such as a host or server computer that generates and controls access to simulated objects by way of a communications component. One embodiment of the client device 402 further includes a memory unit 436 and a storage unit 438. The memory unit 436 and a storage unit 438 are, in some embodiments, coupled to the processing unit 434. The memory unit can include volatile and/or non-volatile memory. The processing unit 434 can perform one or more processes related to administering, reading, generating, implementing/specifying, inspecting, fingerprinting, authenticating, verifying, provisioning, scanning, detecting, decoding, identifying, tracking, deploying security devices and/or retrieving relevant data from security devices. In some embodiments, any portion of or all of the functions described of the various example modules in the client device 402 of the example of FIG. 4A can be performed by the processing unit 434. In particular, with reference to the mobile device illustrated in FIG. 4A, various sensors and/or modules can be performed via any of the combinations of modules in the control subsystem that are not illustrated, including, but not limited to, the processing unit 434 and/or the memory unit 436.

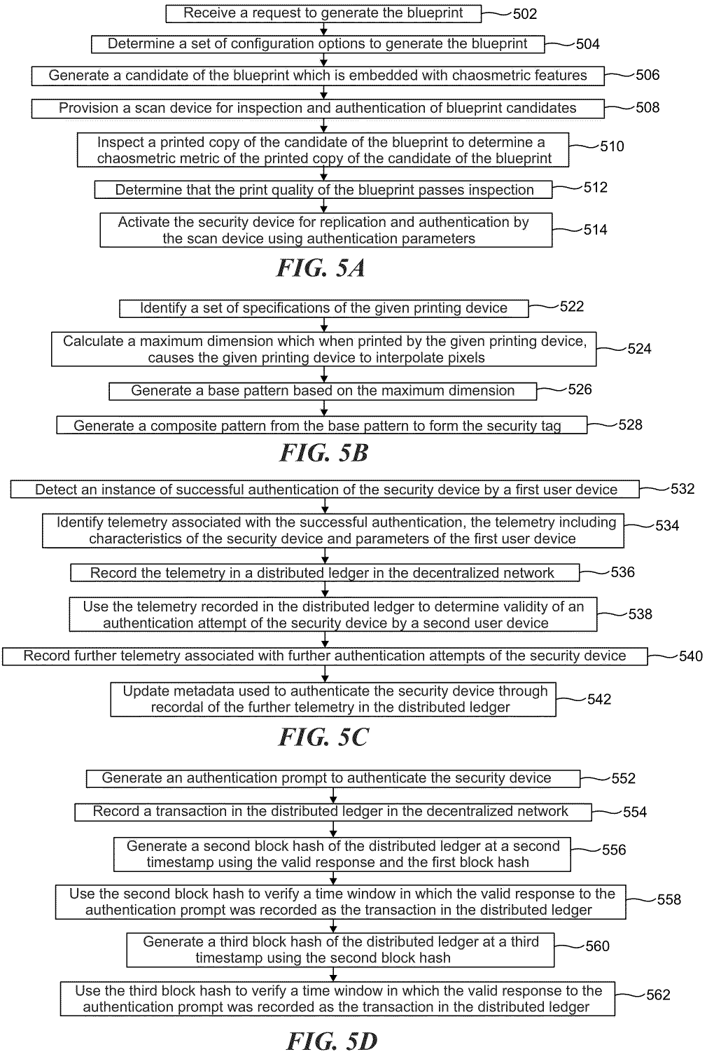

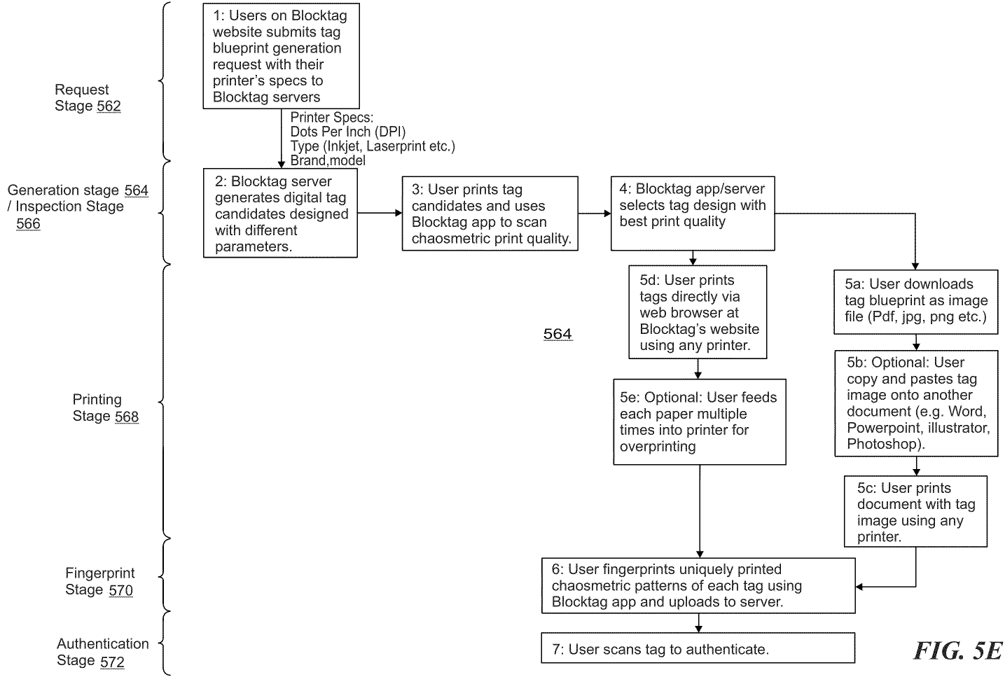

FIG. 5A depicts a flow chart illustrating an example process for generating blueprints and assessing blueprint candidates of a security device with chaosmetric patterns (e.g., chaosmetric features), in accordance with embodiments of the present disclosure.

In process 502, a request to generate the blueprint is received. In process 504, a set of configuration options to generate the blueprint is determined (e.g., by the chaosmetrics specification engine 342 and/or the component specification engine 344 of the security device generator 340 of the host server 300 shown in the example of FIG. 3A). In one embodiment, the set of configuration options are generated based on one or more specifications of a print device used to print the printed copy of the candidate. The one or more specifications of the print device can be received in the request to generate the blueprint. In process 506, a candidate of the blueprint which is embedded with chaosmetric features is generated (e.g., by the chaosmetrics specification engine 342 and/or the component specification engine 344 of the security device generator 340 of the host server 300 shown in the example of FIG. 3A).

In process 508, a scan device is provisioned for inspection and authentication of blueprint candidates. For example, when initiation of the scan device for inspection of the printed copy of the candidate of the blueprint is detected, the system can register an identifier of the scan device as being associated with a requester user of the request to generate the blue print as part of the provisioning procedure (e.g., by the inspection engine 312, fingerprint engine 314 and/or the authentication engine of the verification engine 310 of the host server 300 shown in the example of FIG. 3A). In process 510, a printed copy of the candidate of the blueprint is inspected (e.g., by the inspection engine 312 of the example of FIG. 3A and/or the inspection engine 413 of FIG. 4A) to determine a chaosmetric metric of the printed copy of the candidate of the blueprint. In one embodiment, a sharpness metric is generated from quantifying a sharpness character of a line printed in the printed copy of the blueprint (e.g., by the fingerprint engine 314 of the example of FIG. 3A and/or the fingerprint engine 415 of FIG. 4A). A structural metric can also be generated (e.g., by the fingerprint engine 314 of the example of FIG. 3A and/or the fingerprint engine 415 of FIG. 4A) from quantifying a structural character of structural features in the printed copy of the blueprint. The structural character generally arises from one or more of a shape from the ink in the printed copy and frequency of halftone or fractal patterns of the security device. A fingerprint of the candidate of the blueprint can be created from the sharpness metric and the structural metric (e.g., by the fingerprint engine 314 of the example of FIG. 3A and/or the fingerprint engine 415 of FIG. 4A). Additionally, the chaosmetric metric of the printed copy of the candidate of the blueprint can be determined from the sharpness metric and/or the structural metric. In process 512, it is determined that the print quality of the blueprint passes inspection (e.g., by the inspection engine 312 of the example of FIG. 3A and/or the inspection engine 413 of FIG. 4A). In process 514, the security device is activated for replication and authentication by the scan device using authentication parameters.

FIG. 5B depicts a flow chart illustrating an example process for generating chaosmetric features for a blueprint of a security tag, in accordance with embodiments of the present disclosure.

In process 522, a set of specifications of the given printing device are identified (e.g., by the chaosmetrics specification engine 342 and/or the component specification engine 344 of the security device generator 340 of the host server 300 shown in the example of FIG. 3A). The set of specification of the given printing device can be received with a request for the blue print. In process 524, a maximum dimension which when printed by the given printing device, causes the given printing device to interpolate pixels, is calculated (e.g., by the chaosmetrics specification engine 342 of the security device generator 340 of the host server 300 shown in the example of FIG. 3A). The maximum dimension can be determined from a width of a line in the blueprint of the security tag and the set of specifications of the given printing device, For example, a print resolution, which can be specified in dots per inch (DPI) can be used to determine the maximum dimension. Printing resolution in DPI is the maximum number of dots that can be printed to fit a physical inch of printed space. Each printed dot can also be represented as a pixel from the source tag blueprint. A group of pixels join to form a line that represents the fundamental unit of a tag’s plaid.

In one embodiment, to trigger the given printing device to interpolate pixels, a physical width of a line in digital pixels and in physical measurements (cm, in, etc.) can be determined such that the line width measurement in pixels divided by line width in inches > Printer resolution in DPI:
(line width in pixels)/(line width in inches) > (Printer resolution in DPT)

Note that the process of line width determination (e.g., by the chaosmetrics specification engine 342 of the security device generator 340 of the host server 300 shown in the example of FIG. 3A) assumes is that one printed dot from a printer is equal to one pixel from a monitor screen. In the situation where a printer’s resolution in dots-per-inch resolution is different from a screen’s resolution in Pixels Per Inch, the discrepancy can be addressed through print quality inspection (e.g., by the inspection engine 312 of the example of FIG. 3A and/or the inspection engine 413 of FIG. 4A). In general, the maximum distance (or near maximum distance) is specific to the given printing device, or printing devices having the same or similar printing resolution and other parameters. In addition to printing resolution, the set of specifications of the printer also identifies a type of printer. Laser printers interpolate pixels less because melting toner powder on paper inherently prints sharper lines compared to an inkjet depositing liquid ink on paper. Therefore if a laserjet and inkjet have the same printing resolution (DPI) parameter, the blueprint generation process (e.g., performed by the chaosmetrics specification engine 342 and/or the component specification engine 344 of the security device generator 340 of the host server 300 shown in the example of FIG. 3A) can implement or adjust a line width as measured in pixels to be narrower for a laserjet printer compared to an inkjet printer so as to achieve a same level of pixel interpolation (resulting in the same degree of printed chaosmetrics).

In one embodiment, the set of specifications of the printer includes printer settings of the given printer. If the paper fed into printer is normal quality but the printer settings is deliberately set as photo quality, the blueprint generation process can implement or adjust a line width as measured in pixels (e.g., by the chaosmetrics specification engine 342 and/or the component specification engine 344 of the security device generator 340 of the host server 300 shown in the example of FIG. 3A) to be narrower to account for greater ink bleeding. This technique leverages the fact that photo quality paper reduces ink bleeding to implement a specification that results in higher chaosmetrics artifacts when actually printed on normal paper (since ink bleeds more on normal paper than photo quality paper).

In process 526, a base pattern is generated (e.g., by the chaosmetrics specification engine 342 and/or the component specification engine 344 of the security device generator 340 of the host server 300 shown in the example of FIG. 3A) based on the maximum dimension, such that the dimensions of the features in the base pattern are not greater than the maximum dimension. In process 528, a composite pattern is generated from the base pattern (e.g., by the chaosmetrics specification engine 342 and/or the component specification engine 344 of the security device generator 340 of the host server 300 shown in the example of FIG. 3A) to form the security tag. The base pattern forms chaosmetric features in the security tag upon being printed by the given printing device. In one embodiment, the base pattern is generated with complex colors formed from pastel colored shades of primary printer ink colors. For instance, a color blending algorithm can be performed (e.g., by the chaosmetrics specification engine 342 and/or the component specification engine 344 of the security device generator 340 of the host server 300 shown in the example of FIG. 3A) on the complex colors of the base pattern to adjust an emergent color pattern of the composite pattern to increase a degree of chaos in the chaosmetric features of the security tag. Color blending can be performed (e.g., by the chaosmetrics specification engine 342 and/or the component specification engine 344 of the security device generator 340 of the host server 300 shown in the example of FIG. 3A) by adding the pixel value at each pixel location per C, M, Y, K screen. Subsequently, the CMYK screens are combined to output the final colored image.

Color blending example I:
1. For a specific pixel location, a halftone A is configured as C=255, M=0, Y=0, K=0.
2. Another halftone B at the same pixel location is configured as C=0, M=255, Y=0, K=0.
3. Halftone A + B at that pixel location gives C = 255+0=255, M = 0+255=255, Y = 0, K = 0.
4. Combining these CMYK screens together renders a pure blue pixel.

Color blending example II:
1. For a specific pixel location, a halftone A is designed as C=200, M=0, Y=0, K=0.
2. Another halftone B at the same pixel location is designed as C=100, M=200, Y=0, K=0.
3. Halftone A + B at that pixel location gives C = 200+100=300, M = 0+200=200, Y = 0, K = 0.
4. But pixel values are bounded between 0 to 255. So the blending process adjust pixel values to be C=255, M=200, Y=0, K=0.
4. Combining these CMYK screens together gives an off-blue pixel.

In a further embodiment, stray pixels can be rendered in the blue print (e.g., by the chaosmetrics specification engine 342 and/or the component specification engine 344 of the security device generator 340 of the host server 300 shown in the example of FIG. 3A), such that some of the stray pixels are visible as faded dots in a printed copy of the blueprint and other stray pixels are not visible in the printed copy.

FIG. 5C depicts a flow chart illustrating an example process to use a distributed ledger to perform validation of authentication of a security device in a decentralized network, in accordance with embodiments of the present disclosure.

In process 532, an instance of successful authentication of the security device by a first user device is detected (e.g., by the authentication engine 318 of the example of FIG. 3A and/or the authentication engine 414 of the example of FIG. 4A). In process 534, telemetry associated with the successful authentication is identified (e.g., by the telemetry identifier 332 of the integration engine 330 of the host server 300 shown in the example of FIG. 3A). The telemetry can include characteristics of the security device and parameters of the first user device. The parameter of the first user device can include for example, one or more of, camera parameters of an imaging unit of the first user device, a model of the first user device, and a distance between the security device and the first user device. In one embodiment, the characteristics of the security device can include the metadata used to authenticate the security device and the characteristics of the security device can include chaos metrics. For example, the security device includes chaosmetric artifacts formed from a fractal pattern of the security device and the characteristics of the security device include fractal dimensions and/or fractal lacunarity of the fractal pattern of the security device. In a further example, the security device includes chaosmetric artifacts formed from a halftone pattern of the security device and the characteristics of the security device can include a halftone frequency amplitude of the halftone pattern of the security device. In process 536, the telemetry is recorded (e.g., by the telemetry identifier 332 of the integration engine 330 of the host server 300 shown in the example of FIG. 3A) in a distributed ledger in the decentralized network. In process 538, the telemetry recorded in the distributed ledger is used to determine a validity (e.g., by the verification engine 310 of the host server 300 shown in the example of FIG. 3A) of an authentication attempt of the security device by a second user device. In process 540, further telemetry associated with further authentication attempts of the security device is recorded (e.g., by the integration engine 330 of the host server 300 shown in the example of FIG. 3A). In process 542, metadata used to authenticate the security device is updated through recordal of the further telemetry in the distributed ledger (e.g., by the telemetry identifier 332 and/or the time proof engine 334 of the integration engine 330 of the host server 300 shown in the example of FIG. 3A).

One embodiment includes, generating an authentication prompt (e.g., by the authentication engine 318 of the example of FIG. 3A and/or the authentication engine 414 of the example of FIG. 4A) to authenticate the security device and the authentication prompt can be associated with a first block hash of the distributed ledger at a first timestamp. The authentication prompt can include, for example, a challenge intended to be performed using the first user device. The valid response can be generated if the challenge is performed correctly on the security device to be authenticated, using the first user device. A transaction including a valid response to the authentication prompt and the first block hash can then be recorded in the distributed ledger in the decentralized network (e.g., by the telemetry identifier 332 and/or the time proof engine 334 of the integration engine 330 of the host server 300 shown in the example of FIG. 3A). A second block hash of the distributed ledger is then generated from hashing the valid response and the first block hash at a second timestamp (e.g., by the telemetry identifier 332 and/or the time proof engine 334 of the integration engine 330 of the host server 300 shown in the example of FIG. 3A). Using the second block hash, a time window in which the valid response to the authentication prompt was recorded as the transaction in the distributed ledge can be verified (e.g., by the time proof engine 334 of the integration engine 330 of the host server 300 shown in the example of FIG. 3A). The time window is generally defined by the first timestamp and the second timestamp.

FIG. 5D depicts a flow chart illustrating an example process to use a distributed ledger verify a time window in which authentication of a security device occurred, in accordance with embodiments of the present disclosure.

In process 552, an authentication prompt is generated (e.g., by the authentication engine 318 of the example of FIG. 3A and/or the authentication engine 414 of the example of FIG. 4A) to authenticate a security device which includes chaos metric artifacts. In process 554, a transaction is recorded (e.g., by the telemetry identifier 332 and/or the time proof engine 334 of the integration engine 330 of the host server 300 shown in the example of FIG. 3A) in the distributed ledger in the decentralized network. The transaction can include a valid response to the authentication prompt and the first block hash. The authentication prompt can include, for example, a challenge intended to be performed using the first user device and the valid response is generated if the challenge is performed correctly on the security device to be authenticated, using the first user device. In process 556, a second block hash of the distributed ledger is generated at a second timestamp using the valid response and the first block hash (e.g., by the time proof engine 334 of the integration engine 330 of the host server 300 shown in the example of FIG. 3A). In one embodiment, the second block hash is generated from hashing the valid response and the first block hash e.g., by the time proof engine 334 of the integration engine 330 of the host server 300 shown in the example of FIG. 3A). In process 558, the second block hash is used to verify a time window e.g., by the time proof engine 334 of the integration engine 330 of the host server 300 shown in the example of FIG. 3A) in which the valid response to the authentication prompt was recorded as the transaction in the distributed ledger. The time window can be defined by the first timestamp and the second timestamp. In process 560, a third block hash of the distributed ledger is generated e.g., by the time proof engine 334 of the integration engine 330 of the host server 300 shown in the example of FIG. 3A) at a third timestamp using the second block hash. In process 562, the third block hash is used to verify e.g., by the time proof engine 334 of the integration engine 330 of the host server 300 shown in the example of FIG. 3A) a time window in which the valid response to the authentication prompt was recorded as the transaction in the distributed ledger.

FIG. 5E depicts a flow chart illustrating example an example process for requesting, generating, inspecting, printing fingerprinting, and authentication of a security device, in accordance with embodiments of the present disclosure. The operations described to request, generate, inspect, print, fingerprint and authenticate tags can be implemented by the system (e.g., the host server 100 of FIG. 1 and/or the host server 300 of FIGS. 3A-3B and/or the device 102A-N as shown in the example of FIG. 1 and/or the device 402 of the example of FIG. 4A) with similar processes with fewer or additional steps, as well as in different order of operations using the principles described herein. The printer configurations do not require direct access to the printer’s internal program (firmware) to generate these chaotic pattern characteristics. Various pattern generation techniques are injected (e.g., by the chaosmetrics specification engine 342 and/or the component specification engine 344 of the security device generator 340 of the host server 300 shown in the example of FIG. 3A) during one or more of the stages below: 1. Blueprint Request Stage 2. Print Quality Inspection Stage 3. Tag Printing Stage.

These techniques can be used separately or stacked together in different permutations to ensure chaosmetric property is unique enough to distinguish an original tag from a cloned tag reprinted on the same printer from the same blueprint.

Blueprint Request Stage 562 - In the request stage, a user submit a request for tag blueprints - providing their printer’s (e.g., the print device 114 as shown in the example of FIG. 1) specifications including but not limited to brand, model, printer type (Inkjet, Laserjet etc), Dots Per Inch (DPI) resolution. The request can be submitted from Blocktag’s website (e.g., hosted by a host, the host server 100 of FIG. 1 and/or the host server 300 of FIGS. 3A-3B) as a form where users input their printer’s specs or from Blocktag’s printer driver which programmatically checks and identifies the user’s printer specs. The printer driver can be installed on the user’s computer client, or accessed as a web application.

Blueprint Generation Stage 564 - A Blocktag blueprint can be implemented (e.g., by the chaosmetrics specification engine 342 and/or the component specification engine 344 of the security device generator 340 of the host server 300 shown in the example of FIG. 3A) using on a bottom-up approach or top-down approach comprising basic building blocks using one or more of the following characteristics:
1. Individual shape (Dot, straight line segment, curved line segment, letter, character etc.)
2. Orientation angle
3. Dimensions (Radius, width etc)
4. Position (x,y coordinates) on the tag surface.
5. Color (Including but not limited to Cyan, Magenta, Yellow, Black)

### Base Pattern or Composite Pattern Integration With Content Element

### Monochrome Halftone Integration

FIG. 6A depicts an example of integration of monochrome base or composite patterns with content element 602, in accordance with embodiments of the present disclosure.

In one embodiment, a monochrome base pattern or composite halftone pattern can be integrated (e.g., by the chaosmetrics specification engine 342 and/or the component specification engine 344 of the security device generator 340 of the host server 300 shown in the example of FIG. 3A) as part of a larger content element (e.g. a black-and-white QR or barcode) if the content element is not fully used up to encode metadata and that it can still perform error correction. The halftone pattern’s properties such as x-y position on the Blocktag can be encoded in the content element. In general, any image can be converted into a halftone (e.g., by the chaosmetrics specification engine 342 and/or the component specification engine 344 of the security device generator 340 of the host server 300 shown in the example of FIG. 3A) to enhance chaosmetrics of the pattern through amplification. Image 602 depicts an original QR. Image 604 depicts a hybrid with base pattern covering full QR data area. Image 606 depicts another hybrid with base pattern covering part of QR data area.

### Monochrome Fractal Integration

FIG. 6A-1 depicts examples of integration of monochrome fractal patterns with content element, in accordance with embodiments of the present disclosure.

If the authenticity element is fully used up to encode metadata and cannot be used for error correction, a monochrome base/composite fractal pattern can be joined along the edges of the authenticity element. For example, a fractal with a starting axiom string F+F+F+F, where F means to move forward one step, + means to turn left 90 degrees. Rewrite rule 1: F=FF-F--F-F where -means to turn right 90 degrees. Rewrite rule 2: B=-FA-B. Image 601 depicts an example of a content element having 2D code (e.g., a QR code). Image 603 depicts an example of a fractal pattern (e.g., an icy fractal pattern). Image 605 depicts an example of the fractal pattern 603 superimposed on the 2D code 601 to generate a chaosmetric QR.

If the content element’s basic unit dimension (e.g. QR small square’s width) is larger than the fractal line segment’s width, a space filling fractal can be superimposed on top of the content element without affecting the scannability of the content element. This is similar to halftoning an image but with a more complicated fractal pattern. In general, any image can be converted into a fractal pattern to amplify the image’s chaosmetrics. Image 607 depicts an example of a content element having 2D code (e.g., a QR code). Image 609 depicts an example of a fractal pattern (e.g., a golden square fractal pattern). Image 611 depicts an example of the fractal pattern 611 superimposed on the 2D code 607 to generate a chaosmetric QR. In a further example. Image 613 depicts a content element having a 2D code (e.g., a QR code). Image 615 depicts an example of a fractal pattern which is a square grid space filling fractal with variable thickness ratio. Image 617 depicts an example of the fractal pattern 615 superimposed on the 2D code 613 to generate a chaosmetric QR.

FIG. 6A-2 depicts an example of a QR code converted into a fractal pattern (Hilbert curve fractal pattern), in accordance with embodiments of the present disclosure. FIG. 6A-3 depicts an example of a bar code converted into a fractal pattern (Hilbert curve fractal patter), in accordance with embodiments of the present disclosure. FIG. 6A-4 depicts an example of an artificial fingerprint 625 from a superposition of an elongated circular grating 621 and Hilbert curve fractal 623 in accordance with embodiments of the present disclosure. During printing, chaosmetric artifacts are created in the printed artificial fingerprint 625. FIG. 6A-5 depicts an example of the artificial fingerprint 625 superposed within a content element 627 such as the black/white squares of a QR to generate image 629. in accordance with embodiments of the present disclosure. Fractal patterns can ensure that chaosmetrics artifacts are printed in security devices by printers of different dots per inch (dpi) resolution using different types of paper and ink. Random printed micro deformations are generated at specific physical dimensions depending on the printer, paper, ink combination.

Integration of fractal patterns (e.g., by the chaosmetrics specification engine 342 and/or the component specification engine 344 of the security device generator 340 of the host server 300 shown in the example of FIG. 3A) maximize chaosmetrics in the disclosed security devices across any combination printer, paper and ink parameters without fine tuning as fractals exhibit the same pattern at different scale levels. One of the scale levels will maximize micro deformations. FIG. 6A-6 depicts an example of security device 635 integrated with a fractal grid 633. in accordance with embodiments of the present disclosure. A fractal grid design 633 can also be integrated with a Blocktag 631 (e.g., by the chaosmetrics specification engine 342 and/or the component specification engine 344 of the security device generator 340 of the host server 300 shown in the example of FIG. 3A) as reference lines so that if the grid 633 is deformed after printing the Blocktag on a non-flat surface, a scan device can flatten the deformed grid using image processing techniques.

### Base/Composite Pattern Integration with Marker Element

In one embodiment, a base pattern or composite pattern can be integrated with a marker element. A marker is an object placed in the field of view of an imaging system/device which appears in the image produced, for use as a point of reference or a measure. The marker can be either placed into or on the imaging subject, or the mark or set of marks can be built into in the reticle of an optical instrument. The QR’s fiducial markers is one of other examples of marker types such as:
Just Another Barcode (JAB) colored finder pattern marker
ArUco.
AprilTag https://april.eecs.umich.edu/software/apriltag
Cantag. Compact, rotational invariant marker https://www.cl.cam.ac.uk/∼acr31/cantag
Chilitag.
ARToolkit.
reacTIvision. Uses amoeba shaped markers.
Or other natural features that can be leveraged as markers and tracked using Natural Feature Tracking (NFT) techniques.

In one embodiment, the perpendicular distance between a user’s scan device (e.g. a user device, a client/mobile device 102AN as shown in the example of FIG. 1 and/or a client/mobile device 402 of the example of FIG. 4A). and an item’s Blocktag can be calculated(e.g., by the verification engine 310 of the host server 300 shown in the example of FIG. 3A and/or the verification engine 412 of FIG. 4A) if the scan device’s intrinsic camera parameters and physical distance between any two markers is known beforehand. For example, QR’s fiduciary markers are the corners of a square QR. Therefore, the physical distance between a QR’s markers can be the QR width in inches.

A user’s scan device can also use the markers to measure the Blocktag’s displacement in six degrees of freedom (pitch, roll, yaw, left, right, up, down, forward, backward) from one video frame to another. The Blocktag’s displacement can be calculated (e.g., by the verification engine 310 of the host server 300 shown in the example of FIG. 3A and/or the verification engine 412 of FIG. 4A) from the difference between the scan device’s gyroscope orientation and the Blocktag’s marker orientation relative to a scan device (pitch, roll, yaw, horizontal x position, vertical y position, z depth). Different scan devices have camera lenses with different radial and tangential image distortion. This causes the same image taken by two different camera lenses to look different. In one embodiment, image processing un-distorts the image to reduce noise so that Blocktag image fingerprinting and authentication can be self-serviced across different 3rd party scan devices. A scan device’s intrinsic camera and lens distortion parameters can be inferred from a cluster of markers or from a halftone pattern that looks like a checkerboard (e.g., by the verification engine 310 of the host server 300 shown in the example of FIG. 3A and/or the verification engine 412 of FIG. 4A). For example, this marker cluster or checkerboard pattern can also be integrated as part of a content or marker element to enable a scanning party to calibrate the scanner device’s intrinsic camera and lens distortion parameters conveniently. FIG. 6B depicts an example of a checkerboard marker element used for camera and lens distortion calibration, in accordance with embodiments of the present disclosure. Image 612 depicts a Hybrid QR with base chessboard pattern 615 covering part QR data area. Image 614 illustrates scanner detecting four corners of the QR 617 and other points in chessboard pattern 615 for calibration.

In a further embodiment, the item-device perpendicular distance, Blocktag marker displacement and scan device intrinsic camera and lens distortion parameters are used as input by image processing software to perform the following processes (e.g., by the verification engine 310 of the host server 300 shown in the example of FIG. 3A and/or the verification engine 412 of FIG. 4A):
High precision fingerprinting during fingerprint stage
Proof of presence during authentication stage
Proof of possession during authentication stage
Augmented reality challenge-response during authentication stage.

### Blocktag Blueprint Form Factors

### Polychrome Form Factors

FIG. 6C depicts examples of patterns having polychrome form factor, in accordance with embodiments of the present disclosure. In one embodiment, a polychrome pattern and identifier can be represented as a color barcode (e/g., as a JAB) in various forms. A colored barcode symbol generally include colorful square modules arranged in either a square or rectangle grid. In addition, multiple square/rectangle symbols can be joined side-by-side (docked) together along the horizontal or vertical direction to encode more data infinitely within the view of the scanning device. Therefore, Blocktag’s color barcode form factor can be a narrow strip, as shown in the example of image 621. Such a form factor may be suitable for printing on a vape pen. Blocktag’s color barcode form factor can also include any required irregular shape formed by docking multiple color barcode symbols, as shown in the example if image 623. Forming irregular shapes facilitates work around an item’s surface design constraints (e.g. Product packaging design). Irregular shapes can also visually bound an item’s specific design element that is of interest for anti-counterfeit protections. When printed, polychrome pattern and identifier of the security device produces chemometrics. The chaosmetric color barcode form factor enables the disclosed system (e.g., the host server 100 of FIG. 1 and/or the host server 300 of FIGS. 3A-3B and/or the client/mobile device 102A-N as shown in the example of FIG. 1 and/or the client/mobile device 402 of the example of FIG. 4A) to uniquely identify, track and authenticate a larger number of anti-counterfeit items and item relationships with people to prove possession, presence and ownership.

### Monochrome Form Factors

In one embodiment, the form factor of a security device which is monochromatic can be a square or rectangular shape. FIG. 6D depicts an example of a monochrome security device having a square form factor, in accordance with embodiments of the present disclosure. The depicted monochrome security device example includes Aruco markers 617 at the four corners and a fractal pattern 625 (that is not QR). In a further embodiment, the form factor of a security device which is monochromatic can also be of a circular shape having multiple concentric rings. For example, the circular form factor can include a central circle having a content element and a surrounding ring having an authenticity element and identity element, or vice versa. The content element can include, for example, a circular QR, Cantag marker, or ShotCode circular barcode. The authenticity element can include a fractal pattern or a halftone pattern. It can also be designated as any image embedded with a halftone or fractal pattern (e.g., by the chaosmetrics specification engine 342 and/or the component specification engine 344 of the security device generator 340 of the host server 300 shown in the example of FIG. 3A).In one embodiment, the identity element of a security device can be designed as halftone (e.g. a line grating) defined along a circular line segment in polar coordinates. The periodicity of the halftone pattern can be used to encode data. The identity element can also be designated as a circular barcode traversing the circular barcode in polar coordinates is the same as traversing a traditional barcode in Cartesian coordinates (e.g., by the chaosmetrics specification engine 342 and/or the component specification engine 344 of the security device generator 340 of the host server 300 shown in the example of FIG. 3A). Circular Blocktags can be used as stamps (e.g. Notary stamps, inspection stamps, mailing stamps and other applications of stamps) with enhanced security that can be authenticated with a smartphone.

FIG. 6E depicts an example of a monochrome security device of a circular form factor having a center ShotCode circular barcode and surrounding circular fractal, in accordance with embodiments of the present disclosure. FIG. 6F depicts an example of a monochrome security device having Levy curve fractal with center CanTag marker, in accordance with embodiments of the present disclosure. FIG. 6G depicts an example of a monochrome security device with a Penrose tiling fractal pattern with a Shotcode barcode in the center, in accordance with embodiments of the present disclosure. FIG. 6H depicts an example of a monochrome security device having a center ShotCode marker with a circular radial halftone that functions as a continuous-valued resolution test target, in accordance with embodiments of the present disclosure. As radius increases from center of origin, the resolution decreases. FIG. 6I depicts an example of a monochrome security device with a center marker within an uneven halftone that function as a 1D binary encoded circular barcode, in accordance with embodiments of the present disclosure. FIG. 6J depicts an example of a monochrome security device with a center marker and with a superimposed radial and tangential circular halftone pattern that functions as a 2D binary encoded circular barcode, in accordance with embodiments of the present disclosure. FIG. 6K depicts an example of a monochrome security device with a center Shotcode marker having spiral halftone patterns, in accordance with embodiments of the present disclosure.

In a further embodiment, the form factor of a security device which is monochromatic can also be of a strip (e.g., linear strip form). In the strip form factor, the security device can include for example, a content element such as a barcode, an authenticity element such as fractal subset (Truncated Koch curve) printed along one or more edges of the barcode and an authenticity element as halftones embedded in one or more line gratings of the barcode. FIG. 6L depicts an example of a monochrome security device with a content element as a barcode, an authenticity element as truncated Koch curve (on left hand side), and an identity element with a halftone pattern of line segments (on right hand side), in accordance with embodiments of the present disclosure. FIG. 6M depicts an example of a monochrome security device with an authenticity element as a fractal chain, identity element with a halftone pattern of line segments in the fractal chain, and a content/marker element as a ShotCode circular barcode, in accordance with embodiments of the present disclosure.

### Chaosmetric Generation

### Chaosmetric Generation by Printer Pixel Interpolation

For the disclosed system to generate tag blueprints embedded with chaosmetric patterns, the host server can reference a user’s printer specifications to generate base patterns (e.g., by the chaosmetrics specification engine 342 and/or the component specification engine 344 of the security device generator 340 of the host server 300 shown in the example of FIG. 3A) whose dimensions are small enough to cause the printer firmware to interpolate pixels when printing. This will result in the printed chaosmetric patterns to look different from the source digital tag blueprint patterns.

FIG. 6N depicts an example of a digital tag blueprint with zoomed in patterns, in accordance with embodiments of the present disclosure. FIG. 6O depicts zoomed in line grating patterns from the digital tag blueprint depicted in the example of FIG. 6N, in accordance with embodiments of the present disclosure. FIG. 6P depicts an image of a printed tag of the digital tag blueprint of the example of FIG. 6N, in accordance with embodiments of the present disclosure. FIG. 6Q depicts an image of zoomed in chaosmetric patterns from the printed tag shown in FIG. 6P, in accordance with embodiments of the present disclosure.

### Chaosmetric Generation by Color Shade Variations

The system (e.g., the host server 100 of FIG. 1 and/or the host server 300 of FIGS. 3A-3B and/or the client/mobile device 102A-N as shown in the example of FIG. 1 and/or the client/mobile device 402 of the example of FIG. 4A) can employ a chaosmetrics generation technique that taps on laser printing specificities or constraints. For example, images with subtle tonal nuances are more difficult to print well on a laser printer as it is difficult for a four-color CMYK printer to reproduce subtle transitions in complex colors such as pastels. Laser printers tend to boost contrast and are not good at mixing toner colors to produce re-produce complex colors.

To create chemometric features/artifacts through laserjet printing (e.g., by the chaosmetrics specification engine 342 and/or the component specification engine 344 of the security device generator 340 of the host server 300 shown in the example of FIG. 3A), in one embodiment, the digital base patterns can be implemented with varying shades of complex colors. Such complex colors an include, for example, Pastel colored shades of cyan, magenta, yellow. The base pattern’s complex colors can be digitally overlapped and blended together by performing a color blending process (e.g., by the chaosmetrics specification engine 342 and/or the component specification engine 344 of the security device generator 340 of the host server 300 shown in the example of FIG. 3A) to determine the emergent composite pattern’s color.

Blueprints generated (e.g., by the chaosmetrics specification engine 342 and/or the component specification engine 344 of the security device generator 340 of the host server 300 shown in the example of FIG. 3A) with subtle transitions of complex colors solve a challenge in tag security through enhancing chaosmetrics. Bad actors who have access to a tag’s blueprint can guess what are the color combinations and re-print chaosmetrics that are similar to the original printed tag if the blueprint’s Cyan, Magenta and Yellow (CMY) color composition is simple - for example, a blueprint designed with pure cyan (C=255, M=0, Y=0), Magenta (C=0,M=255,Y=0) and Yellow (C=0,M=0,Y=255). On the other hand, if a blueprint’s color composition is complex, a printer needs to work harder to mix cyan, magenta and yellow toner in different ratios to reproduce the digital blueprint’s color composition. This enhances the randomness of the printed chaosmetrics features and makes it more difficult for a bad actor to re-engineer the same chaosmetrics on a reprinted tag.

FIG. 6R depicts example line gratings without transition of simple colors in accordance with embodiments of the present disclosure. The simple colors are: Cyan (C=255,M=0,Y=0,K=0), Magenta (C=0,M=255,Y=0,K=0) and Yellow (C=0,M=0,Y=255,K=0). FIG. 6S depicts example line gratings with sinusoidal transition of simple colors, in accordance with embodiments of the present disclosure. The simple colors are: Cyan (C=255,M=0,Y=0,K=0), Magenta (C=0,M=255,Y=0,K=0) and Yellow (C=0,M=0,Y=255,K=0). FIG. 6T depicts example line gratings with sinusoidal transition of complex colors (pastels), in accordance with embodiments of the present disclosure. The complex colors are for example, Cyan C=39,M=28,Y=0,K=25), Magenta (C=0,M=48,Y=14,K=0) and Yellow (C=7,M=13,Y=57,K=0).

### Tag Blueprint Stray Pixel Rendering

In a further embodiment, stray pixels are rendered (e.g., by the chaosmetrics specification engine 342 and/or the component specification engine 344 of the security device generator 340 of the host server 300 shown in the example of FIG. 3A) on the blueprint of the security device around the authenticity element. When the blueprint is printed, some stray pixels will appear visible as faded dots, while other stray pixels are not visible. Stray pixels rendering can be implemented for tag blueprint security. Stray pixels implementation therefore solves the problem of bad actors taking a screenshot of an original tag blueprint and printing clone tags. Printing a screenshot of an original tag will render stray pixels visible as faded dots. Printing the original tag blueprint will only render a select few stray pixels visible. FIG. 6U depicts an example of an authenticity element having stray faint colored pixels 691 around its white regions, in accordance with embodiments of the present disclosure.

### Print Quality Inspection Stage 566

The disclosed system (e.g., the host server 100 of FIG. 1 and/or the host server 300 of FIGS. 3A-3B and/or the client/mobile device 102A-N as shown in the example of FIG. 1 and/or the client/mobile device 402 of the example of FIG. 4A), in one embodiment, pre-prints sample tag blueprints. The printed sample tag blueprints can be inspected (e.g., by the inspection engine 312 of the example of FIG. 3A and/or the inspection engine 413 of FIG. 4A) for tag print quality to identify print variations that affect tag security. For example, the print result of a tag blueprint varies based on different:
Paper types (e.g. Photo paper, plain paper)
Printer types (Inkjet, laserjet etc)
Ink types (water based ink, powder based toner etc.)
Printer brands
Dried ink extent in print nozzle

In one embodiment, when a requesting party uses a scan device (e.g. a user device, a client/mobile device 102A-N as shown in the example of FIG. 1 and/or a client/mobile device 402 of the example of FIG. 4A). to inspect print quality, the scan device’s identifier and other parameters can be automatically registered under the requesting party’s identifier. The other parameters that are recorded can include phone brand, model, intrinsic camera parameters, camera resolution, optical zoom levels etc. With the registration, the scan device represents the requesting party or any other user during proof-of-presence and proof-of-possession authentication where the fundamental unit of authentication is an item-device pair. Multiple devices can be registered under a host user. A device can also be registered under multiple guest users with the content of the host user. In addition, the system performs print quality inspection techniques (e.g., by the inspection engine 312 of the example of FIG. 3A and/or the inspection engine 413 of FIG. 4A) to determine if printer firmware has sufficiently interpolated pixels to print chaosmetric features/artifacts. Examples of the print quality inspection techniques performed, (e.g., by the inspection engine 312 of the example of FIG. 3A and/or the inspection engine 413 of FIG. 4A) can include, one or more of:
Template inspection: The system can check a Printed plaid’s template to confirm its similarity similar to a source blueprint. To quantify this, source plaid can be reconstructed and used as template to compute percentage match with an image of the printed tag, and further normalized from 0.0 (No match) to 1.0 (Perfect match). There is a lower bound (e.g. > 0.2) to guard against over-interpolation and upper bound (e.g. <0.5) to guard against under-interpolation.
Color inspection: The system can determine whether the color distribution between blueprint and printed tag images are sufficiently similar. To quantify this, the system can compute RGB histogram correlation between the blueprint and the printed tag image, and further normalized from 0.0 (No correlation) to 1.0 (Perfect correlation).
Spatial frequency inspection: The system can determine the Fourier amplitude at each pixel location in spatial frequency domain.

In a further embodiment, the system can differentiate between camera blur (due to shaky hands or unfocused camera lens) and printed chaosmetrics from interpolated pixels. Unlike the chaosmetric plaid inside the QR that is designed to interpolate pixels, the tag has a color palette plaid beside the QR that can be implemented without interpolation. Camera blur can then be identified by the system detected from the % template match threshold value between color palette plaid’s blueprint and printed image. For example, threshold value can be absolute - the color palette plaid can be implemented using the same features across tags, so the system differentiates between absolute lower bound thresholds that are reasonable for tags printed across different printers and fingerprinted across different phones. The threshold is generally not too low (e.g. >0.5) to ensure the camera is not blurred.

The threshold value can be relative - the color palette plaid can be implemented to avoid interpolation by having wider line widths but with the same line rotation and color as its interpolated chaosmetric plaid counterparts on the same tag. The color palette plaid template match threshold (ColorPalettePlaidBlueprint versus ColorPalettePlaidPrint) should be relatively lower compared to the chaosmetric plaid template match threshold (ChaosmetricPlaidBlueprint versus ChaosmetricPlaidPrint). Camera blur can be reduced by integrating the phone camera’s (e.g. a scan device, a client/mobile device 102A-N as shown in the example of FIG. 1 and/or a client/mobile device 402 of the example of FIG. 4A) native software features with the system (Blocktag processes). For example, in one snapshot, a series of photos (i.e. A photo bracket) of the same tag are taken by the system (e.g., by the inspection engine 312 of the example of FIG. 3A and/or the inspection engine 413 of FIG. 4A) at different exposure time settings which determines how light or dark is the fingerprint photo. The photo(s) from the photo bracket that has highest % template match and sharpest resolution can then be selected.

### Print quality inspection by Fractal Analysis

In a further embodiment, the system performs fractal analysis (e.g., by the verification engine 310 of the host server 300 shown in the example of FIG. 3A and/or the verification engine 412 of FIG. 4A, by the inspection engine 312 of the example of FIG. 3A and/or the inspection engine 413 of FIG. 4A) to inspect print quality of a printed sample tag blue print. Fractal-based print quality inspection includes one or more of the following processes:

1. The system identifies the resolution of a given printer to determine whether the printer has sufficient dots per inch (dpi) resolution to print a monochrome fractal structure clearly up to the target fractal scale level in the digital blueprint design. Specifically, the printed fractal must have a fractal dimension greater than the digital fractal. Otherwise, the printed fractal has no detectable specific chaosmetrics artifacts.

2. The system identifies the resolution of a camera of the scan device (e.g. a user device, a client/mobile device 102A-N as shown in the example of FIG. 1 and/or a client/mobile device 402 of the example of FIG. 4A). Since the printed fractal’s dimension is measured by the requesting party’s scan device, the scan device must have a camera resolution high enough to inspect the printed fractal clearly. This ensures the same scan device can fingerprint (e.g., by the fingerprint engine 314 of the example of FIG. 3A and/or the fingerprint engine 415 of FIG. 4A) the fractal later at a sufficiently high resolution. Eventually, other scan devices with various camera resolutions can authenticate (e.g., by the authentication engine 318 of the example of FIG. 3A and/or the authentication engine 414 of the example of FIG. 4A) the fractal’s specific or general chaosmetric artifacts.

3. The system determines the furthest perpendicular distance between the printed fractal plane and the scan device that can be used without losing resolution of the smallest fractal scale level. Specifically, as the scan device moves farther away from the printed fractal, the measured fractal dimension drops. The farthest distance is a point where the printed fractal’s dimension is lower than the digital fractal’s dimension.

In one embodiment, fractal-based print quality inspection (e.g., by the verification engine 310 of the host server 300 shown in the example of FIG. 3A and/or the verification engine 412 of FIG. 4A) is implemented as follows: If a printed fractal within a rectangular area is imaged by a scan device, the width and height in pixels of the fractal line segment at various scale levels can be determined. This line segment’s width or height property is used to calculate the fractal’s dimension using the box counting technique. The technique’s box width is set based on the line segment’s height or width. The line segment’s heigh or width in pixels can reduce proportionally if the scan device moves farther away from the printed fractal. But if the scan device is too far away, the measured fractal dimension of line segments at smaller scale levels can be lost to pixel interpolation. This lossy pixel interpolation is represented as a drop in the fractal dimension value.

### Polychrome Chaosmetric Print Quality Inspection by Halftone Analysis

In a further embodiment, the system performs halftone analysis to inspect print quality by the verification engine 310 of the host server 300 shown in the example of FIG. 3A and/or the verification engine 412 of FIG. 4A, (e.g., by the verification engine 310 of the host server 300 shown in the example of FIG. 3A and/or the verification engine 412 of FIG. 4A, by the inspection engine 312 of the example of FIG. 3A and/or the inspection engine 413 of FIG. 4A) of a printed sample tag blue print. halftone-based print quality inspection includes one or more of the following processes:

1. Identifies a halftone line width in a digital blue print. A digital blueprint’s halftone line width must be narrow enough so that printing:
Produces random distortions at the edges of different base halftone colors (e.g. Cyan + Yellow)
Aligns the base halftones correctly to produce an emergent composite halftone with a periodicity and rotation.
Blurs the emergent composite halftone (e.g. Green)

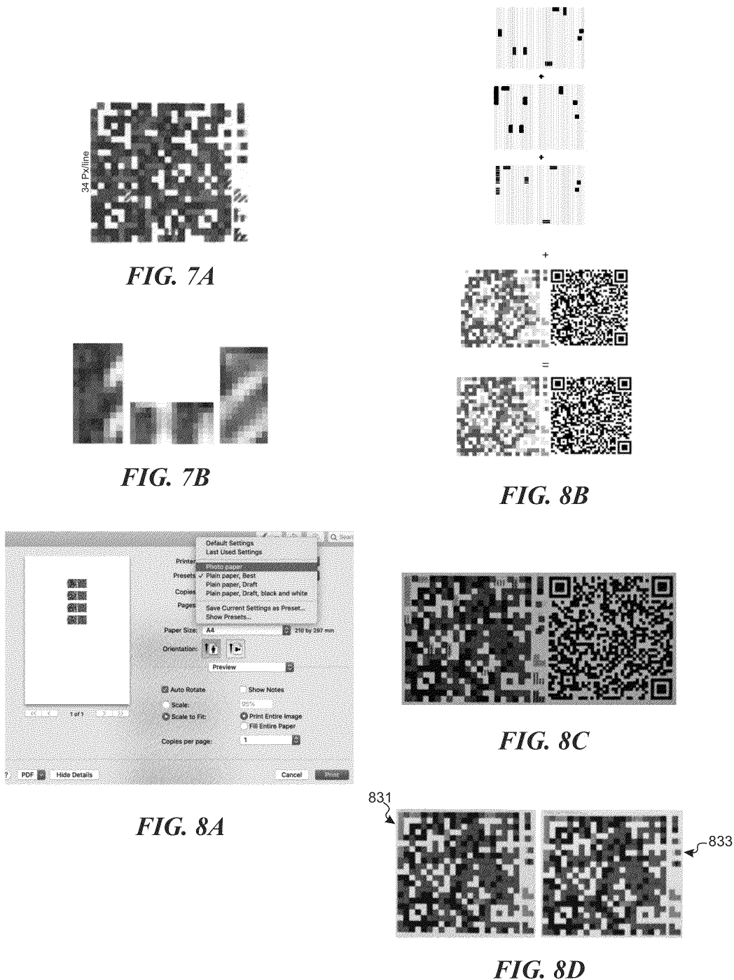

FIG. 7A depicts an example of a printed tag with lines that are too fat which makes it easier to reproduce in accordance with embodiments of the present disclosure. FIG. 7B depicts zoomed in chaosmetric patterns with fat lines, in accordance with embodiments of the present disclosure.

2. The system identifies the resolution of a camera of the scan device (e.g. a user device, a client/mobile device 102A-N as shown in the example of FIG. 1 and/or a client/mobile device 402 of the example of FIG. 4A). The requesting party’s scan device must have a camera resolution high enough to capture the blurred halftones. The degree of blurring is quantified by the halftone’s spatial frequency amplitude.

3. Perceived halftone blurring on a scan device can be caused by physical random distortions at the edges of the printed halftone colors or by the scan device’s pixel interpolation. The system determines the furthest perpendicular distance between the printed halftone plane and the scan device without losing resolution to pixel interpolation noise. A scan device pointed at an item printed with a halftone at a given perpendicular distance between the device and item produces general chaosmetric properties unique to the item-device combination:
Halftone visibility threshold where halftones with periods above this threshold can be captured as an image by a scan device. Halftones with periods below this threshold cannot be imaged by the scan device.
Halftone periodicity range where a scan device perceives moire patterns on top of a halftone that occupies a portion of the device’s display and the halftone is sufficiently small or far away from the device. Moire patterns emerge when the halftone pattern combines with a camera’s sensor grid array.

Halftones and fractals solve the following challenges in the Blocktag system:
Enables long range authentication scenarios where a printed Blocktag is too far from a scan device to capture millimeter-scale chaosmetric print artifacts. For example, phone cameras pointed at Blocktags (e.g., a tag, a security device, a security device 108A-N as shown in the example of FIG. 1, security devices as shown in the example of FIGS. 6D-6M) on street signs/ billboards, CCTV cameras pointed at Blocktags on car plates, telescopic cameras pointed at Blocktags on freight containers, or satellite cameras pointing at planetary surfaces to visually mark land claims or rocket landing/launch sites.
Enables short range micro-scale authentication scenarios where a printed Blocktag is too small to be seen without specialized optical equipment like microscopes. A consumer-grade scan device with digital magnification will interpolate and distort the pixels that represent specific chaosmetric artifacts, but general chaosmetric patterns can still be derived from a halftone or fractal for authentication.
Prevents bad actors from fooling a scan device’s inferred perpendicular distance from a Blocktag’s markers to compromise proof of presence authentication. For example, by attaching a telescopic/microscopic lens to the scan device’s camera so that the camera’s intrinsic parameters do not represent the actual digital/optical magnification. Halftones can guard against this adversarial attack as the halftone’s visibility threshold at a given distance and digital/optical magnification from a scan device with a known set of intrinsic camera parameters is a constant.
Print quality problems are more likely to happen in a decentralized system where Blocktag printing is self-serviced by 3rd parties than in a centralized system controlled by a 1st party Blocktag manufacturer. For example:
   Random human errors during blueprint request stage such as submitting wrong input printer specs.
   A requesting party with adversarial intent falsifying printer specs to compromise the tag’s print quality/security during blueprint request stage.
   Printer technical issues such as overused, clogged print nozzle, print misalignment in different layers during pre-print or printing stage.

Halftone patterns are structures (e.g. a line grating pattern) that can be embedded (e.g., by the cliaosmetrics specification engine 342 and/or the component specification engine 344 of the security device generator 340 of the host server 300 shown in the example of FIG. 3A) in a small area within any 1st party or 3rd party content element/marker to ensure printed cliaosmetrics artifacts/features are reasonably chaotic for a scan device distinguish an original from a cloned Blocktag. Fractal patterns are structures (e.g. Koch curve) that can be broadly embedded (e.g., by the chaosmetrics specification engine 342 and/or the component specification engine 344 of the security device generator 340 of the host server 300 shown in the example of FIG. 3A) on whole areas around or within any 1st party or 3rd party content element/marker. When a printed fractal pattern is digitized, it’s fractal dimension measured by a scan device is ideally greater than or equal to the fractal dimension of the source computer-generated fractal blueprint. Fractals also solve the problem of printing chaosmetrics consistently across printers with different print resolutions.
Other quality control problems may happen along later stages of a self serviced Blocktag system when tags are printed, fingerprinted and authenticated by a 3rd party who is not a Blocktag manufacturer. For example, Imaging inconsistency can occur between tag inspection/fingerprint stage versus authentication stage for Blocktags on surfaces that are curved, uneven, textured, stretchable, soft etc.

A Blocktag (e.g., a tag, a security device, a security device 108A-N as shown in the example of FIG. 1, security devices as shown in the example of FIGS. 6D-6M) can be printed first on flat sticker paper and pasted later on curved surfaces such as cylindrical product packaging. A Blocktag sticker must be inspected and fingerprinted after it is pasted on a curved surface. This correct order can be maintained by using fractal dimensions to quantify chaosmetrics pattern warping caused by a surface’s curvature. In this way, the warped, printed fractal measured during inspection/fingerprinting is consistent with the fractal during authentication. A Blocktag can be printed on uneven surfaces such as soft fabrics, stretchable rubber (gloves). The surface configuration of a Blocktag captured by a scan device during inspection/fingerprint stage may be different from the configuration captured during authentication stage as the surface may be deformed, stretched etc. The scan device can prompt the user to adjust the Blocktag’s printed surface by using fractal dimension/lacunarity to visualize which portions of the surface need adjustment. This ensures a fractal’s inherent structure measured during inspection/fingerprinting is consistent with the structure during authentication.
When a specific chaosmetric artifact is digitized by a scan device during fingerprinting or authentication stage, grayscale pixels of the digitized artifact may misrepresent the analog artifact’s ink distribution if:
The scan device’s camera is too far away from the printed chaosmetric artifact for grayscale pixels to represent the digitized artifact correctly.
The scan device’s camera resolution was insufficient to image the chaosmetric artifact at a given distance, causing the device to interpolate pixels of the digitized chaosmetric artifact incorrectly
The scan device’s captured image is blur due to camera defocusing or user’s jerky movement.

The inherent structure of halftones and fractals can be used to ensure the fingerprinted baseline’s pixels represent the analog chaosmetric artifacts correctly. In summary, different scenarios (short versus long range) use different chaosmetrics (general versus specific) print properties to authenticate.

| | | |
|---|---|---|
| | Short Range Authentication | Long Range Authentication |
| General Chaosimetrics | Item level: Fractal dimension/lacunarity Halftone sharpness | Item-Device level: Halftone visibility threshold Halftone moire range |
| Specific Chaosimetrics | Item level: Fractal or halftone ink edge distortion | Not Applicable |

### Printing Stage 568

### Chaosmetric Patterns Generated by Paper Type Misdirection

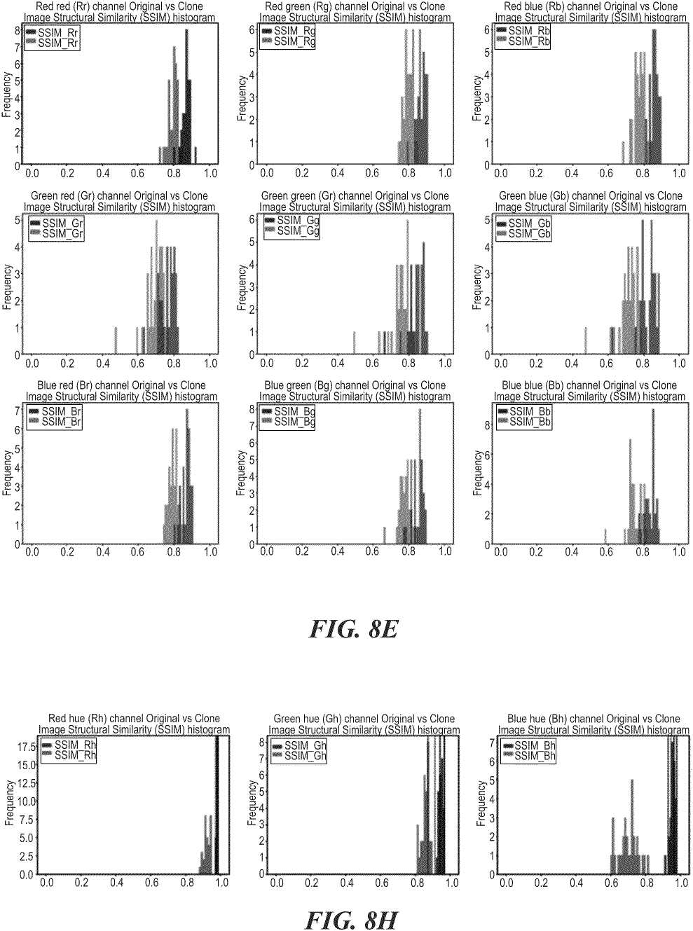

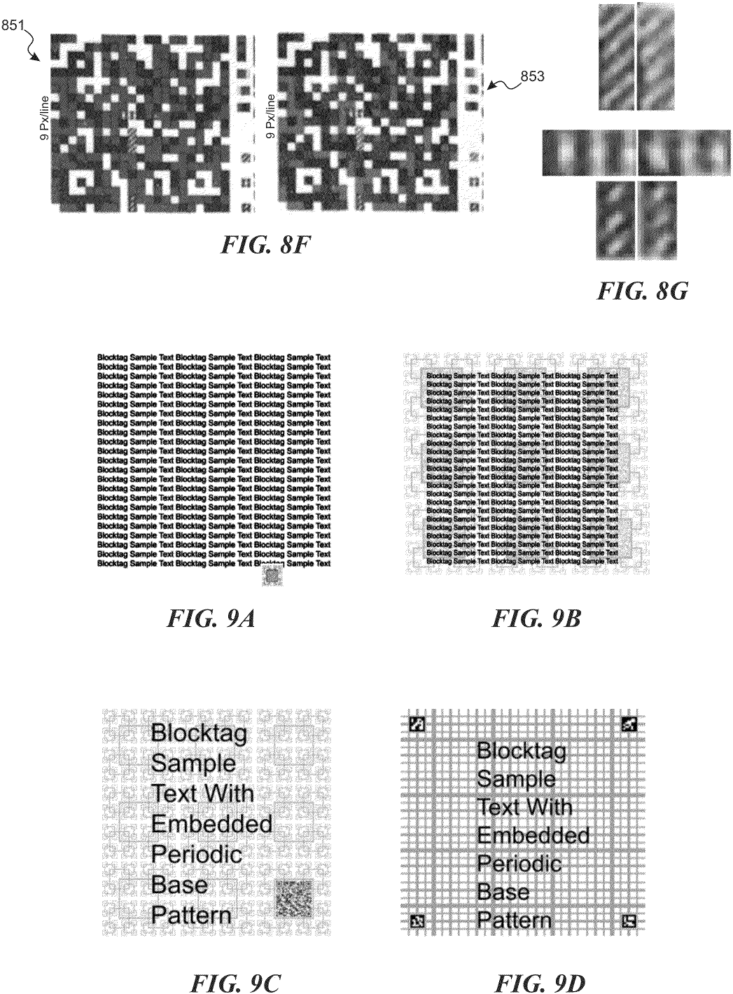

During the printing stage, chaosmetric features/artifacts can be generated by paper type misdirection. For example, the print job setting can be configured to increase randomness of the chaosmetric patterns by select a paper quality in the setting that is different from the actual paper quality fed into the printer. For example, select photo quality paper is selected but plain paper is fed into the printer to be printed. This technique can result in the printed ink to bleed more especially for inkjet printers, producing enhanced chaosmetric artifacts/features. The printed analog patterns will look different from the source digital pattern. The print setting can be configured in a few ways:
Manually by a human operator from the print job window (e.g. The MacOS print job window as shown in the example of FIG. 8A) when printing the tag blueprint (e.g. Pdf).
Programmatically on Blocktag’s website when users print the generated tag blueprints directly without downloading any blueprints (Pdf, jpg, png etc)
Using a printer driver developed by Blocktag or includes Blocktag capabilities. In one embodiment, there is a Blocktag option in the printer settings that could configure the print job to generate chaosmetrics.

### Chaosmetric Patterns Generated by Multi-Feed Overprinting

In a further embodiment, chaosmetric features/artifacts can be generated by feeing the same paper multiple times during the printing stage. For example, instead of feeding each paper once through the printer, feed the same paper multiple times to print different colored layers one over another. This is known as multi-feed overprinting and can be performed manually or automatically using automated printing feeders. FIG. 8B depicts an example of a digital tag blue print having multiple layers to be over printed, in accordance with embodiments of the present disclosure. FIG. 8C depicts an example of an overprinted output by feeding the same paper multiple times through the printer, in accordance with embodiments of the present disclosure.

### Chaosmetric Pattern Printing Variants

Analog patterns can be generated by depositing ink or other materials used by print processes on any printable surface (e.g. paper, fabrics). For example:
1. Toners in laser printing
2. Solid to gaseous ink transfer in sublimation printing
3. Heat transfer print techniques
4. Ultraviolet printing where base layers of ink are hardened by UV light treatment, creating 3D pattern textures)
5. Patterns created from depositing other materials besides ink using 3D printer.

Another way to generate analog patterns besides printing is via photolithography techniques. For example, ultraviolet curable resins can be used to generate patterns on glass and plastic surfaces. FIG. 9A depicts an example of zigzag patterned lines formed in a plastic substrate, in accordance with embodiments of the present disclosure. FIG. 9B depicts an example of a heart pattern where each basic unit heart block can be modelled mathematically, in accordance with embodiments of the present disclosure. FIG. 9C depicts an example of horizontal and vertical line patterns on holographic plastic surface, in accordance with embodiments of the present disclosure. Another way to generate analog patterns is via chemical etching. For example, this is commonly found in semiconductor fabrication processes to generate patterns or 3D microstructures on metallic surfaces. FIG. 9D depicts an example of horizontal patterned diffraction lines from point light source reflecting off metallic surface designed with nanostructures and an adjacent QR, in accordance with embodiments of the present disclosure.

Chaosmetric patterns can also be printed through additional techniques. For example:
1. Heat transfer printing where the pattern is first printed on paper. Subsequently, ink is thermally transferred from the paper to another surface such as a fabric using heat and pressure. The heat transfer process amplifies ink randomness as the fabric may have an uneven texture and ink colors may change when heated.
2. Water slide transfer printing where the pattern is first printed on a special paper lined with adhesive on one side. The pattern is printed with ink on the adhesive side. Ink is transferred from the paper to another surface using water and pressure. For example, pressing a paper printed with a tattoo pattern onto skin with a damp cloth. The water slide transfer process amplifies ink randomness due to varying skin moisture and ambient humidity.
3. Sublimation printing where solid ink is converted to gaseous state first before ink deposition.
4. Ultraviolet printing where base layers of ink are hardened by UV light treatment, creating 3D pattern textures.
5. Microprinting at a scale that requires analog or digital zoom magnification to read with the naked eye. For example, using offset printing plates, Intaglio printmaking, laser etching or laser marking to print recognizable characters/patterns on currency or bank cheques.
6. 3D printing depositing other materials besides ink using 3D printer.
7. Photolithography. For example, ultraviolet (UV) curable resins can be partially exposed to UV light to etch chaosmetric patterns on glass and plastic surfaces.
8. Chemical etching commonly found in semiconductor fabrication processes to generate patterns or 3D microstructures on metallic surfaces. To create chaosmetrics, wash metallic surfaces with the chemical etchant for a shorter time so that the 3D microstructures etched on the metal are incomplete. The imperfect etching becomes a source for desirable chaosmetric patterns.

### Caos Amplification Devices

The degree of pattern chaos can be amplified by attaching other devices to the print device. Examples include the following.

### Chaos Amplification by Mechanical Vibration in Inkjet Printers

A chaos amplification device (e.g., the chaos amplification unit 132 as shown in the example of FIG. 1) can include a mechanical device pre-programmed to vibrate randomly. The device can for example, be directly mounted on components near the print nozzle of an inkjet printer (e.g. The ink cartridge) using mechanical attachments and/or adhesives and/ or magnetic attachments, so that random vibrations to the printhead or nozzle will displace the ink randomly from its target location on paper. Mechanical vibrations travel through solids well, so any part of the printer that is physically connected to the print nozzle is generally suitable for having a chaos amplification device mounted thereon. The system can vary the vibration properties (e.g., frequency, amplitude, timbre etc.) randomly to amplify the degree of chaos.

### Chaos Amplification by Electrostatic Charging in Laserjet Printers

The chaos amplification device (e.g., the chaos amplification unit 132 as shown in the example of FIG. 1) can include an electrostatic charging device such as a charge plate (capacitor) or charge drum, for example, that negatively (or positively) charges a paper before it is fed into a laser printer. The paper’s charge may be distributed more randomly and unevenly by embedding/infusing/ sprinkling the paper with electrically conducting materials such as iron, aluminum, copper, selenium, or silicon for example. The electrostatic charging device can, for example, be mounted on top of the paper feeder tray of a laserjet printer so that unevenly distributed charges on the paper may displace the electrostatically changed toner randomly. In one embodiment, inks can also be electrostatically charged so that they interact chaotically with electrostatically charged paper.

### Fingerprinting Stage 570

### Single Tag Fingerprinting

Each tag with a unique QR, a unique color barcode and a unique chaosmetrics pattern can be fingerprinted (e.g., by the fingerprint engine 314 of the example of FIG. 3A and/or the fingerprint engine 415 of FIG. 4A) by a scan device (e.g. a user device, a client/mobile device 102A-N as shown in the example of FIG. 1 and/or a client/mobile device 402 of the example of FIG. 4A).

### Multi Tag Fingerprinting

A tag batch can be engineered so that only one tag needs to be fingerprinted to represent the fingerprints of other tags printed on the same sheet of paper. In one embodiment, all tags on the paper are implemented to have the same color barcode and chaosmetric feature/pattern. Each tag still has a unique QR to represent multiple original tag instances having the same color barcode.

### Multi Tag, Single Sheet Panoramic Image Fingerprinting

If each tag on a sheet of paper has a unique QR, a unique color barcode and a unique chaosmetric pattern, The tags can be scanned in bulk by using a scan device such as a phone camera to capture multiple images of the sheet with overlapping fields of view to produce a panoramic image capturing the whole sheet. The panoramic image is then sent to Blocktag’s server (e.g., the host server) for asynchronous fingerprinting.

### Multi Tag, Multi Sheet Feeder Scanner Fingerprinting

Multiple printed tag sheets can be fed into a scanner with a multi-sheet feeder to scan all tags in bulk. The scanner output is then sent to Blocktag’s server for asynchronous fingerprinting.

### Augmented Reality (AR) Guided High Precision Fingerprinting

For high valued physical goods that require high security, a scan device (e.g. a user device, a client/mobile device 102A-N as shown in the example of FIG. 1 and/or a client/mobile device 402 of the example of FIG. 4A) with gyroscope and/or GPS or RFID antenna can be used to increase fingerprinting precision. To achieve this, the disclosed system records (e.g., by the fingerprint engine 314 of the example of FIG. 3A and/or the fingerprint engine 415 of FIG. 4A) the scan device’s orientation (pitch, roll, yaw, horizontal x position, vertical y position, z depth) relative to the tag when the requesting/affiliate party uses the scan device to fingerprint the tag. In performing the fingerprinting process (e.g., by the fingerprint engine 314 of the example of FIG. 3A and/or the fingerprint engine 415 of FIG. 4A), the system can, in one embodiment, require or request the requesting/affiliate party to fingerprint the tag at one or more specific orientations by using an augmented reality user interface. The augmented reality user interface can guide the requesting/affiliate party in six degrees of freedom (pitch, roll, yaw, up/down, left/right, top/down) to orientate the scan device correctly. For example, through an augmented reality experience, a tag owner can guide user on what orientation and position to fingerprint the tag by prompting the user to fit his phone (e.g., scan device) onto the floating 3D AR blue box. Alternatively, the user can fingerprint the tag freely and a floating 3D AR blue box can be created to represent a position and orientation if the scan device during fingerprint. Subsequently, the registered 3D floating blue box will appear again during authentication for users to fit their tag on it.

A fingerprint can be characterized by a structural metric and/or a sharpness metric (e.g., by the fingerprint engine 314 of the example of FIG. 3A and/or the fingerprint engine 415 of FIG. 4A). A structural metric can include the shape of chaotic printed ink and frequency of recurring halftone/fractal patterns detected as different colors with or without a printed reference color palette. There are counterfeit cases where a structural metric may not be captured as well as photocopies, which is why sharpness metric complements structural metric as photocopies will render similar structures as being sharper or blurrier. In one example, a sharpness metric can be determined using the variance of the Laplace transform of an image. In this example, a high variance corresponds to sharp renderings of the edges of chaosmetric artifacts, and a low variance means the edges are blurred. The structural metric can be determined using a process to mask noisy pixels and improve authentication noise-to-signal ratio by quantifying structural similarity from edges of chaosmetric features, Additional techniques for fingerprinting include a process to identify or detect a paper type from a scan device during fingerprinting stage. The paper type can include any of Matt, Glossy, Photo quality, Normal Quality etc. The detected paper type is used to confirm consistency with the paper type specified by the user during tag generation, Knowing the correct paper type, the system can perform the PaperTrick technique to increase chaosmetrics effectively and reliable at scale when user self services the print process. In one embodiment, the paper type can be determined (e.g., by the fingerprint engine 314 of the example of FIG. 3A and/or the fingerprint engine 415 of FIG. 4A) through inference by implementing and training an AI engine using labelled examples of different paper types. The AI engine can be trained and therefore learn from the different grain, texture, patterns colors when imaged under a scan device or scanner. In addition, the AI engine can be trained (e.g., by the fingerprint engine 314 of the example of FIG. 3A and/or the fingerprint engine 415 of FIG. 4A) to identify or detect the type of printer used to generate tags or blueprints. For example, the AI engine can be trained to differentiate between Inkjet printed tags and laserjet tags as laserjet toners produce sharper, glossy printed edges while inkjet produces blurrier, more gradual transitions from one ink color to another.

### Authentication Stage 572

### Online Chaosmetric Pattern Authentication With Fingerprint

In one embodiment, the scan device and/or the host server can perform authentication (e.g., by the authentication engine 318 of the example of FIG. 3A and/or the authentication engine 414 of the example of FIG. 4A) to authenticate chaosmetric patterns on a tag (security device) by comparing image similarity with baseline chaosmetric pattern which has been previously fingerprinted. The previously fingerprinted baseline chaosmetric pattern is one generated from the same security device and can be fetched from the host server. The authentication process can be performed by any of the following entities or any combination of the following entities:
A scan device (e.g. a user device, a client/mobile device 102A-N as shown in the example of FIG. 1 and/or a client/mobile device 402 of the example of FIG. 4A) as a locally installed 1st party client application (e.g. an iOS app for iPhone);
A server (e.g., by the authentication engine 318 of the host server 300 shown in the example of FIG. 3A)and accessed by 3rd party client application as a white label service (e.g. XYZ Brand application powered by the authentication engine 318;
A generic application, such as a browser on a computing device, or a local application (such as any mobile or desktop application, or point of sale software, track and trace software, etc.) on a computing device.

### Chaosmetric Pattern Detection

The chaosmetric pattern’s print anomalies can be microscopic and not obvious to human vision, but can be detected/measured by computer vision. In traditional counterfeit detection, human operators use a magnifying glass and/or other specialized hardware to detect the presence of authentic artifacts on the physical good (e.g. Checks). In one embodiment, the disclosed system performs computer vision techniques (e.g., by the verification engine 310 of the host server 300 shown in the example of FIG. 3A and/or the verification engine 412 of FIG. 4A) to automate counterfeit detection processes. A scan device (e.g. a user device, a client/mobile device 102A-N as shown in the example of FIG. 1 and/or a client/mobile device 402 of the example of FIG. 4A) executing performing authentication (e.g., by the authentication engine 318 of the example of FIG. 3A and/or the authentication engine 414 of the example of FIG. 4A) can auto-detect and auto-zoom onto tags. Once the tag is detected, the scan device can auto-focus on printed reference patterns such as fractals, halftones and grids. These patterns can be used as camera focus feedback. Microscopic tags can also be authenticated (e.g., by the authentication engine 318 of the example of FIG. 3A and/or the authentication engine 414 of the example of FIG. 4A) using any scan device with analog or digital zoom magnification. The scan device can auto zoom once a micro-Blocktag is in range and identified at camera resolution scale. When users point their camera (e.g. a user device, a client/mobile device 102A-N as shown in the example of FIG. 1 and/or a client/mobile device 402 of the example of FIG. 4A) at a Blocktag on a physical object, through computer vision techniques, areas on the Blocktag’s chaosmetric pattern image that are different from the fingerprinted version can be detected and flagged.

### Chaosmetric Pattern Measurement

FIG. 8D depicts an example of a side by side comparison of an original security device 833 and a cloned security device 831, in accordance with embodiments of the present disclosure. In this example, the cloned tag 831 is a reprint of the original from same tag blueprint printed on the same paper with the same printer (Konica Minolta BizHub C1070 with print dpi=1200) FIG. 8E depicts an example of an image similarity histogram of fingerprinted original tag against treatment original tag (black histogram) and treatment cloned tag (light grey histogram), in accordance with embodiments of the present disclosure. In this example, the x-axis represents the image similarity bins and y-axis represents the number of treatment instances in each bin. Note that original tags can be distinguished from cloned tags by drawing a vertical line that best separates black histogram from light grey histogram. In addition, authentication shows original tags having higher image similarity on average than cloned tags. FIG. 8F depicts an example of Side-by-side comparison of tag printed from the same blueprint on the same printer with different paper feed settings (851: Photo Paper, 853: Plain Paper)., in accordance with embodiments of the present disclosure. FIG. 8G depicts zoomed images of chaosmetrics artifacts in the tags printed as shown in the example of FIG. 8F, in accordance with embodiments of the present disclosure. FIG. 8H depicts a comparison of the image structure similarity histogram of the tags printed as shown in the example of FIG. 8F, in accordance with embodiments of the present disclosure.

### Augmented Reality Guided Fingerprinting and Authentication

In a further embodiment, users can be guided by the system ((e.g., the host server 100 of FIG. 1 and/or the host server 300 of FIGS. 3A-3B and/or the client/mobile device 102A-N as shown in the example of FIG. 1 and/or the client/mobile device 402 of the example of FIG. 4A as shown by Blocktag application user interface) during authentication to place the scan device (e.g. a user device, a client/mobile device 102A-N as shown in the example of FIG. 1 and/or a client/mobile device 402 of the example of FIG. 4A) at the same position as when a device was placed to fingerprint the tag. This enhancement can be useful in scenarios where authentication requires high security (e.g. Image similarity >0.95),

In general, the closer the device’s pitch, row, yaw (PRY) during authentication is to its PRY determined during fingerprinting (e.g., by the fingerprint engine 314 of the example of FIG. 3A and/or the fingerprint engine 415 of FIG. 4A), the higher the image similarity measured (e.g., by the fingerprint engine 314 of the example of FIG. 3A and/or the fingerprint engine 415 of FIG. 4A). This is because the image similarity measure between a chaosmetric artifact/pattern’s snapshot and its fingerprinted baseline is sensitive to rotational (pitch, roll, raw) changes between the device and tag. Since chaosmetric artifacts are small and represented by a few pixels, pixel interpolation during the warped perspective operation to “normalize” translation and rotation affects similarity values.

### Augmented Reality Guided Challenge-Response

In a further embodiment a scan device (e.g. a user device, a client/mobile device 102A-N as shown in the example of FIG. 1 and/or a client/mobile device 402 of the example of FIG. 4A) and a tag (e.g., a security device, a “Blocktag”, a security device 108AN as shown in the example of FIG. 1, security devices as shown in the example of FIGS. 6D-6M) can be used to challenge someone to respond and prove that they physically possess a tag (i.e. Proof-of-Possession challenge-response).

The challenge-response process can include, one or more of:
A challenge-response protocol deployed on a scan device. The challenge-response protocol can in one embodiment, challenge the participant to respond by orienting the scan device relative to the tag to meet one or more requirements in the six degrees of freedom (pitch, roll, yaw, left, right, up, down forward, backward) per challenge-response instance and across multiple instances in time.
Augmented reality (AR) features deployed on a scan device to facilitate the authentication process between the challenge-response protocol and a participant.

One example of an augmented reality feature for challenge-response is as follows:
1. Record the device’s PRY during chaosmetric pattern fingerprint in a few orientations
2. Show the device’s PRY during fingerprint as an augmented reality ‘ghost’ phone. For challenge response, users can orientate their phone so that it fits directly on the AR ghost phone.
3. When we see image similarity reaching a max value when phone is on AR ghost plane, challenge-response passes

### System Integration With 3rd Party Legacy Tag Systems

In one embodiment, tag authentication functionality can be integrated with 3rd party legacy tag systems (e.g., by the integration engine 330 of the host server 300 shown in the example of FIG. 3A). The chaosmetric artifacts generation process (e.g., by the chaosmetrics specification engine 342 and/or the component specification engine 344 of the security device generator 340 of the host server 300 shown in the example of FIG. 3A) of the disclosed tags can be integrated with the requesting party’s legacy tag system during one or more stages of the disclosed self-serviced tag request, generation, inspection, printing and/or fingerprint system. For example:
1. During tag request, the requesting party can input pre-existing metadata that represents a legacy 3rd party QR or part of a new 1st party QR to be associated with a new color barcode serial ID.
2. During tag generation, instead of generating a new 1st party QR, a tag generator (e.g., tag generator 340) can omit the 1st party QR design and leave a blank area in the blueprint to be filled in by a 3rd party legacy QR in later stages (e.g. Tag printing)
3. During, before or after tag fingerprinting, the scan device can also detect and register a legacy 3rd party QR adjacent to a color barcode’s serial ID of a tag.

### System Integration With Blockchains

The following are examples of integration of the system with blockchain (e.g., by the integration engine 330 of the host server 300 shown in the example of FIG. 3A):
1. Integration to enable tag data storage and data integrity - so that the system can utilize blockchain to solve the consensus problem (so potentially adversarial parties can agree on the data).
2. Integration can leverage the consensus around timestamps in blockchain blocks to prove that a challenge response authentication flow was completed within a certain time frame (e.g., by the telemetry identifier 332 and/or the time proof engine 334 of the integration engine 330 of the host server 300 shown in the example of FIG. 3A).

In one embodiment, after a successful authentication (or online authentication), the recorded telemetry (e.g., by the telemetry identifier 332 and/or the time proof engine 334 of the integration engine 330 of the host server 300 shown in the example of FIG. 3A) from an item’s tag and 3^{rd} party user’s device (i.e. An item-device authentication unit) can be stored on a Blockchain and further used to cross validate other item-device authentication sessions (e.g., by the verification engine 310 of the host server 300 shown in the example of FIG. 3A and/or the verification engine 412 of FIG. 4A) belonging to the same item. For example, the recorded telemetry (e.g. Fingerprint, fractal dimension/lacunarity, and/or halftone frequency amplitude) from a 3rd party device that share same or similar intrinsic camera parameters, phone model and/or distance between item and device can be used to cross validate another user’s authentication session. Therefore, one embodiment of the system is able to perform decentralized cross validation (e.g., by the verification engine 310 of the host server 300 shown in the example of FIG. 3A and/or the verification engine 412 of FIG. 4A) with integration of the system with Blockchain. The decentralized cross validation function can for example, solves the problem of physical tag degradation over time. When a tag is placed in external environments under sunshine, humidity etc., dirt may accumulate or the tag’s printed colors may fade. With decentralized functions, such as decentralized cross validation, the fingerprint and other metadata used to authenticate a tag can be updated automatically and over time in a decentralised manner by various across any user.

In one example, some use cases require data to be stored under a company’s custody (e.g., for compliance reasons). An alternative to storing the data directly on a blockchain, whether public or private, is storing only the hash of that data on the blockchain. This enables the system to verify the integrity of the data, and further enables the owner to keep it private. In addition the various properties from the fingerprint of a tag, separately and in conjunction with the properties of a scan device, can be cross referenced to generate challenge response authentication schemes (e.g., by the verification engine 310 of the host server 300 shown in the example of FIG. 3A and/or the verification engine 412 of FIG. 4A). For example, a tag can reflect a different color based on the viewer’s viewing angle. A generated challenge could be to “scan tag from top left to bottom right”, and a user would need to scan the tag as prescribed, with the tag responding in a predetermined way, for the response to be validated. This challenge can be generated at random. To ensure that the challenge was generated at random, at a certain time, the system can perform time proofing (e.g., by the telemetry identifier 332 and/or the time proof engine 334 of the integration engine 330 of the host server 300 shown in the example of FIG. 3A) based on a blockchain. One embodiment of the time proof process is performed as follows:

Every newly generated block in Bitcoin and Ethereum has an associated hash identifier (Blockhash) that is unpredictable. Each block hash is included in the next block which when hashed, forms a chain of hashes. In other words, every time a new block is confirmed, older block proof of work (PoW) hashes are included in a longer and longer chain (also known as a Merkle tree). It turns into a hash of a hash of a hash of a hash, etc. Therefore, the more future blocks there are, the more likely a historical block is valid (e.g., reaching consensus across the network). By including this hash with a data write on a blockchain, a time window in which this data was generated (for example, when a tag was scanned) can be proved. In the example below, a time window in this example can be defined by a start time, and an end time, and the blockchain has an average block time of 10 minutes.
1. Block b (time t): This blockhash is used to generate a challenge within a challenge-response authentication scheme. This block’s timestamp is the start time.
2. The user solves the challenge from step 1 and submits the resulting data to the blockchain network in a transaction.
3. Block b+1 (time t+10 minutes): The transaction that was submitted in step 2 is confirmed, because this current block contains Block b’s hash. This block’s timestamp is the end time.
4. Block b+2 (time t + 20 minutes): The transaction that was submitted in step 2 is confirmed again, as the hash of the previous block (Block b+1) is included in this block, which in turns contains the hash of the block that contains the transaction (Blockb). This and each subsequent block adds more assurance that Block b and Block b+1 are valid, verifying the start and end times of the challenge-response flow.

Historical blocks have timestamps that have reached consensus. After a challenge-response flow is complete, anyone with access to historical blockchain data can validate/verify the time window in which the challenge-response was performed, without needing to trust a 3rd party validator/verifier, unlike in centralized systems. The shortcoming of a centralized system would be the fact that while the server can offer a challenge-response, 3rd parties have to trust that server to be truthful in generating the challenge at the time it said it did and to show that the response is valid. Some examples of use cases include the following:
A buyer may ask a seller to prove that they still have the actual item for sale. A seller may want to prove that they have a specific product on hand ready to ship at a specific time. The time proof with challenge-response authentication would prove the seller scanned the item, within a short (or recent) time window.
A courier may want to prove that they delivered a specific parcel to a specific recipient at a specific time. The time proof with challenge-response authentication would prove the recipient scanned the item within a short time window as a way to confirm delivery.

Time proof transaction can also be used as an input to a smart contract. For example, if recipient of a package solves a challenge-response authentication within 3 blocks (aka the recipient has proved that they have received the package), then allow the courier to withdraw funds and block the sender from withdrawing funds.

### System Integration With Location Tracking

One embodiment of the present disclosure includes integration of the system with location tracking (e.g., by the integration engine 330 of the host server 300 shown in the example of FIG. 3A). Given a Blocktag with a known latitude and longitude, the authenticated proof-of-presence distance between the Blocktag and a user’s scan device can be plotted as a locus of points on a digital map. This features solves the following challenges:
Global Positioning Systems (GPS) have limited resolution. Blocktag’s proof-of-presence system implemented with location tracking can generate finer positioning resolution on a user’s physical location outdoors and indoors.
A user can mask their physical location and IP address on their computing device using Virtual Private Networks (VPN). Blocktag’s proof-of-presence system unmasks users’ location even if users are using VPN on the scan devices. This can for instance, enable companies to track employee’s remote work physical locations.

### Security Device (Blocktag/Tag) Variants

### Integrate of Security Device With Other Authenticity Hardware

For example, If a 3rd party prints the color barcode and QR code components on a physical good, the 3rd party can affix a microlens/nanodiffractive/hologram on top of the color barcode in a way similar to how mail stamps are affixed on top of a square area on an envelope.

### Integrate of Security Device With Text/Image Element

In one embodiment, a page of text/images is marked with a Blocktag. During tag request, the requesting party can specify a page of text/images to be marked. This specification can be provided in an application that is integrated with the system’s API. For example, if the requesting party opens a PDF document in a pdf opener application (e.g., Acrobat), a system plugin for the pdf opener application can generate and place a tag on the PDF document. During tag generation, the system can generate a digital tag blueprint that encodes the text/image characteristics to create a 1-to-1 mapping between the tag/image and text. Text characteristics include for example, the content (e.g., letters, numerals and/or characters) of the text and positions of the text. The positions of the text can be specified relative to the tag. Image characteristics can include shift invariant corner point positions in the image. The system can then embedd the tag around the text’s/image’s white spaces. The digital page integrated with a Blocktag can then be printed, and fingerprinted.

During authentication of a security device (e.g., a tag, a “Blocktag”, a security device 108A-N as shown in the example of FIG. 1, security devices as shown in the example of FIGS. 6D-6M), a scan device (e.g. a user device, a client/mobile device 102A-N as shown in the example of FIG. 1 and/or a client/mobile device 402 of the example of FIG. 4A) can scan security device integrated with the page to distinguish the printed original page from cloned pages, A cloned page can be, for example, a photocopy of the original printed page or a reprinted copy of the original digital page. The scan device can automatically zoom in to capture the unique printed chaosmetric artifacts/patterns of the Blocktag. The scan device can further compare the unique printed chaosmetric artifacts/patterns with a fingerprinted baseline (e.g., by the fingerprint engine 314 of the example of FIG. 3A and/or the fingerprint engine 415 of FIG. 4A). The scan device can also zoom out to capture the page’s Blocktag and text/images together.

In one embodiment, the scan device performs computer vision techniques such as Optical Character Recognition (OCR) to detect the printed text’s characteristics or Shift Invariant Feature Tracking (SIFT) to detect the printed image’s characteristics (e.g., by the fingerprint engine 314 of the example of FIG. 3A and/or the fingerprint engine 415 of FIG. 4A). The detected text/image characteristics can then be compared with the expected characteristics encoded in the Blocktag.

In a further embodiment of tag generation, the system places horizontal/vertical/diagonal rows of tag blueprints behind the text/image as a translucent watermark, as shown in the example of FIG. 9A. This prevents the text/image from being physically separated from the tag after printing. For example, this implementation prevents a printed Blocktag from being cut out from a printed original document and pasted on a reprinted copy of the source document with the same text/image. In a further embodiment of tag generation, a page of text/image can be marked by a patterned watermark behind the page’s text/images, as shown in the example of FIG. 9B. The watermark can be designed as a monochrome light gray, translucent, non-intrusive fractal pattern behind a black text document. The fractal pattern can, for example, be encoded with a Blocktag or be stenographically encoded across the print without a Blocktag (e.g., by the chaosmetrics specification engine 342 and/or the component specification engine 344 of the security device generator 340 of the host server 300 shown in the example of FIG. 3A). During stenographic generation, a fractal pattern can be encoded (e.g., by the chaosmetrics specification engine 342 and/or the component specification engine 344 of the security device generator 340 of the host server 300 shown in the example of FIG. 3A) in the following example processes:
A text’s single letter, numeral or other characters can embed a periodic halftone base pattern that encodes a rule defining the fractal. The fractal pattern can be signed across the text as variations to each letter’s embedded base pattern periodicity characteristic. Other text characteristics such as color, grayscale can also be used to define the fractal.
In another fractal encoding example process, the fractal pattern is superimposed onto the text and intersected with the letters themselves, so only letters that overlap some of the fractal would have their color spectrum or greyscale altered. If the cell density of the fractal is tight enough, then more letters will be affected. The variations in the way the letters are printed expresses cells in the hidden fractal that are either “on” or “off.” So a dark letter, or a letter that is more red vs. more blue (with the black) can signify an on or off cell in the hidden fractal. This fractal would be encoded into the printing of the letters.
In a further example, each letter can be lined with fractal subsets (i.e. A truncated Koch Curve) along its edges to amplify each letter’s printed chaosmetrics to authenticate a printed page of text printed on a specific paper type.

The digital page marked with a stenographic fractal can then be printed, and fingerprinted. During stenographic authentication, The positions of the printed base patterns and other font properties that define the fractal watermark can be detected by a scan device using computer vision techniques such as Optical Character Recognition (OCR). Optional markers may also be integrated with the document to facilitate OCR. The document’s general chaosmetrics (i.e. Special characteristics of the printer, ink and paper) are quantified by comparing the printed fractal watermark’s dimension/lacunarity with a fingerprinted baseline. The document’s specific chaosmetrics (i.e. Random ink distortions along edges of fractals and fractal subsets) are quantified by comparing the ink distortion’s structural similarity with a fingerprinted baseline. In another stenographic generation approach, a page of text can be marked with overt/covert structures that vary the page’s rendering. For example add a pigment that makes a character look black to the naked eye but actually gives the character a unique pixel color/grayscale histogram. Besides a page’s characters themselves, other page variables can also be used such as:
The grayscale and/or pattern in the “spaces” between the letters and the lines.
The space between the characters
The space between words
The spaces between the lines of text
The left/right/top/bottom margin width
Font color, grayscale, type, size of characters supported by standard text encoding formats (e.g. Unicode, ASCII)

In one embodiment, a page of text can be uniquely signed using these page variables. Every unique page printed from a printer can be digitally signed with enough data derived from that page itself as a Blocktag. The unique fingerprint of the text itself is encoded into the printed object of the page. When the page is later scanned by a device (e.g. a user device, a client/mobile device 102A-N as shown in the example of FIG. 1 and/or a client/mobile device 402 of the example of FIG. 4A) installed with Blocktag software, the signature can be detected and authenticated by comparing with the original digital page without a fingerprinted page baseline.

In summary, the processes for Blocktag (e.g., a tag, a security device, a security device 108A-N as shown in the example of FIG. 1, security devices as shown in the example of FIGS. 6D-6M) integration with text/image element includes:
1. Using a Blocktag to mark a page of text and/or images
2. Marking a page of text and/or images by adding overt and/or covert structures to variations in rendering and/or watermarking a page of text and/or images (Not necessarily including a Blocktag)
3. Methods 1 + 2 combined.

If the system combines (e.g., by the chaosmetrics specification engine 342 and/or the component specification engine 344 of the security device generator 340 of the host server 300 shown in the example of FIG. 3A) this covert encoding into the letters with the overt Blocktag, the advantages of both techniques are achieved. The Blocktag gives the user something to aim at that looks up a record on the blockchain. The covert fractal in the text (or other attributes of the printing) can then be read and compared (e.g., by the verification engine 310 of the host server 300 shown in the example of FIG. 3A and/or the verification engine 412 of FIG. 4A) to what is registered for that page on the blockchain record of the Blocktag. In another example process, there is no Blocktag and/or there is no need to look anything up remotely - the encrypted covert or overt watermark in the text is sufficient to authenticate the document.

The process of marking a page therefore eincludes-
(1) Using a blocktag AND EITHER OR BOTH OF
   (a) encrypted watermark either behind the text or on top of it, OR
   (b) encrypted authentication structures embedded into the printing of the page (variations of type face color, line spacing, etc.)
(2) Performing process (1) without the Blocktag part: EITHER OR BOTH OF
   (a) encrypted watermark either behind the text or on top of it, OR
   (b) encrypted authentication structures embedded into the printing of the page (variations of type face color, line spacing, etc.)

Documents that utilize Blocktag’s fractal watermark solves weaknesses in document security. One of the weaknesses of tools like Docusign and e-signatures is that there is no obvious way to authenticate the signatures from documents they are in. Putting a digital or analog Blocktag stamp on a document enables anyone to authenticate any signature using their smartphone. Users can aim their smartphone at the digital copy on a computer screen or TV or any display, such as on another phone. In applications that are integrated with the authentication API of the system. A user can also authenticate (e.g., by the authentication engine 318 of the example of FIG. 3A and/or the authentication engine 414 of the example of FIG. 4A) any Blocktag that appears and is detected in an image or file or application, automatically or on-demand, directly from within the application in which the tag is rendered. For example if a PDF is opened in Acrobat having a digitally signed Blocktag stamp, a plugin for Acrobat can detect it and authenticate the tag. The plugin can also mark the tag as “Authentic” automatically in the rendered document. This process, can also be performed on-demand when the user taps the tag for example. In one embodiment, digital authentication of Blocktag can use a combination of public key signature verification and analysis of the characteristics of the tag itself or the tag’s fractal. Additional Other use case scenarios for a Blocktag fractal watermark include event tickets, legal documents and painted artwork.

FIG. 9C depicts an example of text/image integrated with a security device, where the text includes embedded characteristics per letter that define a repeated fractal square grid watermark across the letters. In addition, optional content element (or a QR code) can be added, for example at the bottom right corner. FIG. 9D depicts an example of text/image integrated with a security device, where the text includes embedded characteristics per letter that define a fractal cross grid watermark across the letters. The embedded characteristics of a letter can include, for example, one or more of base pattern periodicity, color, grayscale, font type, etc. Moreover, optional Aruco markers can be added, for example on the four corners of the document to facilitate base pattern detection.

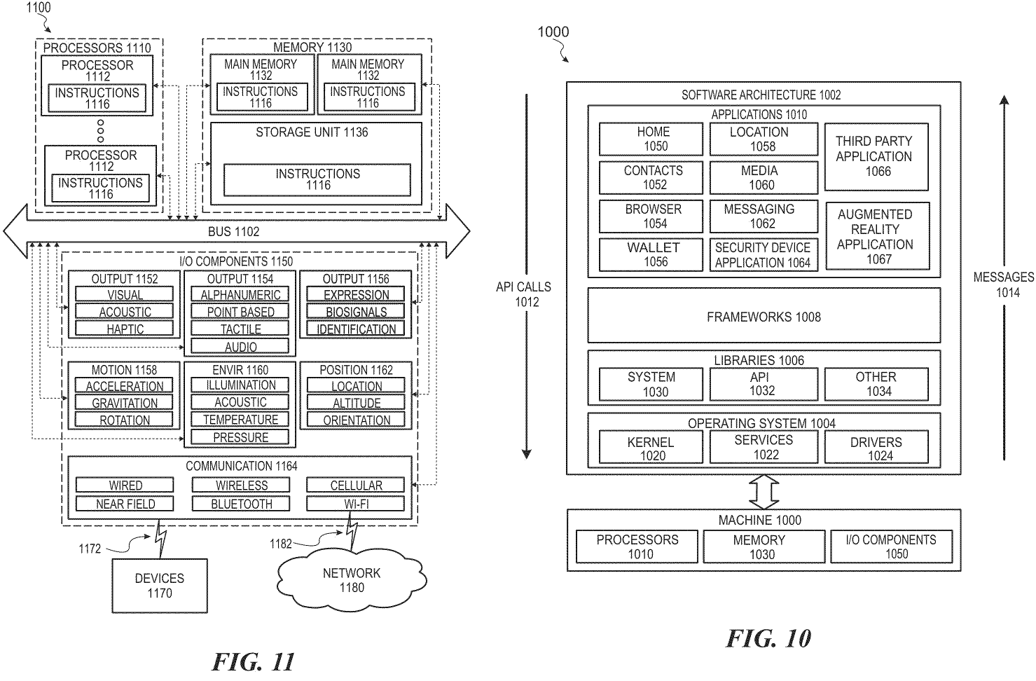

FIG. 10 is a block diagram 1000 illustrating an architecture of software 1002, which can be installed on any one or more of the devices described above. FIG. 10 is a non-limiting example of a software architecture, and it will be appreciated that many other architectures can be implemented to facilitate the functionality described herein. In various embodiments, the software 902 is implemented by hardware such as machine 1100 of FIG. 11 that includes processors 1110, memory 1130, and input/output (I/O) components 1130. In this example architecture, the software 1002 can be conceptualized as a stack of layers where each layer may provide a particular functionality. For example, the software 1002 includes layers such as an operating system 1004, libraries 1006, frameworks 1008, and applications 1010. Operationally, the applications 1010 invoke API calls 1012 through the software stack and receive messages 1014 in response to the API calls 1012, in accordance with some embodiments.

In some embodiments, the operating system 1004 manages hardware resources and provides common services. The operating system 1004 includes, for example, a kernel 1020, services 1022, and drivers 1024. The kernel 1020 acts as an abstraction layer between the hardware and the other software layers consistent with some embodiments. For example, the kernel 1020 provides memory management, processor management (e.g., scheduling), component management, networking, and security settings, among other functionality. The services 1022 can provide other common services for the other software layers. The drivers 1024 are responsible for controlling or interfacing with the underlying hardware, according to some embodiments. For instance, the drivers 1024 can include display drivers, camera drivers, BLUETOOTH drivers, flash memory drivers, serial communication drivers (e.g., Universal Serial Bus (USB) drivers), WI-FI drivers, audio drivers, power management drivers, and so forth. In some embodiments, the libraries 1006 provide a low-level common infrastructure utilized by the applications 1010. The libraries 1006 can include system libraries 1030 (e.g., C standard library) that can provide functions such as memory allocation functions, string manipulation functions, mathematics functions, and the like. In addition, the libraries 1006 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1006 can also include a wide variety of other libraries 1034 to provide many other APIs to the applications 1010.

The frameworks 1008 provide a high-level common infrastructure that can be utilized by the applications 1010, according to some embodiments. For example, the frameworks 1008 provide various graphic user interface (GUI) functions, high-level resource management, high-level location services, and so forth. The frameworks 1008 can provide a broad spectrum of other APIs that can be utilized by the applications 1010, some of which may be specific to a particular operating system 1004 or platform. In an example embodiment, the applications 1010 include a home application 1050, a contacts application 1052, a browser application 1054, a search/discovery application 1056, a location application 1058, a media application 1060, a messaging application 1062, a security device application 1064, an augmented reality application 1067 and other applications such as a third party application 1066. According to some embodiments, the applications 1010 are programs that execute functions defined in the programs. Various programming languages can be employed to create one or more of the applications 1010, structured in a variety of manners, such as object-oriented programming languages (e.g., Objective-C, Java, or C++) or procedural programming languages (e.g., C or assembly language). In a specific example, the third party application 1066 (e.g., an application developed using the Android, Windows or iOS. software development kit (SDK) by an entity other than the vendor of the particular platform) may be mobile software running on a mobile operating system such as Android, Windows or iOS, or another mobile operating systems. In this example, the third party application 1066 can invoke the API calls 1012 provided by the operating system 1004 to facilitate functionality described herein. The security device application 1064 may implement any system or method described herein, including provisioning, administering, verifying, creating, generating, authenticating security devices or any other operation described herein.

FIG. 11 is a block diagram illustrating components of a machine 1100, according to some example embodiments, able to read a set of instructions from a machine-readable medium (e.g., a machine-readable storage medium) and perform any one or more of the methodologies discussed herein.

Specifically, FIG. 11 shows a diagrammatic representation of the machine 1100 in the example form of a computer system, within which instructions 1016 (e.g., software, a program, an application, an applet, an app, or other executable code) for causing the machine 1000 to perform any one or more of the methodologies discussed herein can be executed. Additionally, or alternatively, the instruction can implement any module of FIG. 3A and any module of FIG. 4A, and so forth. The instructions transform the general, non-programmed machine into a particular machine programmed to carry out the described and illustrated functions in the manner described. In alternative embodiments, the machine 1100 operates as a standalone device or can be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 can comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a head mounted device, a smart lens, goggles, smart glasses, a smart home device (e.g., a smart appliance), other smart devices, a web appliance, a network router, a network switch, a network bridge, a Blackberry, a processor, a telephone, a web appliance, a console, a hand-held console, a (hand-held) gaming device, a music player, any portable, mobile, hand-held device or any device or machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein. The machine 1100 can include processors 1110, memory/storage 1130, and I/O components 1150, which can be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 1112 and processor 1114 that may execute instructions 1116. The term “processor” is intended to include multi-core processor that may comprise two or more independent processors (sometimes referred to as “cores”) that can execute instructions contemporaneously. Although FIG. 11 shows multiple processors, the machine 1100 may include a single processor with a single core, a single processor with multiple cores (e.g., a multi-core processor), multiple processors with a single core, multiple processors with multiples cores, or any combination thereof. The memory/storage 1130 can include a main memory 1132, a static memory 1134, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 can also reside, completely or partially, within the memory 1132, within the storage unit 1136, within at least one of the processors 1110 (e.g., within the processor’s cache memory), or any suitable combination thereof, during execution thereof by the machine 1100. Accordingly, the memory 1132, the storage unit 1136, and the memory of the processors 1110 are examples of machine-readable media.

As used herein, the term “machine-readable medium” or “machine-readable storage medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” or “machine-readable storage medium” should be taken to include a single medium or multiple media (e.g., a centralized or distributed database, or associated caches and servers) able to store instructions 1116. The term “machine-readable medium” or “machine-readable storage medium” shall also be taken to include any medium, or combination of multiple media, that is capable of storing, encoding or carrying a set of instructions (e.g., instructions 1116) for execution by a machine (e.g., machine 1100), such that the instructions, when executed by one or more processors of the machine 1100 (e.g., processors 1111), cause the machine 1100 to perform any one or more of the methodologies described herein. Accordingly, a “machine-readable medium” or “machine-readable storage medium” refers to a single storage apparatus or device, as well as “cloud-based” storage systems or storage networks that include multiple storage apparatus or devices. The term “machine-readable medium” or “machine-readable storage medium” excludes signals per se.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure. Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The I/O components 1150 can include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 can include many other components that are not shown in FIG. 11. The I/O components 1150 are grouped according to functionality merely for simplifying the following discussion and the grouping is in no way limiting. In example embodiments, the I/O components 1150 can include output components 1152 and input components 1154. The output components 1152 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), eye trackers, and the like.

In further example embodiments, the I/O components 1152 can include biometric components 1156, motion components 1158, environmental components 1160, or position components 1162 among a wide array of other components. For example, the biometric components 1156 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 can include acceleration sensor components (e.g., an accelerometer), gravitation sensor components, rotation sensor components (e.g., a gyroscope), and so forth. The environmental components 1160 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1162 can include location sensor components (e.g., a GPS receiver component), altitude sensor components (e.g., altimeters or barometers that detect air pressure from which altitude may be derived), orientation sensor components (e.g., magnetometers), and the like. Communication can be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 include a network interface component or other suitable device to interface with the network 1180. In further examples, communication components 1164 include wired communication components, wireless communication components, cellular communication components, Near Field Communication (NFC) components, Bluetooth. components (e.g., Bluetooth. Low Energy), WI-FI components, and other communication components to provide communication via other modalities. The devices 1170 may be another machine or any of a wide variety of peripheral devices (e.g., a peripheral device coupled via a USB). The network interface component can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The network interface component can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand. Other network security functions can be performed or included in the functions of the firewall, can be, for example, but are not limited to, intrusion-prevention, intrusion detection, next-generation firewall, personal firewall, etc. without deviating from the novel art of this disclosure.

Moreover, the communication components 1164 can detect identifiers or include components operable to detect identifiers. For example, the communication components 1164 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1164, such as location via Internet Protocol (IP) geo-location, location via WI-FI signal triangulation, location via detecting a BLUETOOTH or NFC beacon signal that may indicate a particular location, and so forth. In various example embodiments, one or more portions of the network 1180 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI.RTM. network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or other type of cellular or wireless coupling. In this example, the coupling 1182 can implement any of a variety of types of data transfer technology, such as Single Carrier Radio Transmission Technology, Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, 5G, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1116 can be transmitted or received over the network 1180 using a transmission medium via a network interface device (e.g., a network interface component included in the communication components 1164) and utilizing any one of a number of transfer protocols (e.g., HTTP). Similarly, the instructions 1116 can be transmitted or received using a transmission medium via the coupling 1172 (e.g., a peer-to-peer coupling) to devices 1170. The term “transmission medium” shall be taken to include any intangible medium that is capable of storing, encoding, or carrying the instructions 1116 for execution by the machine 1100, and includes digital or analog communications signals or other intangible medium to facilitate communication of such software. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Although an overview of the innovative subject matter has been described with reference to specific example embodiments, various modifications and changes may be made to these embodiments without departing from the broader scope of embodiments of the present disclosure. Such embodiments of the novel subject matter may be referred to herein, individually or collectively, by the term “innovation” merely for convenience and without intending to voluntarily limit the scope of this application to any single disclosure or novel or innovative concept if more than one is, in fact, disclosed. The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled. As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges. The teachings of the disclosure provided herein can be applied to other systems, not necessarily the system described above. The elements and acts of the various embodiments described above can be combined to provide further embodiments. Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112,

6, other aspects may likewise be embodied as a means-plus-function claim, or in other forms, such as being embodied in a computer-readable medium. (Any claims intended to be treated under 35 U.S.C. §112,

6 will begin with the words “means for”.) Accordingly, the applicant reserves the right to add additional claims after filing the application to pursue such additional claim forms for other aspects of the disclosure.

1. A security device, comprising:
a physical surface having formed thereon a composite pattern;
wherein, the composite pattern is created from joining or overlap of a first base pattern and a second base pattern;
wherein, the first base pattern is created from a first basic building block;
wherein, the basic building block forms chaosmetric artifacts in the physical surface upon printing.

2. The security device of claim 1, further comprising:
a content element having metadata;
wherein, the composite pattern is formed within a polychrome pattern and disposed adjacent to the content element.

3. The security device of claim 1, further comprising:
a content element having metadata;
wherein, the composite pattern is formed within a polychrome pattern and disposed adjacent to the content element;
wherein the polychrome pattern includes a 2D color barcode.

4. The security device of claim 1, further comprising:
a content element having metadata;
wherein, the content element and the composite pattern are formed within a square or rectangular form factor.

5. The security device of claim 1, further comprising:
a content element having metadata;
wherein, the content element includes a circular QR code, a Cantag marker, or a ShotCode circular barcode.

6. The security device of claim 1, further comprising:
a content element having metadata;
wherein, the content element is formed as a central circle;
wherein, the composite pattern is formed as a ring surrounding the central circle.

7. The security device of claim 1, further comprising:
a content element having metadata;
wherein, the content element is formed in as a central circle;
wherein, the composite pattern is formed as a ring surrounding the central circle having one or more of, a fractal pattern or a halftone pattern.

8. The security device of claim 1, further comprising:
a content element having metadata;
wherein, the content element is formed in as a central circle;
a ring surrounding the central circle having formed within, the composite pattern and an identity element.

9. The security device of claim 1, further comprising:
a content element having metadata;
wherein, the content element is formed in as a central circle;
a ring surrounding the central circle having formed within an identity element;
wherein, the identity element includes line gratings or a circular barcode.

10. The security device of claim 1, further comprising:
a content element having metadata;
a monochrome fractal pattern formed along one or more edges of the content element or along one or more edges of the composite pattern.

11. The security device of claim 1, further comprising:
a content element having metadata;
a monochrome fractal pattern formed to overlap the content element for chaosmetric enhancement.

12. The security device of claim 1, further comprising:
a content element having metadata;
a monochrome fractal pattern formed within features of the content element for chaosmetric enhancement.

13. The security device of claim 1, further comprising:
a content element having metadata formed as a QR code;
wherein, the QR code is converted into a hilbert curve fractal pattern for chaosmetric enhancement.

14. The security device of claim 1, further comprising:
a content element having metadata;
a fractal grid integrated with the content element as reference lines.

15. The security device of claim 1, further comprising:
a content element having at least one of: a URI, a URL or bar code;
a 2D colored barcode disposed adjacent to the content element in the physical surface;
wherein:
the composite pattern is embedded in the 2D colored barcode to form a polychrome pattern identifier.

16. The security device of claim 1, further comprising:
a content element having metadata;
wherein, the composite pattern is monochromatic and integrated in the content element;
wherein, the metadata includes additional metadata defining characteristics of the composite pattern.

17. The security device of claim 1, further comprising:
a resolution test component having line gratings with predetermined thicknesses and distances between each of the line gratings;
wherein, the calibration component is used in assessing a resolution power of a scan device used to authenticate the security device.

18. The security device of claim 1, further comprising:
a resolution test component having line gratings with predetermined thicknesses and distances between each of the line gratings;
wherein, the resolution test component is used in determining a resolution profile of a scan device used to authenticate the security device;
wherein, the resolution profile of the scan device is characterized as a function of a distance between the resolution test component and the scan device.

19. The security device of claim 1, further comprising:
a resolution test component having line gratings with each of the line gratings having predetermined thicknesses and distances between each of the line gratings;
wherein, the calibration component is used in assessing resolution power of a scan device used to authenticate the security device;
wherein, the calibration component is disposed in the same plane as the security device to be authenticated.

20. The security device of claim 1, wherein:
the physical surface includes paper or fabrics.

21-36. (canceled)
